(19) United States
(12) Patent Application Publication
(10) Pub. No.: US 2021/0143472 A1
(43) Pub. Date: May 13, 2021

(54) SOLID ELECTROLYTE COMPOSITION, SOLID ELECTROLYTE-CONTAINING SHEET, ELECTRODE SHEET FOR ALL-SOLID STATE SECONDARY BATTERY, ALL-SOLID STATE SECONDARY BATTERY, METHOD OF MANUFACTURING SOLID ELECTROLYTE-CONTAINING SHEET, METHOD OF MANUFACTURING ALL-SOLID STATE SECONDARY BATTERY, AND METHOD OF MANUFACTURING PARTICLE BINDER

(71) Applicant: FUJIFILM Corporation, Tokyo (JP)

(72) Inventors: Tomonori MIMURA, Kanagawa (JP); Atsushi SUGASAKI, Kanagawa (JP)

(73) Assignee: FUJIFILM Corporation, Tokyo (JP)

(21) Appl. No.: 17/153,888

(22) Filed: Jan. 21, 2021

Related U.S. Application Data
(63) Continuation of application No. PCT/JP2019/028425, filed on Jul. 19, 2019.

(30) Foreign Application Priority Data
Jul. 25, 2018 (JP) 2018-139152

(51) Int. Cl. H01M 10/0562; H01M 4/62; C08K 3/22; C08F 290/04

(52) U.S. Cl. CPC H01M 10/0562; H01M 4/622; C08K 3/22; C08K 2003/2244; H01M 2300/0091; H01M 2300/0068; C08F 290/046

(57) ABSTRACT

Provided is an a solid electrolyte composition including: an inorganic solid electrolyte; a particle binder that includes a polymer and has an average particle size of 5 nm to 10 μm, the polymer including a component that includes a binding site represented by Formula (H-1) or (H-2) at a side chain and has a C log P value of 4 or lower and a molecular weight of lower than 1000; and a dispersion medium. A solid electrolyte-containing sheet, an electrode sheet for an all-solid state secondary battery, and an all-solid state secondary battery that include layer formed of the solid electrolyte composition are also provided. In addition, method of manufacturing the particle binder, the solid electrolyte-containing sheet, and the all-solid state secondary battery are provided.

This application is a Continuation of PCT International Application No. PCT/JP2019/028425 filed on Jul. 19, 2019, which claims priority under 35 U.S.C. § 119 (a) to Japanese Patent Application No. 2018-139152 filed in Japan on Jul. 25, 2018. Each of the above applications is hereby expressly incorporated by reference, in its entirety, into the present application.

### BACKGROUND OF THE INVENTION

### 1. Field of the Invention

The present invention relates to a solid electrolyte composition, a solid electrolyte-containing sheet, an electrode sheet for an all-solid state secondary battery, an all-solid state secondary battery, a method of manufacturing a solid electrolyte-containing sheet, a method of manufacturing an all-solid state secondary battery, and a method of manufacturing a particle binder.

### 2. Description of the Background Art

A lithium ion secondary battery is a storage battery including a negative electrode, a positive electrode, and an electrolyte sandwiched between the negative electrode and the positive electrode and enables charging and discharging by the reciprocal migration of lithium ions between both electrodes. In the related art, in lithium ion secondary batteries, an organic electrolytic solution has been used as the electrolyte. However, in organic electrolytic solutions, liquid leakage is likely to occur, there is a concern that a short-circuit and ignition may be caused in batteries due to overcharging or overdischarging, and there is a demand for additional improvement in safety and reliability.

Under these circumstances, all-solid state secondary batteries in which an inorganic solid electrolyte is used instead of the organic electrolytic solution are attracting attention. In an all-solid state secondary battery, a negative electrode, an electrolyte, and a positive electrode are all solid, and safety or reliability batteries including an organic electrolytic solution can be significantly improved.

In the all-solid state secondary battery, as a material for forming a constituent layer such as a negative electrode active material layer, a solid electrolyte layer, or a positive electrode active material layer, a material including an inorganic solid electrolyte, an active material, and a binder is disclosed.

For example, WO2016/129427A describes a solid electrolyte composition including: an inorganic solid electrolyte; binder particles formed of a polymer having a reactive group; a dispersion medium; and at least one component selected from a crosslinking agent or a crosslinking accelerator. During use of the solid electrolyte composition, the binder particles attached to particles of the inorganic solid electrolyte or an active material are cured by a crosslinking agent or a crosslinking accelerator. In addition, WO2012/173089A describes a slurry including: an inorganic solid electrolyte; and a binder formed of a particle polymer having an average particle size 30 to 300 nm. WO2017/131093A describes a solid electrolyte composition including: an inorganic solid electrolyte; and a binder that is formed of a polymer including a component derived from a specific macromonomer and including a ring structure of two or more rings.

### SUMMARY OF THE INVENTION

A constituent layer of an all-solid state secondary battery is formed of solid particles such as an inorganic solid electrolyte, binder particles, or an active material. In this case, it is desirable that a material for forming a constituent layer exhibits excellent dispersibility by dispersing solid particles in a dispersion medium or the like. However, even in a case where a material having excellent dispersibility is used, a constituent layer is formed of solid particles. Therefore, interface contact between the solid particles is not sufficient, and the interface resistance increases (the ion conductivity decreases). On the other hand, in a case where binding properties between the solid particles are weak, a constituent layer formed on a surface of a current collector is likely to peel off from the current collector. In addition, poor contact between solid particles occurs due to contraction and expansion of a constituent layer, in particular, an active material layer caused by charging and discharging of an all-solid state secondary battery (intercalation and deintercalation of lithium ions), which causes an increase in electrical resistance and further a decrease in battery performance.

An object of the present invention is to provide a solid electrolyte composition having excellent dispersibility. In an all-solid state secondary battery that is obtained by using this solid electrolyte composition as a material for forming a constituent layer of an all-solid state secondary battery, while suppressing an increase in interface resistance between solid particles, solid particles can be strongly bound to each other, and excellent battery performance can be realized. In addition, another object of the present invention is to provide a solid electrolyte-containing sheet, an electrode sheet for an all-solid state secondary battery, and an all-solid state secondary battery that include a layer formed of the solid electrolyte composition. Still another object of the present invention is to provide methods of manufacturing a solid electrolyte-containing sheet and an all-solid state secondary battery in which the solid electrolyte composition is used. In addition, still another object of the present invention is to provide a suitable method of manufacturing a particle binder used in the solid electrolyte composition.

The present inventors conducted an various investigation and found that excellent dispersibility can be exhibited by using a particle binder that includes a polymer in combination with an inorganic solid electrolyte and a dispersion medium in a solid electrolyte composition, the polymer including a component that includes a binding site represented by Formula (H-1) or (H-2) at a side chain and has a C log P value of 4 or lower and a molecular weight of lower than 1000. Further, it was also found that, by using this solid electrolyte composition as a material for forming a constituent layer of an all-solid state secondary battery, a constituent layer in which solid particles are strongly bonded to each other while suppressing interface resistance between the solid particles can be formed, and excellent battery performance can be imparted to the all-solid state secondary battery. The present invention has been completed based on the above findings as a result of repeated investigation.

That is, the above-described objects have been achieved by the following means.
<1> A solid electrolyte composition comprising:
an inorganic solid electrolyte having ion conductivity of a metal belonging to Group 1 or Group 2 in the periodic table;
a particle binder that includes a polymer and has an average particle size of 5 nm to 10 μm, the polymer including a component that includes a binding site represented by Formula (H-1) or (H-2) at a side chain and has a C log P value of 4 or lower and a molecular weight of lower than 1000; and
a dispersion medium,

[chemical structure]

in the formulae, X¹¹, X¹², X¹³, and X¹⁵ each independently represent an imino group, an oxygen atom, a sulfur atom, or a selenium atom,
X¹⁴ represents an amino group, a hydroxy group, a sulfanyl group, or a carboxy group, and
L¹¹ represents an alkylene group or an alkenylene group having 4 or less carbon atoms.
<2> The solid electrolyte composition according to <1>,
in which the component is represented by Formula (R-1) or (R-2),

[chemical structure]

in the formulae, X²¹, X²², X²³, and X²⁵ each independently represent an imino group, an oxygen atom, or a sulfur atom,
X² represents a hydroxy group or a sulfanyl group,
R¹¹ to R¹³ and R¹⁵ to R¹⁷ each independently represent a hydrogen atom, a cyano group, a halogen atom, or an alkyl group,
R¹⁴ and R¹⁸ each independently represent a hydrogen atom or a substituent,
L²¹ to L²³ and L²⁵ each independently represent an alkylene group having 1 to 16 carbon atoms, an alkenylene group having 2 to 16 carbon atoms, an arylene group having 6 to 24 carbon atoms, an oxygen atom, a sulfur atom, an imino group, a carbonyl group, a phosphate linking group, a phosphonate linking group, or a linking group including a combination thereof, and
L²⁴ represents an alkylene group or an alkenylene group having 4 or less carbon atoms.
<3> The solid electrolyte composition according to <1> or <2>,
in which the component is represented by Formula (R-21) or (R-22).

[chemical structure]

in the formulae, X³¹, X³², and X³⁵ each independently represent an imino group or an oxygen atom,
X³³ represents an oxygen atom,
X³⁴ represents a hydroxy group,
Y¹¹ and Y¹² each independently represent an imino group or an oxygen atom,
R²¹ to R²³ and R²⁵ to R²⁷ each independently represent a hydrogen atom, a cyano group, or an alkyl group,
R²⁴ and R²⁸ each independently represent a hydrogen atom, a hydroxy group, an alkyl group having 1 to 6 carbon atoms, a phenyl group, or a carboxy group,
L³¹ to L³³ and L³⁵ each independently represent an alkylene group having 1 to 16 carbon atoms, an arylene group having 6 to 12 carbon atoms, an oxygen atom, a sulfur atom, an imino group, a carbonyl group, or a linking group including a combination thereof, and
L³⁴ represents an alkylene group having 2 or less carbon atoms.
<4> The solid electrolyte composition according to <1>,
in which in Formula (H-1), X¹¹ and X¹² each independently represent an imino group and X¹³ represents an oxygen atom, or
in Formula (H-2), X¹⁴ represents an amino group, a hydroxy group, a sulfanyl group, or a carboxy group, X¹⁵ represents an imino group, and L¹¹ represents an alkylene group or an alkenylene group having 4 or less carbon atoms.
<5> The solid electrolyte composition according to anyone of <1> to <4>, in which the polymer includes 20 mass % or higher and lower than 90 mass % of the component.
<6> The solid electrolyte composition according to anyone of <1> to <5>, in which the C log P value is 2.5 or lower.
<7> The solid electrolyte composition according to anyone of <1> to <6>,
wherein the polymer includes a component that includes a group having 6 or more carbon atoms at a side chain.
<8> The solid electrolyte composition according to anyone of <1> to <7>,
in which the polymer includes a component that is derived from a macromonomer having a mass average molecular weight of 1000 or higher.
<9> The solid electrolyte composition according to <8>,
in which the component derived from the macromonomer includes a binding site represented by Formula (H-21) or (H-22) at a side chain,

[chemical structure]

in the formulae, X⁴¹, X⁴², X⁴³, and X⁴ each independently represent an imino group, an oxygen atom, a sulfur atom, or a selenium atom,
X⁴⁴ represents an amino group, a hydroxy group, a sulfanyl group, or a carboxy group, and
L⁴¹ represents an alkylene group or an alkenylene group having 4 or less carbon atoms.
<10> The solid electrolyte composition according to any one of <1> to <9>,
in which the particle binder includes a component that precipitates after a centrifugal separation process in a dispersion medium at a temperature of 20° C. and a rotation speed of 100000 rpm for 1 hour and a component that does not precipitate after the centrifugal separation process, and
a content X of the component that precipitates and a content Y of the component that does not precipitate satisfy the following expression by mass,

Y/(X+Y)≤0.10.
<11> The solid electrolyte composition according to anyone of <1> to <10>,
in which the polymer includes at least one functional group selected from Group (a) of functional groups,
Group (a) of functional groups
a carboxy group, a sulfonate group, a phosphate group, a phosphonate group, an isocyanate group, an oxetane group, an epoxy group, and a silyl group.
<12> The solid electrolyte composition according to anyone of <1> to <11>,
in which the inorganic solid electrolyte is represented by Formula (1),

Lₐ₁M_{b1}P_{c1}S_{d1}Aₑ₁ Formula (1),
in the formula, L represents an element selected from Li, Na, or K,
M represents an element selected from B, Zn, Sn. Si, Cu, Ga, Sb, Al, or Ge,
A represents an element selected from I, Br, Cl, or F, and
a1 to e1 represent compositional ratios between the respective elements, and
a1:b1:c1:d1:e1 satisfies 1 to 12:0 to 5:1:2 to 12:0 to 10.
<13> The solid electrolyte composition according to anyone of <1> to <12>,
in which the dispersion medium is at least one dispersion medium selected from a ketone compound, an ester compound, an aromatic compound, or an aliphatic compound.
<14> The solid electrolyte composition according to any one of <1> to <13>, comprising:
an active material capable of intercalating and deintercalating ions of a metal belonging to Group 1 or Group 2 in the periodic table.
<15> A solid electrolyte-containing sheet comprising:
a layer formed of the solid electrolyte composition according to any one of <1> to <14>.
<16> An electrode sheet for an all-solid state secondary battery, the electrode sheet comprising:
an active material layer formed of the solid electrolyte composition according to <14>.
<17> An all-solid state secondary battery comprising a positive electrode active material layer, a solid electrolyte layer, and a negative electrode active material layer in this order,
in which at least one of the positive electrode active material layer, the negative electrode active material layer, or the solid electrolyte layer is formed of the solid electrolyte composition according to any one of <1> to <14>.
<18> A method of manufacturing a solid electrolyte-containing sheet, the method comprising:
forming a film using the solid electrolyte composition according to any one of <1> to <14>.
<19> A method of manufacturing an all-solid state secondary battery, the method comprising manufacturing the all-solid state secondary battery through the method according to <18>.
<20> A method of manufacturing a particle binder that includes a polymer and has an average particle size of 5 nm to 10 μm, the polymer including a component that includes a binding site represented by Formula (H-1) or (H-2) and has a C log P value of 4 or lower and a molecular weight of lower than 1000, the method comprising:
a step of causing a functional polymer having a functional group at a side chain to react with a side chain-forming compound having a reactive group that reacts with the functional group to form the binding site,

[chemical structure]

in the formulae, X¹¹, X¹², X¹³, and X¹⁵ each independently represent an imino group, an oxygen atom, a sulfur atom, or a selenium atom,
X¹⁴ represents an amino group, a hydroxy group, a sulfanyl group, or a carboxy group, and
L¹¹ represents an alkylene group or an alkenylene group having 4 or less carbon atoms.

The present invention can provide a solid electrolyte composition having excellent dispersibility. In an all-solid state secondary battery that is obtained by using this solid electrolyte composition as a material for forming a layer forming a constituent layer of an all-solid state secondary battery, while suppressing an increase in interface resistance between solid particles, solid particles can be strongly bound to each other, and excellent battery performance can be realized. The present invention can also provide a solid electrolyte-containing sheet, an electrode sheet for an all-solid state secondary battery, and an all-solid state secondary battery that include a layer formed of the solid electrolyte composition. Further, the present invention can also provide methods of manufacturing a solid electrolyte-containing sheet and an all-solid state secondary battery in which the solid electrolyte composition is used. In addition, the present invention can also provide a suitable method of manufacturing a particle binder used in the solid electrolyte composition.

The above-described and other characteristics and advantageous effects of the present invention will be clarified from the following description appropriately with reference to the accompanying drawings.

### BRIEF DESCRIPTION OF THE DRAWINGS

FIG. 1 is a vertical cross-sectional view schematically illustrating an all-solid state secondary battery according to a preferred embodiment of the present invention.

FIG. 2 is a vertical cross-sectional view schematically illustrating an all-solid state secondary battery (coin battery) prepared in Examples.

### DESCRIPTION OF THE PREFERRED EMBODIMENTS

In the description of the present invention, numerical ranges represented by “to” include numerical values before and after “to” as lower limit values and upper limit values.

In the description of the present specification, the simple expression “acryl” or “(meth)acryl” refers to acryl and/or methacryl.

In the present specification, the expression of a compound (for example, in a case where a compound is represented by an expression with “compound” added to the end) refers to not only the compound itself but also a salt or an ion thereof. In addition, this expression also refers to a derivative obtained by modifying a part of the compound, for example, by introducing a substituent into the compound within a range where desired effects are exhibited.

A substituent, a linking group, or the like (hereinafter, referred to as “substituent or the like”) is not specified in the present specification regarding whether to be substituted or unsubstituted may have an appropriate substituent. Accordingly, even in a case where a YYY group is simply described in the present specification, this YYY group includes not only an aspect having a substituent but also an aspect not having a substituent. The same shall be applied to a compound which is not specified in the present specification regarding whether to be substituted or unsubstituted. Preferable examples of the substituent include a substituent T described below.

In the present specification, in a case where a plurality of substituents or the like represented by a specific reference numeral are present or a plurality of substituents or the like are simultaneously or alternatively defined, the respective substituents or the like may be the same as or different from each other. In addition, unless specified otherwise, in a case where a plurality of substituents or the like are adjacent to each other, the substituents may be linked or fused to each other to form a ring.

[Solid Electrolyte Composition]

A solid electrolyte composition according to an embodiment of the present invention includes an inorganic solid electrolyte, a particle binder that includes a polymer described below and has an average particle size of 5 nm to 10 μm, and a dispersion medium. The solid electrolyte layer will also be referred to as “inorganic solid electrolyte-containing composition” from the viewpoint of containing the inorganic solid electrolyte described below.

The solid electrolyte composition is in a dispersed state (suspension) in which the inorganic solid electrolyte and the particle binder in a solid state are dispersed in the dispersion medium. This solid electrolyte composition only has to be in the above-described dispersed state and is preferably a slurry. The particle binder is not particularly limited as long as, in a case where the particle binder is used for a constituent layer or an applied and dried layer of the solid electrolyte composition described below, the binder particles can bind solid particles of the inorganic solid electrolyte and the like to each other and further bind solid particles and an adjacent layer (for example, a current collector) to each other. The particle binder does not have to bind the solid particles in the dispersed state of the solid electrolyte composition.

In the solid electrolyte composition according to the embodiment of the present invention, in a case where the inorganic solid electrolyte and the particle binder are present together in the dispersion medium, the inorganic solid electrolyte can be highly and stably dispersed, and the dispersibility of the solid electrolyte composition can be improved. In a case where a constituent layer of an all-solid state secondary battery is formed using the solid electrolyte composition, solid particles and further solid particles and a current collector or the like can be strongly bound to each other. The details of the reason for this are not clear but considered to be as follows.

In a case where the particle binder in the solid electrolyte composition according to the embodiment of the present invention has a C log P value of 4 or less and a molecular weight of lower than 1000 as described below, the particle binder is formed to include a polymer that has a component having a specific binding site represented by Formula (II-1) or (II-2) described below. Therefore, it is presumed that, due to the synergistic effect of the C log P value, the molecular weight, and the specific binding site in the component, affinity to the solid particles such as the inorganic solid electrolyte in the dispersion medium is improved. As a result, the solid particles can be highly and stably dispersed. Further, a constituent layer of an all-solid state secondary battery can be formed while maintaining affinity to the solid particles. Therefore, in the obtained constituent layer, the solid particles can be strongly bound to each other. In addition, in a case where a constituent layer is formed on a current collector, the current collector and the solid particles can be strongly bound to each other.

On the other hand, since the particle binder is in the form of particles, the particle binder can secure an ion conduction path without excessively covering (being attached) surfaces of the solid particles as compared to a non-particle binder (for example, a liquid binder (soluble binder) in the solid electrolyte composition). Therefore, even in a case where the affinity to the solid particles is high, the interface resistance between the solid particles can be suppressed to be low.

This way, the high and stable dispersibility of the solid electrolyte composition and the strong binding properties between the solid particles and the like can be simultaneously realized (maintained) on a high level while suppressing an increase in interface resistance. Accordingly, in the constituent layer formed of the solid electrolyte composition according to the embodiment of the present invention, the contact state between the solid particles (the amount of an ion conduction path constructed), and the binding strength between the solid particles are improved with a good balance. As a result, it is considered that, even while constructing an ion conduction path, the solid particles and the like are bound to each other with strong binding properties, and the interface resistance between the solid particles is low. In each of sheets or an all-solid state secondary battery including the constituent layer having the excellent characteristics, high ion conductivity is exhibited while suppressing an increase in electrical resistance. Further, the excellent battery performance can be maintained even in a case where charging and discharging is repeated.

In the present invention, the dispersibility of the solid electrolyte composition being excellent represents a state where solid particles are highly and stably dispersed in the dispersion medium, for example, a state where the dispersibility is evaluated as an evaluation rank of “5” or higher in “Dispersibility Test” in Examples described below.

The solid electrolyte composition according to the embodiment of the present invention includes an aspect including not only an inorganic solid electrolyte but also an active material and optionally an conductive auxiliary agent or the like as dispersoids (the composition in this aspect will be referred to as “electrode layer-forming composition”).

The solid electrolyte composition according to the embodiment of the present invention is a non-aqueous composition. In the present invention, the non-aqueous composition includes not only an aspect not including moisture but also an aspect where the moisture content (also referred to as “water content”) is 50 ppm or lower. In the non-aqueous composition, the moisture content is preferably 20 ppm or lower, more preferably 10 ppm or lower, and still more preferably 5 ppm or lower. The moisture content refers to the content of water (mass ratio to the solid electrolyte composition) in the solid electrolyte composition. The moisture content can be obtained by Karl Fischer titration after filtering the solid electrolyte composition the through a membrane filter having a pore size of 0.45 μm.

Hereinafter, the components that are included in the solid electrolyte composition according to the embodiment of the present invention and components that may be included therein will be described.

<Inorganic Solid Electrolyte>

In the present invention, the inorganic solid electrolyte is an inorganic solid electrolyte, and the solid electrolyte refers to a solid-form electrolyte capable of migrating ions therein. The inorganic solid electrolyte is clearly distinguished from organic solid electrolytes (polymer electrolytes such as polyethylene oxide (PEO) and organic electrolyte salts such as lithium bis(trifluoromethanesulfonyl)imide (LiTFSI)) since the inorganic solid electrolyte does not include any organic matter as a principal ion conductive material. In addition, the inorganic solid electrolyte is solid in a steady state and thus, typically, is not dissociated or liberated into cations and anions. Due to this fact, the inorganic solid electrolyte is also clearly distinguished from inorganic electrolyte salts of which cations and anions are dissociated or liberated in electrolytic solutions or polymers (LiPF₆, LiBF₄, LiFSI, LiCl, and the like). The inorganic solid electrolyte is not particularly limited as long as it has ion conductivity of a metal belonging to Group 1 or Group 2 in the periodic table and generally does not have electron conductivity.

In the present invention, the inorganic solid electrolyte has ion conductivity of a metal belonging to Group 1 or Group 2 in the periodic table. The inorganic solid electrolyte can be appropriately selected from solid electrolyte materials to be applied to this kind of products and used.

Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based solid electrolyte. From the viewpoint of a high ion conductivity and easiness in joining interfaces between particles, a sulfide-based inorganic solid electrolyte is preferable.

In a case where an all-solid state secondary battery according to the embodiment of the present invention is an all-solid state lithium ion secondary battery, the inorganic solid electrolyte preferably has ion conductivity of lithium ions.

(i) Sulfide-Based Inorganic Solid Electrolyte

The sulfide-based inorganic solid electrolyte is preferably a compound that contains a sulfur atom, has ion conductivity of a metal belonging to Group 1 or Group 2 in the periodic table, and has electron-insulating properties. The sulfide-based inorganic solid electrolyte is preferably an inorganic solid electrolyte that contains at least Li, S, and P as elements and has lithium ion conductivity. However, the sulfide-based inorganic solid electrolyte may include elements other than Li, S, and P depending on the purposes or cases.

Examples of the sulfide-based inorganic solid electrolyte include a lithium ion-conductive sulfide-based inorganic solid electrolyte satisfying a composition represented by the following Formula (1).

Lₐ₁M_{b1}P_{c1}S_{d1}Aₑ₁ Formula (1)

In the formula, L represents an element selected from Li, Na, or K and is preferably Li. M represents an element selected from B, Zn, Sn, Si, Cu, Ga, Sb, Al, or Ge. A represents an element selected from I, Br, Cl, or F, and a1 to e1 represent the compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the ratios of raw material compounds blended to manufacture the sulfide-based inorganic solid electrolyte as described below.

The sulfide-based inorganic solid electrolyte may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two raw materials of, for example, lithium sulfide (Li₂S), phosphorus sulfide (for example, diphosphorus pentasulide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio between Li₂S and P₂S₅ in Li—P—S-based glass and Li—P—S-based glass ceramic is preferably 60:40 to 90:10 and more preferably 68:32 to 78:22 in terms of the molar ratio between Li₂S:P₂S₅. In a case where the ratio between Li₂S and P₂S₅ is set in the above-described range, it is possible to increase the lithium ion conductivity. Specifically, the lithium ion conductivity can be preferably set to 1×10⁻⁴ S/cm or more and more preferably set to 1×10⁻³ S/cm or more. The upper limit is not particularly limited, but realistically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, LiS—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S, Li₂S—SiS₂—P₂S₅—LiI, Li₂S—SiS₂—LiI, Li₂S—SiS₂—Li₄SiO₄, Li₂S—SiS₂—Li₃PO₄, and Li₁₀GeP₂Si₂. Mixing ratios of the respective raw materials do not matter. Examples of a method for synthesizing the sulfide-based inorganic solid electrolyte material using the above-described raw material compositions include an amorphization method. Examples of the amorphization method include a mechanical milling method, a solution method, and a melting quenching method. This is because treatments at a normal temperature become possible, and it is possible to simplify manufacturing steps.

(ii) Oxide-Based Inorganic Solid Electrolyte

The oxide-based inorganic solid electrolyte is preferably a compound that contains an oxygen atom, has ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit is not particularly limited, but realistically 1×10⁻¹ S/cm or less.

Specific examples of the compound include LiₓₐLa_{ya}TiO₃ [xa=0.3 to 0.7 and ya=0.3 to 0.7] (LLT), Li_{xb}La_{yb}Zr_{zb}M^{bb}_{mb}O_{nb} (M^{bb} is at least one element of Al, Mg, Ca, Sr, V, Nb, Ta, Ti, Ge, In or Sn, xb satisfies 5≤xb≤10, yb satisfies 1≤yb≤4, zb satisfies 1≤zb≤4, mb satisfies 0≤mb≤2, and nb satisfies 5≤nb≤20), Li_{xc}B_{yc}M^{cc}_{zc}O_{nc} (M^{cc} is at least one element of C, S, Al, Si, Ga, Ge, In, or Sn, xc satisfies 0<xc≤5, yc satisfies 0<yc≤1, zc satisfies 0<zc≤1, and nc satisfies 0<nc≤6), Li_{xd}(Al, Ga)_{yd}(Ti, Ge)_{zd}Si_{ad}P_{md}O_{nd} (1≤xd≤3, 0≤yd≤1, 0≤zd≤2, 0≤ad≤1, 1≤md≤7, 3≤nd≤13), Li₍₃₋₂ₓₑ₎M^{ee}ₓₑD^{ee}O (xe represents a number of 0 or more and 0.1 or less, M^{cc} represents a divalent metal atom, D^{cc} represents a halogen atom or a combination of two or more halogen atoms), Li_{xf}Si_{yf}O_{zf} (1≤xf≤5, 0<yf≤3, 1≤zf≤10), Li_{xg}S_{yg}O_{zg} (1≤xg≤3, 0<yg≤2, 1≤zg≤10), Li₃O₃—Li₂SO₄, Li₂O—B₂O₃—P₂O₅, Li₂O—SiO₂, Li₆BaLa₂Ta₂O₁₂, Li₃PO_{(4-3/2w)}N_{w} (w satisfies w<1), Li_{3.5}Zn_{0.25}GeO₄ having a lithium super ionic conductor (LISICON)-type crystal structure. La_{0.55}Li_{0.35}TiO₃ having a perovskite type crystal structure, LiTi₂P₃O₁₂ having a natrium super ionic conductor (NASICON)-type crystal structure, Li_{1+xh+yh}(Al, Ga)ₓₕ(Ti, Ge)₂₋ₓₕSi_{yh}P_{3-yh}O₁₂ (0≤xh≤1, 0≤yh≤1), Li₇La₃Zr₂O₂ (LLZ) having a garnet-type crystal structure. In addition, phosphorus compounds containing Li, P, and O are also desirable. Examples thereof include lithium phosphate (Li₃PO₄) and LiPON in which some of oxygen elements in lithium phosphate are substituted with nitrogen elements, LiPOD¹ (D¹ is at least one element selected from Ti, V, Cr, Mn, Fe, Co, Ni, Cu, Zr, Nb, Mo, Ru, Ag, Ta, W, Pt, Au, or the like). It is also possible to preferably use LiA¹ON (A¹ represents at least one element selected from Si, B, Ge, Al, C. Ga, or the like) and the like.

(iii) Halide-Based Inorganic Solid Electrolyte

The halide-based inorganic solid electrolyte is preferably a compound that contains a halogen atom, has ion conductivity of a metal belonging to Group 1 or Group 2 in the periodic table, and has electron-insulating properties.

The halide-based inorganic solid electrolyte is not particularly limited, and examples thereof include LiCl, LiBr, LiI, and compounds such as Li₃YBr₆ or Li₃YC₆ described in ADVANCED MATERIALS, 2018, 30, 1803075. In particular, Li₃YBr₆ or Li₃YCl₆ is preferable.

(iv) Hydride-Based Inorganic Solid Electrolyte

The hydride-based inorganic solid electrolyte is preferably a compound that contains a hydrogen atom, has ion conductivity of a metal belonging to Group 1 or Group 2 in the periodic table, and has electron-insulating properties.

The hydride-based inorganic solid electrolyte is not particularly limited, and examples thereof include LiBH₄, Li(BH₄)₃I, and 3LiBH₄—LiCl.

The inorganic solid electrolyte is preferably in the form of particles. In this case, the average particle size (volume average particle size) of the inorganic solid electrolyte is not particularly limited, but is preferably 0.01 μm or more and more preferably 0.1 μm or more. The upper limit is preferably 100 μm or less and more preferably 50 μm or less. The average particle size of the inorganic solid electrolyte is measured in the following order. The inorganic solid electrolyte particles are diluted using water (heptane in a case where the inorganic solid electrolyte is unstable in water) in a 20 mL sample bottle to prepare 1 mass % of a dispersion liquid. The diluted dispersion specimen is irradiated with 1 kHz ultrasonic waves for 10 minutes and is then immediately used for testing. The volume average particle size is obtained by acquiring data 50 times using this dispersion liquid specimen, a laser diffraction/scattering particle size distribution analyzer LA-920 (trade name, manufactured by Horiba Ltd.), and a quartz cell for measurement at a temperature of 25° C. Other detailed conditions and the like can be found in JIS Z8828: 2013 “Particle Size Analysis-Dynamic Light Scattering” as necessary. For each level, five specimens are prepared and the average value thereof is adopted.

As the inorganic solid electrolyte, one kind may be used alone, or two or more kinds may be used in combination.

From the viewpoints of dispersibility, a reduction in interface resistance, and binding properties, the content of the inorganic solid electrolyte in the solid electrolyte composition is not particularly limited and is preferably 50 mass % or higher, more preferably 70 mass % or higher, and still more preferably 90 mass % or higher with respect to 100 mass % of the solid content. From the same viewpoint, the upper limit is preferably 99.99 mass % or lower, more preferably 99.95 mass % or lower, and particularly preferably 99.9 mass % or lower. Here, in a case where the solid electrolyte composition contains an active material described below, the content of the inorganic solid electrolyte in the solid electrolyte composition refers to the total content of the inorganic solid electrolyte and the active material.

In the present invention, the solid content (solid component) refers to components that neither volatilize nor evaporate and disappear in a case where the solid electrolyte composition is dried at 150° C. for 6 hours in a nitrogen atmosphere at a pressure of 1 mm/g. Typically, the solid content refers to components other than a dispersion medium described below.

<Particle Binder>

A solid electrolyte composition according to an embodiment of the present invention includes a particle binder that includes a polymer described below and has an average particle size of 5 nm to 10 μm.

The particle binder is dispersed in the solid electrolyte composition (in the dispersion medium) in a state where the form of particles is maintained. The solid electrolyte composition according to the embodiment of the present invention includes not only an aspect where the particle binder includes the dispersion medium in a state where the form of particles and the average particle size are maintained but also an aspect where a part of the particle binder is dissolved in the dispersion medium within a range where the effects of the present invention do not deteriorate.

The particle binder is formed of polymer particles, and the shape of the particle binder is not particularly limited as long as it has a particle shape, and may be a spherical shape or an unstructured shape in the solid electrolyte composition, a solid electrolyte-containing sheet, or, a constituent layer of an all-solid state secondary battery.

The average particle size of the particle binder is 5 nm to 10 μm. As a result, the dispersibility of the solid electrolyte composition, the binding properties between the solid particles, and the ion conductivity can be improved. From the viewpoint of further improving the dispersibility, the binding properties, and the ion conductivity, the average particle size is preferably 10 nm to 5 μm, more preferably 15 nm to 1 μm, and still more preferably 20 nm to 0.5 μm.

The average particle size of the particle binder can be measured using the same method as that of the inorganic solid electrolyte.

The average particle size of the particle binder in a constituent layer of an all-solid state secondary battery can be measured, for example, by disassembling the battery to peel off the constituent layer including the particle binder, measuring the average particle size of the constituent layer, and excluding a measured value of the average particle size of particles other than the particle binder obtained in advance from the average particle size of the constituent layer.

The average particle size of the particle binder can be adjusted, for example, based on the kind of a dispersion medium used for preparing a particle binder dispersion liquid, the content of the component in the polymer forming the particle binder, for example, the content of a component derived from a macromonomer, and the like.

The mass average molecular weight of the polymer forming the particle binder is not particularly limited and is preferably 5,000 or more, more preferably 10,000 or higher, and still more preferably 30,000 or higher. The upper limit is preferably 1,000,000 or lower and more preferably 200.000 or lower.

The particle binder is not particularly limited as long as it is formed to include the polymer including the component described below. As the polymer forming the particle binder, a polymer that is typically used for a solid electrolyte composition for an all-solid state secondary battery can be used except that it includes the component described below. Examples of the polymer including the component described below include a polyurethane resin, a polyurea resin, a polyamide resin, a polyimide resin, a polyester resin, a typical polyether resin, a polycarbonate resin, a cellulose derivative resin, a fluorine-containing resin, a hydrocarbon-based thermoplastic resin, a polyvinyl resin, and a (meth)acrylic resin. Among these, a polyurea resin, a polyurethane resin, or a (meth)acrylic resin is preferable, and a (meth)acrylic resin is more preferable.

In the present invention, a main chain of the polymer refers to a linear molecular chain in which all the molecular chains forming the polymer other than the main chain can be considered pendants to the main chain. In a case where the polymer includes a component derived from a macromonomer, typically, the longest chain among all the molecular chains forming the polymer is the main chain although depending on the mass average molecular weight of the macromonomer. In this case, a functional group at a polymer terminal is not included in the main chain.

In addition, side chains of the polymer refers to molecular chains other than the main chain and include a short molecular chain and a long molecular chain. In the present invention, it is preferable that the side chain of the polymer is a uncrosslinked molecular chain (for example, a graft chain or a pendant chain) without forming a crosslinked structure (a structure bonded to another molecular chain) from the viewpoint of dispersibility and binding properties.

(Sequential Polymerization Type Polymer)

In a case where the polymer forming the particle binder is a sequential polymerization (polycondensation, polyaddition, or addition condensation) type polymer, the structure thereof is not particularly limited and is preferably a polymer having a partial structure represented by Formula (I) (preferably in a main chain).

[chemical structure]

In Formula (I), R represents a hydrogen atom or a monovalent organic group.

Examples of the polymer having the partial structure represented by Formula (I) include a polymer having an amide bond (polyamide resin), a polymer having a urea bond (polyurea resin), a polymer having an imide bond (polyimide resin), and a polymer having a urethane bond (polyurethane resin).

Examples of the organic group in R include an alkyl group, an alkenyl group, an aryl group, and a heteroaryl group. In particular, it is preferable that R represents a hydrogen atom.

It is preferable that the sequential polymerization type polymer includes a main chain including a combination of 2 or more components (preferably 2 to 8 components, more preferably 2 to 4 components, and still more preferably 3 or 4 components) represented by any one of Formulae (I-1) to (I-4) or a main chain formed by sequential polymerization of a carboxylic dianhydride represented by Formula (I-5) and a diamine compound deriving a component represented by Formula (I-6). The combination of the respective components is appropriately selected depending on the kind of the polymer. One component in the combination of the components refers to the kind of a component represented by any one of the following formulae. Even in a case where the polymer includes two components represented by one of the following formulae, it is not considered that the polymer includes two kinds of components.

[chemical structure]

In the formulae, R^{P1} and R^{P2} each independently represent a molecular chain having a molecular weight or a mass average molecular weight of 20 to 200,000. The molecular weight of the molecular chain cannot be uniquely determined because it depends on the kind thereof and the like, and is, for example, preferably 30 or higher, more preferably 50 or higher, still more preferably 100 or higher, and still more preferably 150 or higher. The upper limit is preferably 100,000 or lower and more preferably 10,000 or lower. The molecular weight of the molecular chain is measured for a raw material compound before being incorporated into the main chain of the polymer.

The molecular chain that can be used as R^{P1} and R^{P2} is not particularly limited and is preferably a hydrocarbon chain, a polyalkylene oxide chain, a polycarbonate chain, or a polyester chain, more preferably a hydrocarbon chain or a polyalkylene oxide chain, and still more preferably a hydrocarbon chain.

The hydrocarbon chain that can be used as R^{P1} and R^{P2} refers to a chain of hydrocarbon including a carbon atom and a hydrogen atom and more specifically refers to a structure in which at least two atoms (for example, hydrogen atoms) or a group (for example, a methyl group) is desorbed from the compound including a carbon atom and a hydrogen atom. However, in the present invention, the hydrocarbon chain also includes a chain that includes a chain having an oxygen atom, a sulfur atom, or a nitrogen atom, for example, as in a hydrocarbon group represented by Formula (M2). A terminal group that may be present in a terminal of the hydrocarbon chain is not included in the hydrocarbon chain. This hydrocarbon chain may include a carbon-carbon unsaturated bond or may include a ring structure of an aliphatic ring and/or an aromatic ring. That is, the hydrocarbon chain may be a hydrocarbon chain including a hydrocarbon selected from an aliphatic hydrocarbon or an aromatic hydrocarbon.

The hydrocarbon chain only has to satisfy the molecular weight and includes a double hydrocarbon chain including a chain consisting of a hydrocarbon group having a low molecular weight and a hydrocarbon chain (also referred to as “hydrocarbon polymer chain”) consisting of a hydrocarbon polymer.

The hydrocarbon chain having a low molecular weight refers to a chain consisting of a typical (non-polymerizable) hydrocarbon group, and examples of the hydrocarbon group include an aliphatic or aromatic hydrocarbon group. Specifically, an alkylene group (having preferably 1 to 12 carbon atoms, more preferably 1 to 6 carbon atoms, and still more preferably 1 to 3 carbon atoms), an arylene group (having preferably 6 to 22 carbon atoms, more preferably 6 to 14 carbon atoms, and still more preferably 6 to 10 carbon atoms), or a group including a combination of the above-described groups is preferable. As the hydrocarbon group forming the hydrocarbon chain having a low molecular weight that can be used as R^{P2}, an alkylene group is more preferable, an alkylene group having 2 to 6 carbon atoms is still more preferable, and an alkylene group having 2 or 3 carbon atoms is still more preferable.

The aliphatic hydrocarbon group is not particularly limited, and examples thereof include a hydrogen reduced form of an aromatic hydrocarbon group represented by Formula (M2) and a partial structure (for example, a group consisting of isophorone) in a well-known aliphatic diisocyanate compound. In addition, a hydrocarbon group in each of exemplary components described below can also be used.

Examples of the aromatic hydrocarbon group include a hydrocarbon group in each of exemplary components described below, and a phenylene group or a hydrocarbon group represented by Formula (M2) is preferable.

[chemical structure]

In Formula (M2), X represents a single bond, —CH₂—, —C(CH₃)₂—, —SO₂—, —S—, —CO—, or —O—. From the viewpoint of binding properties, —CH₂— or —O— is preferable, and —CH₂— is more preferable. The alkyl group and alkylene group described herein may be substituent with a substituent Z and preferably a halogen atom (more preferably a fluorine atom).

R^{M2} to R^{M5} each independently represent a hydrogen atom or a substituent and preferably a hydrogen atom. The substituent that can be used as R^{M2} to R^{M5} is not particularly limited, and examples thereof include an alkyl group having 1 to 20 carbon atoms, an alkenyl group having 1 to 20 carbon atoms, —OR^{M6}, —N(R^{M6})₂, —SR^{M6} (R_{M6} represents a substituent and preferably an alkyl group having 1 to 20 carbon atoms or an aryl group having 6 to 10 carbon atoms), and a halogen atom (for example, a fluorine atom, a chlorine atom, or a bromine atom). Examples of —N(R^{M6})₂ include an alkylamino group (having preferably 1 to 20 carbon atoms and more preferably 1 to 6 carbon atoms) and an arylamino group (having preferably 6 to 40 carbon atoms and more preferably 6 to 20 carbon atoms).

The hydrocarbon polymer chain is a polymer chain obtained by polymerization of polymerizable hydrocarbons (at least two hydrocarbons) and is not particularly limited as long as it is a chain consisting of a hydrocarbon polymer having a large number of carbon atoms than the hydrocarbon chain having a low molecular weight. The hydrocarbon polymer chain is a chain consisting of a hydrocarbon polymer having preferably 30 or more and more preferably 50 or more carbon atoms. The upper limit of the number of carbon atoms forming the hydrocarbon polymer is not particularly limited and may be, for example, 3,000. The hydrocarbon polymer chain is preferably a chain consisting of a hydrocarbon polymer formed of an aliphatic hydrocarbon in which a main chain satisfies the above-described number of carbon atoms and more preferably a chain consisting of a polymer (preferably an elastomer) formed of an aliphatic saturated hydrocarbon or an aliphatic unsaturated hydrocarbon. Examples of the polymer include a diene polymer having a double bond in a main chain and a non-diene polymer not having a double bond in a main chain. Examples of the diene polymer include a styrene-butadiene copolymer, a styrene-ethylene-butadiene copolymer, a copolymer (preferably butyl rubber (IIR)) of isobutylene and isoprene, a butadiene polymer, an isoprene polymer, and an ethylene-propylene-diene copolymer. Examples of the non-diene polymer include an olefin polymer such as an ethylene-propylene copolymer or a styrene-ethylene-butylene copolymer and a hydrogen reduced form of the above-described diene polymer.

The hydrocarbon forming the hydrocarbon chain preferably has a reactive group at a terminal and more preferably has a terminal reactive group capable of polycondensation. The terminal reactive group capable of polycondensation or polyaddition forms a group bonded to R^{P1} or R^{P2} in each of the formulae by polycondensation or polyaddition. Examples of the terminal reactive group include an isocyanate group, a hydroxy group, a carboxy group, an amino group and an acid anhydride. In particular, a hydroxy group is preferable.

Examples of the polyalkylene oxide chain (polyalkyleneoxy chain) include a chain consisting of a well-known polyalkyleneoxy group. The number of carbon atoms in the alkyleneoxy group of the polyalkyleneoxy chain is preferably 1 to 10, more preferably 1 to 6, and still more preferably 2 or 3 (a polyethyleneoxy chain or a polypropyleneoxy chain). The polyalkyleneoxy chain may be a chain consisting of one alkyleneoxy group or may be a chain consisting of two or more alkyleneoxy groups (for example, a chain consisting of an ethyleneoxy group and a propyleneoxy group).

Examples of the polycarbonate chain or the polyester chain include a chain consisting of a well-known polycarbonate or polyester.

It is preferable that the polyalkyleneoxy chain, the polycarbonate chain, or the polyester chain includes an alkyl group (having preferably 1 to 12 carbon atoms and more preferably 1 to 6 carbon atoms) at a terminal.

The terminal of the polyalkyleneoxy chain, the polycarbonate chain, or the polyester chain that can be used as R^{P1} and R^{P2} can be appropriately changed to a typical chemical structure that can be incorporated into the component represented by each of the formulae as R^{P1} and R^{P2}. For example, the polyalkyleneoxy chain is incorporated as RP1 or RP2 of the component after a terminal oxygen atom is removed therefrom.

In the alkyl group in the molecular chain or at a terminal thereof, an ether group (—O—), a thioether group (—S—), a carbonyl group (>C═O), or an imino group (>NR^{N}: R^{N} represents a hydrogen atom, an alkyl group having 1 to 6 carbon atoms, or an aryl group having 6 to 10 carbon atoms) may be present.

In each of the formulae, R^{P1} and R^{P2} represent a divalent molecular chain but may represent a trivalent or higher molecular chain in which at least one hydrogen atom is substituted with —NH—CO—, —CO—, —O—, —NH—, or —N<.

Among the above-described molecular chains, R^{P1} represents preferably a hydrocarbon chain, more preferably a hydrocarbon chain having a low molecular weight, still more preferably a hydrocarbon chain consisting of an aliphatic or aromatic hydrocarbon group, and still more preferably a hydrocarbon chain consisting of an aromatic hydrocarbon group.

Among the above-described molecular chains, R^{P2} represents preferably a hydrocarbon chain having a low molecular weight (more preferably an aliphatic hydrocarbon group) or a molecular chain other than the hydrocarbon chain having a low molecular weight.

In Formula (I-5), R^{P3} represents an aromatic or aliphatic linking group (tetravalent) and preferably a linking group represented by any one of Formulae (i) to (iix).

[chemical structure]

In Formulae (i) to (iix), X¹ represents a single bond or a divalent linking group. As the divalent linking group, an alkylene group having 1 to 6 carbon atoms (for example, methylene, ethylene, or propylene) is preferable. As the propylene, 1,3-hexafluoro-2,2-propanediyl is preferable. L represents —CH₂═CH₂— or —CH₂—. R^{X} and R^{Y} each independently represent a hydrogen atom or a substituent. In each of the formulae, * represents a binding site to the carbonyl group in Formula (I-5). The substituent that can be used as R^{X} and R^{Y} is not particularly limited, and examples thereof include the substituent Z described below. In particular, an alkyl group (having preferably 1 to 12 carbon atoms, more preferably 1 to 6 carbon atoms, still more preferably 1 to 3 carbon atoms) or an aryl group (having preferably 6 to 22 carbon atoms, more preferably 6 to 14 carbon atoms, still more preferably 6 to 10 carbon atoms) is preferable.

R^{P1}, R^{P2}, and R^{P3} may each independently have a substituent. The substituent is not particularly limited, and examples thereof include the substituent Z described below. In particular, the substituents that can be used as R^{M2} are preferable.

Specific examples of the component represented by each of the formulae are not particularly limited and include a component derived from a compound corresponding to a polymer having each of bonds described below.

In a case where the sequential polymerization type polymer includes the component represented by any one of Formulae (I-1) to (I-6), the content thereof is not particularly limited and can be appropriately set in consideration of the content of a component (K) described below or the like. For example, a ratio between a total content of the component represented by Formula (I-1), (I-2), or (I-5) and a total content of the component represented by Formula (I-3), (I-4), or (I-6) is set in a range of 40 to 60:60 to 40 by molar ratio. However, in a case where the component (K) described below, a component that has a group having 6 or more carbon atoms at a side chain, a component derived from a macromonomer also corresponds to the component represented by each of the formulae, the total content thereof includes the contents of the components.

(Polymer having Amide Bond)

Examples of the polymer having an amide bond include polyamide.

The polyamide can be obtained by condensation polymerization of a diamine compound and a dicarboxylic acid compound or by ring-opening polymerization of a lactam.

Examples of the diamine compound include an aliphatic diamine compound such as ethylenediamine, 1-methylethyldiamine, 1,3-propylenediamine, tetramethylenediamine, pentamethylenediamine, heptamethylenediamine, octamethylenediamine, nonamethylenediamine, decamethylenediamine, undecamethylenediamine, dodecamethylenediamine, cyclohexanediamine, or bis-(4,4′-aminohexyl)methane, and an aromatic diamine such as paraxylylenediamine or 2,2-bis(4-aminophenyl)hexafluoropropane. In addition, as a commercially available product of the diamine having a polypropyleneoxy chain, for example, “JEFFAMINE” series (trade name, manufactured by Huntsman, manufactured by Mitsui Chemicals Inc.) can be used. Examples of “JEFFAMINE” series include JEFFAMINE D-230, JEFFAMINE D-400, JEFFAMINE D-2000, JEFFAMINE XTJ-510, JEFFAMINE XTJ-500, JEFFAMINE XTJ-501, JEFFAMINE XTJ-502, JEFFAMINE HK-511, JEFFAMINE EDR-148, JEFFAMINE XTJ-512, JEFFAMINE XTJ-542, JEFFAMINE XTJ-533, and JEFFAMINE XTJ-536.

Examples of the dicarboxylic acid compound include an aliphatic dicarboxylic acid such as phthalic acid, malonic acid, succinic acid, glutaric acid, sebacic acid, pimelic acid, suberic acid, azelaic acid, undecanoic acid, undecanedioic acid, dodecanedioic acid, dimer acid, or 1,4-cyclohexanedicarboxylic acid, and an aromatic dicarboxylic acid such as paraxylylene dicarboxylic acid, metaxylylene dicarboxylic acid, 2,6-naphthalenedicarboxylic acid, or 4,4′-diphenyldicarboxylic acid.

As each of the diamine compound and the dicarboxylic acid compound, one kind or two or more kinds can be used. In addition, in the polyamide, a combination of the diamine compound and the dicarboxylic acid compound is not particularly limited.

The lactam is not particularly limited, and a typical lactam that can form a polyamide can be used without any particular limitation.

(Polymer having Urea Bond)

Examples of the polymer having a urea bond include polyurea. The polyurea can be synthesized by condensation polymerization of a diisocyanate compound and a diamine compound in the presence of an amine catalyst.

Specific examples of the diisocyanate compound is not particularly limited and can be appropriately selected depending on the purposes. Specific examples of the diisocyanate compound include: an aromatic diisocyanate compound such as 2,4-tolylene diisocyanate, a dimer of 2,4-tolylene diisocyanate, 2,6-tolylene diisocyanate, p-xylylene diisocyanate, m-xylylene diisocyanate, 4,4′-diphenylmethane diisocyanate (MDI), 1,5-naphthylene diisocyanate, or 3,3′-dimethylbiphenyl-4,4′-diisocyanate; an aliphatic diisocyanate compound such as hexamethylene diisocyanate, trimethylhexamethylene diisocyanate, lysine diisocyanate, or dimer acid diisocyanate; an alicyclic diisocyanate compound such as isophorone diisocyanate, 4,4′-methylene bis(cyclohexyl isocyanate), methylcyclohexane-2,4 (or 2,6)-diyldiisocyanate, or 1,3-(isocyanatomethyl) cyclohexane; and a diisocyanate compound which is a reaction product between a diol and a diisocyanate such as an adduct of one mole of 1,3-butylene glycol and two moles of tolylene diisocyanate. Among these, 4,4′-diphenylmethane diisocyanate (MDI) or 4,4′-methylene bis(cyclohexyl isocyanate) is preferable.

Specific examples of the diamine compound include the above-described compound examples.

As each of the diisocyanate compound and the diamine compound, one kind or two or more kinds can be used. In addition, in the polyurea, a combination of the diisocyanate compound and the diamine compound is not particularly limited.

(Polymer Having Imide Bond)

Examples of the polymer having an imide bond include polyimide. The polyimide is typically obtained by forming polyamic acid through an addition reaction of tetracarboxylic dianhydride and a diamine compound and closing the ring.

Specific examples of the tetracarboxylic dianhydride include 3,3′4,4′-biphenyl tetracarboxylic dianhydride (s-BPDA), pyromellitic dianhydride (PMDA), 2,3,3′,4′-biphenyl tetracarboxylic dianhydride (a-BPDA), oxydiphthalic dianhydride, diphenylsulfone-3,4,3′,4′-tetracarboxylic dianhydride, bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenone tetracarboxylic dianhydride, 3,3′,4,4′-benzophenone tetracarboxylic dianhydride, bis(3,4-dicarboxyphenyl)methane dianhydride, 2,2-bis(3,4-dicarboxyphenyl)propane dianhydride, p-phenylene bis(trimellitic monoester anhydride), p-biphenylene bis(trimellitic monoester anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]ropane dianhydride, 2,3,6,7-naphthalenctetracarboxylic dianhydride, 1,4,5,8-naphthalenetetracarboxylic dianhydride, and 4,4′-(2-2-hexafluoroisopropylidene)diphthalic dianhydride. Among these examples, one kind may be used alone, or a mixture of two or more kinds may be used.

It is preferable that the tetracarboxylic acid component includes at least one of s-BPDA or PMDA. For example, the content of s-BPDA with respect to 100 mol % of the tetracarboxylic acid component is preferably 50 mol % or higher, more preferably 70 mol % or higher, and still more preferably 75 mol % or higher. It is preferable that the tetracarboxylic dianhydride includes a rigid benzene ring.

Specific examples of the diamine compound include the above-described compound examples.

The diamine compound has a structure having an amino group at opposite terminals of a polyethylene oxide chain, a polypropylene oxide chain, a polycarbonate chain, or a polyester chain.

As each of the tetracarboxylic dianhydride and the diamine compound, one kind or two or more kinds can be used. In addition, in the polyimide, a combination of the tetracarboxylic dianhydride and the diamine compound is not particularly limited.

(Polymer Having Urethane Bond)

Examples of the polymer having a urethane bond include polyurethane. The polyurethane can be obtained by condensation polymerization of a diisocyanate compound and a diol compound in the presence of catalysts of titanium, tin, and bismuth.

Specific examples of the diisocyanate compound include the above-described compound examples.

Specific examples of the diol compound include ethylene glycol, diethylene glycol, triethylene glycol, tetraethylene glycol, propylene glycol, dipropylene glycol, polyethylene glycol, (for example, polyethylene glycol having an average molecular weight of 200, 400, 600, 1000, 1500, 2000, 3000, or 7500), polypropylene glycol (for example, polypropylene glycol having an average molecular weight of 400, 700, 1000, 2000, 3000, or 4000), neopentylglycol, 1,3-butylene glycol, 1,4-butanediol, 1,3-butanediol, 1,6-hexanediol, 2-butene-1,4-diol, 2,2,4-trimethyl-1,3-pentanediol, 1,4-bis-β-hydroxyethoxycyclohexane, cyclohexanedimethanol, tricyclodecanedimethanol, hydrogenated bisphenol A, hydrogenated bisphenol F, an ethylene oxide adduct of bisphenol A, a propylene oxide adduct of bisphenol A, an ethylene oxide adduct of bisphenol F, and a propylene oxide adduct of bisphenol F. The diol compound is available as a commercially available product, and examples thereof include a polyether diol compound, a polyester diol compound, and a polycarbonate diol compound, a polyalkylene diol compound, and a silicone diol compound.

As the diol compound, at least one of a polyethylene oxide chain, a polypropylene oxide chain, a polycarbonate chain, a polyester chain, a polybutadiene chain, a polyisoprene chain, a polyalkylene chain, or a silicone chain is preferable. In addition, from the viewpoint of improving adsorption to a sulfide-based inorganic solid electrolyte or an active material, it is preferable that the diol compound includes a carbon-carbon unsaturated bond or a polar group (an alcoholic hydroxyl group, a phenolic hydroxyl group, a thiol group, a carboxy group, a sulfonate group, a sulfonamide group, a phosphate group, a nitrile group, an amino group, a dipolar ion-containing group, a metal hydroxide, or a metal alkoxide). As the diol compound, for example, 2,2-bis(hydroxymethyl)propionic acid can be used. As a commercially available product of the diol compound having a carbon-carbon unsaturated bond, BLEMMER GLM (manufactured by NOF Corporation) or a compound described in JP2007-187836A can be preferably used.

In the case of the polyurethane, as a polymerization inhibitor, monoalcohol or monoamine can be used. The polymerization inhibitor is introduced into a terminal portion of the polyurethane main chain. As a method of introducing a soft segment into a polyurethane terminal, for example, polyalkylene glycol monoalkyl ether (polyethylene glycol monoalkyl ether or polypropylene monoalkyl ether is preferable), polycarbonate diol monoalkyl ether, polyester diol monoalkyl ether, polyester monoalcohol can be used.

In addition, by using monoalcohol or monoamine having a polar group or a carbon-carbon unsaturated bond, the polar group or the carbon-carbon unsaturated bond can be introduced into a terminal of the polyurethane main chain. For example, hydroxyacetic acid, hydroxypropionic acid, 4-hydroxybenzyl alcohol, 3-mercapto-1-propanol, 2,3-dimercapto-1-propanol, 3-mercapto-1-hexanol, 3-hydroxypropanesulfonic acid, 2-cyanoethanol, 3-hydroxyglutaronitrile, 2-aminoethanol, 2-hydroxyethyl methacrylate, 2-hydroxyethyl acrylate, or N-methacrylene diamine can be used.

As each of the diisocyanate compound, the diol compound, the polymerization inhibitor, and the like, one kind or two or more kinds can be used.

In addition, in the polyurethane, a combination of the diisocyanate compound and the diol compound is not particularly limited.

In the present invention, as at least one component (a raw material compound to be sequential polymerization type) for forming a repeating unit of the sequential polymerization type polymer, the polymer includes a component (hereinafter, also referred to as “component (K)”) including a binding site represented by Formula (H-1) or (H-2) described below at a side chain and having a C log P value of 4 or lower and a molecular weight of lower than 1000. It is preferable that the component (K) has the same definition as the component (K) in an addition polymerization type polymer described below, except that the molecular chain that is incorporated into the main chain of the polymer is a molecular chain obtained by sequential polymerization of the raw material compound.

Examples of the raw material compound for deriving the component (K) include a raw material compound having a group represented by -L²¹-X²¹—C(═X²³)—X²²-L²²-R¹⁴ in Formula (R-1) described below and a raw material compound having a group represented by -L²³-C(X²⁴)-L²⁴)-X²⁵-L²⁵-R¹⁸ in Formula (R-2). More specifically, for example, a compound for deriving the component represented by any one of Formulae (I-1) to (I-6) that includes Re, R^{P2}, or R^{P3} having the group represented by -L²¹-X²¹—C(═X²³)—X²²-L²²-R¹⁴ or the group represented by -L²³-C(X²⁴)-L²⁴)-X²⁵-L²⁵-R¹⁸ or a compound for deriving a component having —CO—, —NHCO—, —O—, or —NH— at opposite terminals (binding sites) of the component represented by Formula (R-1) (preferably Formula (R-21)) or Formula (R-2) (preferably Formula (R-22)) can be used. For example, in the case of a polyurethane resin, an isocyanate compound or a diol compound that can derive the component (K) can be used, and specific examples thereof include a diol compound M-18 used in Examples described below.

It is preferable that the sequential polymerization type polymer includes a component that has a group having 6 or more carbon atoms at a side chain and/or a component derived from a macromonomer. This component can be introduced into the sequential polymerization type polymer by using a raw material compound that has a group having 6 or more carbon atoms or a raw material compound having a polymer chain. Examples of the component that has a group having 6 or more carbon atoms at a side chain include a compound for deriving the component represented by any one of Formulae (I-1) to (I-6) that includes R^{P1}, R^{P2}, or R^{P3} having a group with 6 or more carbon atoms as a substituent. The group that has a group having 6 or more carbon atoms will be described below. Examples of the macromonomer used for the sequential polymerization type polymer include a macromonomer (a component derived from the macromonomer) that is included in an addition polymerization type polymer described below and into which a functional group capable of sequential polymerization is introduced and a raw material compound having a polymer chain. Among these, a raw material compound having a functional group capable of sequential polymerization at an end portion of a polymer chain is preferable. As the raw material compound, for example, a compound for deriving the component represented by any one of Formulae (I-1) to (I-4) and (I-6) that has a molecular chain having a mass average molecular weight of 1000 or higher among the molecular chains that can be used as R^{P1} or R^{P2} can be used, and examples thereof include a terminal-modified hydrocarbon polymer. In particular, a terminal-modified product of a diene (non-diene) elastomer is preferable, and specific examples thereof include a macromonomer (MM-4) used in Examples below.

In addition, the sequential polymerization type polymer may include a component other than the above-described respective components.

In the sequential polymerization type polymer, the content of each of the component (K), the component that has a group having 6 or more carbon atoms at a side chain, and the component derived from the macromonomer is not particularly limited and is preferably the same as the content thereof in a (meth)acrylic resin described below.

(Addition Polymerization Type Polymer)

In a case where the polymer forming the particle binder is an addition polymerization type polymer such as a polyvinyl resin or a (meth)acrylic resin, the polymer includes a component (K) described below as one repeating unit. In case of being incorporated into the polymer, the component (K) is a component including a binding site represented by Formula (H-1) or (H-2) at a side chain and having a C log P value of 4 or lower and a molecular weight of lower than 1000.

The C log P value of the component (K) is 4 or lower. In a case where the particle binder includes a polymer including the component (K) that includes the specific binding site described below and has a molecular weight of lower than 1000 and a C log P value of 4 or lower, as described above, the dispersibility of the solid electrolyte composition and the binding properties between solid particles and the like can be improved. From the viewpoint of further improving the above-described properties on a higher level, the C log P value of the component (K) is preferably 2.5 or lower, more preferably 2.4 or lower, and still more preferably 2.3 or lower. The lower limit is not particularly limited, and is practically −10 or higher and preferably −2 or higher.

In the present invention, the C log P value refers to a value obtained by calculating a common logarithm Log P of a partition coefficient P between 1-octanol and water. As a method or software used for calculating the C Log P value, a well-known one can be used. In the present invention, unless specified otherwise, the C Log P value is a value calculated after drawing a structure using ChemBioDraw Ultra (version 13.0, manufactured by PerkinElmer Co., Ltd.).

The molecular weight of the component (K) is lower than 1000. In a case where the particle binder includes a polymer including the component (K) that includes the specific binding site described below and has a C log P value of 4 or lower and a low molecular weight of lower than 1000, the dispersibility of the solid electrolyte composition and the binding properties between the solid particles can be improved. From the viewpoint of further improving the above-described properties on a higher level, the molecular weight of the component (K) is preferably 700 or lower, more preferably 500 or lower, and still more preferably 300 or lower. The lower limit is not particularly limited and is preferably 100 or higher and more preferably 200 or higher. The content of the component (K) described in the present invention refers to the molecular weight of the compound (the component (K) removed from the polymer, for example, a compound corresponding to the component (K) shown in Specific examples below) that derives the component (K) incorporated into the polymer.

The component (K) in the polymer includes a binding site represented by Formula (H-1) or (H-2) at a side chain and preferably includes a binding site represented by Formula (H-1) (H-2)

[chemical structure]

In the formula, a wave line portion represents a binding position, and any of the binding positions may be the binding site bonded to the main chain side of the polymer. The binding position bonded to the main chain side of the polymer is, for example, preferably X¹¹ in Formula (H-1) and a carbon atom bonded to X¹⁴ in Formula (H-2).

X¹¹, X¹², X¹³, and X¹⁵ each independently represent an imino group, an oxygen atom, a sulfur atom, or a selenium atom. Examples of the imino group that can be used as X¹¹, X¹², and X¹⁵ include —NR^{N}—, and examples of the imino group that can be used as X¹³ include ═NR^{N}. R^{N} represents a hydrogen atom or a substituent. Irrespective of whether the imino group represents —NR^{N}— or ═NR^{N}, it is preferable that R^{N} represents a hydrogen atom. The substituent which may be used as R^{N} is not particularly limited, and examples thereof include groups selected from the substituent T described below. In particular, for example, an alkyl group, an aryl group, or a heterocyclic group (preferably, a pyridine ring group, an azolidine ring group, an azole ring group (a ring group obtained by removing one hydrogen atom from a heterocyclic 5-membered ring compound having one or more nitrogen atoms), an oxole ring group (a ring group obtained by removing one hydrogen atom from dioxolane), a thiophene ring group, an imidazole ring group, or an imidazoline ring group) is preferable.

X¹¹, X¹², X¹³, and X¹⁵ each independently represent preferably an imino group, an oxygen atom, or a sulfur atom. X¹¹ and X¹² each independently represent more preferably an imino group or an oxygen atom and still more preferably an imino group. X¹³ represents more preferably an oxygen atom. X¹⁵ represents more preferably an imino group or an oxygen atom and still more preferably an imino group.

X¹⁴ represents an amino group, a hydroxy group, a sulfanyl group, or a carboxy group, preferably a hydroxy group or a sulfanyl group, and more preferably a hydroxy group. The amino group that can be used as X⁴ is not particularly limited and has the same definition as that of the amino group in the substituent T described below.

L¹¹ represents an alkylene group or an alkenylene group having 4 or less carbon atoms having 4 or less carbon atoms as a linking group, preferably an alkylene group having 4 or less carbon atoms, and more preferably an alkylene group having 2 or less carbon atoms. Examples of the alkylene group having 4 or less carbon atoms include methylene, ethylene, propylene, butylene, and 1- or 2-methylpropylene. Among these, methylene, ethylene, or butylene is preferable, and methylene is more preferable. Examples of the alkenylene group having 4 or less carbon atoms include vinylene, propenylene, and butenylene.

In the binding site in Formula (H-1), a combination of X¹¹, X¹², and X¹³ is not particularly limited, a combination in which X¹¹ and X¹² each independently represent an imino group or an oxygen atom and X¹³ represents an oxygen atom is preferable, a combination in which one of X¹¹ and X¹² represents an imino group, another one of X¹¹ and X¹² represents an imino group or an oxygen atom, and X represents an oxygen atom is more preferable, and a combination in which X¹¹ represents an imino group, X¹² represents an imino group or an oxygen atom, and X represents an oxygen atom is still more preferable, and a combination in which X¹¹ and X¹² represents an imino group and X¹³ represents an oxygen atom is still more preferable. Specific examples of the binding site including this combination include a urea binding site, a urethane binding site, and a carbonate binding site. In particular, a urea binding site or a urethane binding site is preferable, and a urea binding site is more preferable. In the urethane binding site, it is preferable that a nitrogen atom is a binding position bonded to the main chain side of the polymer.

In the binding site in Formula (H-2), a combination of X¹⁴, X¹⁵, and L¹¹ is not particularly limited, a combination in which X¹ represents an imino group or an oxygen atom, X¹⁴ represents an amino group, a hydroxy group, a sulfanyl group, or a carboxy group, and L¹¹ represents an alkylene group or an alkenylene group having 4 or less carbon atoms having 4 or less carbon atoms as a linking group is preferable, and a combination in which X¹⁵ represents an imino group, X¹⁴ represents an amino group, a hydroxy group, a sulfanyl group, or a carboxy group, and L¹¹ represents an alkylene group or an alkenylene group having 4 or less carbon atoms having 4 or less carbon atoms as a linking group is more preferable.

The component (K) includes the molecular chain that is incorporated into the main chain of the polymer. This molecular chain is a chain obtained by polymerization of a polymerizable group in a polymerizable compound that derives the component (K). This molecular chain is appropriately determined depending on the kind of the polymer. In a case where the kind of the polymer is an addition polymerization type polymer, the molecular chain is, for example, a carbon chain or a typical ethylene chain. In a case where the kind of the polymer is a sequential polymerization type polymer, the molecular chain is, for example, a polyol chain or a polyamine chain. In the present invention, the number of polymerizable groups in one molecule of the polymerizable compound that derives the component (K) is not particularly limited and is preferably 1 to 4 and more preferably 1.

In the component (K), the molecular chain and the specific binding site may be may be bonded to each other directly (without a linking group) or through a linking group. In the present invention, an aspect where the molecular chain and the specific binding site are bonded to each other through a linking group is preferable.

The linking group is not particularly limited and has the same definition as that of L²¹ in Formula (R-1) described below, and preferable examples thereof include a —CO—O-alkylene group, a —CO—N(R^{N})-alkylene group, a —CO—O-alkylene-O-alkylene group, and a —CO—N(R^{N})-alkylene-O-alkylene group. R^{N} is as described above.

The component (K) includes a terminal group linked to the specific binding site. Examples of the terminal group include a hydrogen atom and a substituent. Among these, a substituent is preferable. The substituent which may be used as the terminal group is not particularly limited, and examples thereof include groups selected from the substituent T described below. In particular, a group represented by -L²²-R¹⁴ in Formula (R-1) is preferable, and an alkyl group, an aryl group, a heterocyclic group (preferably, a pyridine ring group, an azolidine ring group, an azole ring group (a ring group obtained by removing one hydrogen atom from a heterocyclic 5-membered ring compound having one or more nitrogen atoms), an oxole ring group (a ring group obtained by removing one hydrogen atom from dioxolane), a thiophene ring group, an imidazole ring group, or an imidazoline ring group), a hydroxy group, a carboxy group, or an acyl group is more preferable. This terminal group may further include, as a substituent, a group selected from the substituent T described below or a functional group selected from the group (a) of functional groups.

Among the components (K), a component that is suitably used for the addition polymerization type polymer, in particular, the polyvinyl resin, or the (meth)acrylic resin will be described specifically and in detail.

As the component that is used for the polyvinyl resin or the (meth)acrylic resin, a component represented by Formula (R-1) or (R-2) among the above-described components is preferable.

[chemical structure]

The component represented by Formula (R-1) includes an ethylene chain as a molecular chain, -L²¹- as a linking group, —X²¹—C(═X²³)—X²²— as the binding site represented by Formula (H-1), and -L²²-R¹⁴ as a terminal group.

In addition, the component represented by Formula (R-2) includes an ethylene chain as a molecular chain, L²³ as a linking group, —C(X²⁴)-L²⁴-X²⁵— as the binding site represented by Formula (H-2), and -L²⁵-R¹⁸ as a terminal group.

In Formulae (R-1) and (R-2), X²¹, X²², X²³, and X²⁵ each independently represent an imino group, an oxygen atom, or a sulfur atom. X²¹, X²², X²³, and X²⁵ have the same definitions as those of X¹¹, X¹², X¹³, and X¹⁵ in Formulae (H-1) and (H-2) except that X²¹, X²², X²³, and X²⁵ each independently represent a selenium atom.

X²⁴ has the same definition as that of X¹⁴ in Formula (H-2) except that X²⁴ represents a hydroxy group or a sulfanyl group without representing an amino group and a carboxy group.

L²⁴ represents an alkylene group or an alkenylene group having 4 or less carbon atoms having 4 or less carbon atoms and has the same definition as that of L¹¹ in Formula (H-2).

A combination of X²¹, X²², and X²³ has the same definition as that of the combination of X¹¹, X¹², and X¹³. A combination of X²⁴, L²⁴, and X²⁵ has the same definition as that of the combination of X¹⁴, L¹¹, and X¹⁵.

R¹¹ to R¹³ and R¹⁵ to R¹⁷ each independently represent a hydrogen atom, a cyano group, a halogen atom, or an alkyl group. Examples of the halogen atom that can be used as R¹¹ to R¹³ and R¹⁵ to R¹⁷ include a fluorine atom, a chlorine atom, and a bromine atom. The alkyl group that can be used as R¹¹ to R¹³ and R¹⁵ to R¹⁷ is not particularly limited and is preferably an alkyl group having 1 to 24 carbon atoms, more preferably an alkyl group having 1 to 12 carbon atoms, and still more preferably an alkyl group having 1 to 6 carbon atoms.
R¹¹, R¹², R¹⁵, and R¹⁶ each independently represent preferably a hydrogen atom or an alkyl group and more preferably a hydrogen atom. R¹³ and R¹⁴ each independently represent preferably a hydrogen atom, a halogen atom, or an alkyl group, more preferably a hydrogen atom or an alkyl group, and still more preferably a hydrogen atom or methyl.

L²¹ to L²³ and L²⁵ each independently represent an alkylene group having 1 to 16 carbon atoms, an alkenylene group having 2 to 16 carbon atoms, an arylene group having 6 to 24 carbon atoms, an oxygen atom (—O—), a sulfur atom (—S—), an imino group (—N(R^{N})—), a carbonyl group, a phosphate linking group (—O—P(OH)(O)—O—), a phosphonate linking group (—P(OH)(O)—O—), or a linking group including a combination thereof. R^{N} is as described above and may be bonded to another substituent such as R¹ present in the vicinity of R^{N} to form a ring.

The number of carbon atoms in the alkylene group that can be used as L²¹ to L²³ and L²⁵ is preferably 1 to 8, more preferably 1 to 6, and still more preferably 1 to 4. The number of carbon atoms in the alkenylene group that can be used as L² to L² and L²⁵ is preferably 2 to 8, more preferably 2 to 6, and still more preferably 2 to 4. The number of carbon atoms in the arylene group that can be used as L² to L² and L² is preferably 6 to 12. In a case where 1 to L² and L² represents a linking group including a combination of the above-described groups, the number of groups to be used in combination is not particularly limited as long as it is 2 or more, and is, for example, preferably 2 to 100 and more preferably 2 to 6.

It is preferable that L²¹ to L²³ and L²⁵ each independently represent an alkylene group having 1 to 16 carbon atoms, an arylene group having 6 to 12 carbon atoms, an oxygen atom, a sulfur atom, an imino group, a carbonyl group, or a linking group including a combination thereof.

In the case of a component that is used for the (meth)acrylic resin, L²¹ and L²³ each independently represent preferably a linking group including a combination of groups or atoms (the number of groups to be used in combination is as described above) selected from the group consisting of an alkylene group having 1 to 16 carbon atoms, an alkenylene group having 2 to 16 carbon atoms, an arylene group having 6 to 24 carbon atoms, an oxygen atom, a sulfur atom, an imino group, a carbonyl group, a phosphate linking group, a phosphonate linking group, or a linking group including a combination thereof, more preferably an alkylene group having 1 to 16 carbon atoms, an arylene group having 6 to 12 carbon atoms, an oxygen atom, a sulfur atom, an imino group, a carbonyl group, or a linking group including a combination thereof, still more preferably a linking group (ester bond) including a combination of at least a carbonyl group and an oxygen atom or still more preferably a linking group (amide bond) including a combination of at least a carbonyl group and an imino group, and still more preferably a linking group consisting of a carbonyl group, an oxygen atom, and an alkylene group having 1 to 16 carbon atoms or a linking group consisting of a carbonyl group, an imino group, and an alkylene group having 1 to 16 carbon atoms.

L²² and L²⁵ each independently represent preferably an alkylene group having 1 to 16 carbon atoms, an alkenylene group having 2 to 16 carbon atoms, an arylene group having 6 to 24 carbon atoms, an oxygen atom, a sulfur atom, an imino group, a carbonyl group, or a linking group including a combination thereof.

L²² represents more preferably an alkylene group having 1 to 16 carbon atoms or an arylene group having 6 to 24 carbon atoms, still more preferably an alkylene group having 1 to 16 carbon atoms, still more preferably an alkylene group having 1 to 8 carbon atoms, and still more preferably an alkylene group having 1 to 6 carbon atoms.

L²⁵ represents preferably an alkylene group having 1 to 16 carbon atoms, an arylene group having 6 to 24 carbon atoms, a carbonyl group, or a linking group including a combination thereof. The number of groups to be used in combination is as described above.

R¹⁴ and R¹⁸ each independently represent a hydrogen atom or a substituent. The substituent which may be used as R¹⁴ and R¹⁸ is not particularly limited, and examples thereof include a group selected from the substituent T described below and a functional group selected from the group (a) of functional groups. In particular, for example, an alkyl group, an aryl group, a carboxy group, an acyl group, an alkoxycarbonyl group, a hydroxy group, a heterocyclic group (preferably, a pyridine ring group, an azolidine ring group, an azole ring group (a ring group obtained by removing one hydrogen atom from a heterocyclic 5-membered ring compound having one or more nitrogen atoms), an oxole ring group (a ring group obtained by removing one hydrogen atom from dioxolane), a thiophene ring group, an imidazole ring group, or an imidazoline ring group) is preferable.

In a case where -L²²-R¹⁴ and -L²⁵-R¹⁸ each independently represent one substituent, L²² and L²⁵ represent a residue obtained by removing one hydrogen atom from the substituent, and R¹⁴ and R¹⁸ represent a hydrogen atom. For example, in an exemplary component K-4 (-L²²-R¹⁴ represents a hexyl group), -L²² represents a hexylene group, and R¹⁴ represents a hydrogen atom.

In addition, in a case where -L²²-R¹⁴ and -L²⁵-R¹⁸ each independently represent a group consisting of two or more groups, R¹⁴ and -L²⁵-R¹⁸ represent a terminal group without representing a hydrogen atom. For example, in an exemplary component K-1 (-L²²-R¹⁴ represents a benzyl group) described below, -L²²- does not represent —CH₂—C₆H₄—, R¹⁴ does not represent a hydrogen atom, -L²² represents a methylene group, and R¹⁴ represents a phenyl group.

It is preferable that the component (K) is a component represented by Formula (R-21) or (R-22).

[chemical structure]

The component represented by Formula (R-21) includes an ethylene chain as a molecular chain, —CO—Y¹¹-L³¹- as a linking group, —X³¹—C(═X³³)—X³²— as the binding site represented by Formula (H-1), and -L³²-R²⁴ as a terminal group.

In addition, the component represented by Formula (R-22) includes an ethylene chain as a molecular chain, —CO—Y¹²-L³³- as a linking group, —C(X³⁴)-L³⁴-X³⁵— as the binding site represented by Formula (H-2), and -L³⁵-R²⁸ as a terminal group.

In Formulae (R-21) and (R-22), X³¹, X³², and X³⁵ each independently represent an imino group (—N(R^{N})—: R^{N} is as described above) or an oxygen atom. X³¹, X³², and X³⁵ have the same definitions as those of X¹¹, X¹², and X¹⁵ in Formulae (H-1) and (H-2) except that X³¹, X³², and X³⁵ each independently represent a sulfur atom or a selenium atom. X³³ represents an oxygen atom. X³⁴ has the same definition as that of X¹⁴ in Formula (H-2) except that X³⁴ represents a hydroxy group without representing a sulfanyl group, an amino group, and a carboxy group.

L³⁴ represents an alkylene group having 2 or less carbon atoms as a linking group. The alkylene group having 2 or less carbon atoms is the same as described regarding L11 in Formula (H-2).

A combination of X³¹, X³², and X³³ has the same definition as that of the combination of X¹¹, X¹², and X¹³. A combination of X³⁴, L³⁴, and X³⁵ has the same definition as that of the combination of X¹⁴, L¹¹, and X¹⁵.

R²¹ to R²³ and R²⁵ to R²⁷ have the same definitions as those of R¹¹ to R¹³ and R¹⁵ to R¹⁷ in Formulae (R-1) and (R-2), except that R²¹ to R²³ and R²⁵ to R²⁷ each independently represent a hydrogen atom, a cyano group, or an alkyl group without representing a halogen atom.

Y¹¹ and Y¹² each independently represent an imino group (—N(R^{N})—: R^{N} is as described above) or an oxygen atom and preferably an oxygen atom.

L³¹ to L³³ and L³⁵ each independently represent an alkylene group having 1 to 16 carbon atoms, an arylene group having 6 to 12 carbon atoms, an oxygen atom, a sulfur atom, an imino group, a carbonyl group, or a linking group including a combination thereof. L³¹ and L³³ represent preferably an alkylene group having 1 to 16 carbon atoms or an arylene group having 6 to 12 carbon atoms, more preferably an alkylene group having 1 to 16 carbon atoms, still more preferably an alkylene group having 1 to 8 carbon atoms, still more preferably an alkylene group having 1 to 6 carbon atoms, and still more preferably an alkylene group having 1 to 4 carbon atoms. L³² represents preferably an alkylene group having 1 to 16 carbon atoms or an arylene group having 6 to 12 carbon atoms, more preferably an alkylene group having 1 to 16 carbon atoms, still more preferably an alkylene group having 1 to 8 carbon atoms, and still more preferably an alkylene group having 1 to 6 carbon atoms. L³⁵ represents preferably an alkylene group having 1 to 16 carbon atoms, an arylene group having 6 to 12 carbon atoms, a carbonyl group, or a linking group including a combination thereof. The number of groups to be used in combination is the same as that of L²⁵.

R²⁴ and R²⁸ each independently correspond R¹⁴ or R¹⁸ and represent a hydrogen atom, a hydroxy group, an alkyl group having 1 to 6 carbon atoms, a phenyl group, or a carboxy group.

Specific examples of the component (K) will be shown below together with C log P values, but the present invention is not limited thereto. Among the following specific examples, K-18 is a specific example of the component (K) in the sequential polymerization type polymer. Components other than K-18 among the following specific examples are components for forming (meth)acrylic resins and can be made to be components in the various polymers by appropriately changing the molecular chain (ethylene chain) and the linking group (—CO—O-alkylene group).

[chemical structure]

[chemical structure]

[chemical structure]

[chemical structure]

[chemical structure]

[chemical structure]

[chemical structure]

The content of the component (K) in the polymer is not particularly limited and is preferably 20 mass % or higher and lower than 90 mass %. As a result, a balance between a component (M2) and/or a component (MM) can be improved, and the dispersibility of the solid electrolyte composition, the binding properties between the solid particles and the like, and the ion conductivity can be exhibited on a higher level. The content of the component (K) in the polymer is more preferably 25 mass % or higher and still more preferably 30 mass % or higher. The upper limit is more preferably 75 mass % or lower and still more preferably 70 mass % or lower.

In a case where the polymer forming the particle binder is an addition polymerization type polymer such as a polyvinyl resin or a (meth)acrylic resin, it is preferable that the polymer includes a component other than the component (K). Examples of the component (hereinafter, referred to as “component (M2)”) include a component that does not include the binding site represented by Formula (H-1) or (H-2) and has a molecular weight of lower than 1000. In addition, as the component (M2), a component that has a group having 6 or more carbon atoms at a side chain in case of being incorporated into the polymer can also be used. In particular, a component that does not include the binding site represented by Formula (H-1) or (H-2), has a molecular weight of lower than 1000, and has a group having 6 or more carbon atoms at a side chain is preferable. In a case where the component (M2) is a component that has a group having 6 or more carbon atoms at a side chain, a balance with the component (K) and the component (MM) derived from the macromonomer described below in the polymer can be improved, and the dispersibility of the solid electrolyte composition, the binding properties between the solid particles and the like, and the ion conductivity can be exhibited on a higher level with a good balance.

From the viewpoint of the dispersibility, the binding properties, and the ion conductivity, the group having 6 or more carbon atoms is preferably a group having 6 to 30 carbon atoms, more preferably a group having 8 to 24 carbon atoms, and still more preferably a group having 8 to 16 carbon atoms. The group having 6 or more carbon atoms may include a heteroatom. It is preferable that the group having 6 or more carbon atoms is a terminal group in the component.

The C log P value of the component (M2) is not particularly limited.

Examples of the component (M2) include a component derived from a polymerizable compound (m2) that is copolymerizable with the polymerizable compound that derives the component (K). Examples of the polymerizable compound (m2) include a compound having a polymerizable group (for example, a group having an ethylenically unsaturated bond), for example, various vinyl compounds and/or (meth)acrylic compounds. In particular, it is preferable that a (meth)acrylic compound is used. A (meth)acrylic compound selected from a (meth)acrylic acid compound, a (meth)acrylic acid ester compound, and a (meth)acrylonitrile compound is more preferable. It is preferable that the polymerizable compound (m2) has a group having 6 or more carbon atoms, in a case where the polymerizable compound (m2) is incorporated into the polymer, a component that has a group having 6 or more carbon atoms at a side chain is produced. The number of polymerizable groups in one molecule of the polymerizable compound is not particularly limited and is preferably 1 to 4 and more preferably 1.

As the vinyl compound or the (meth)acrylic compound, a compound represented by Formula (b-1) is preferable.

[chemical structure]

In the formula, R¹ represents a hydrogen atom, a hydroxy group, a cyano group, a halogen atom, an alkyl group (having preferably 1 to 24 carbon atoms, more preferably 1 to 12 carbon atoms, and still more preferably 1 to 6 carbon atoms), an alkenyl group (having preferably 2 to 24 carbon atoms, more preferably 2 to 12 carbon atoms, and still more preferably 2 to 6 carbon atoms), an alkynyl group (having preferably 2 to 24 carbon atoms, more preferably 2 to 12 carbon atoms, and still more preferably 2 to 6 carbon atoms), or an aryl group (having preferably 6 to 22 carbon atoms and more preferably 6 to 14 carbon atoms). In particular, a hydrogen atom or an alkyl group is preferable, and a hydrogen atom or a methyl group is more preferable.

R² represents a hydrogen atom or a substituent. The substituent that can be used as R² is not particularly limited, and examples thereof include an alkyl group (having preferably 1 to 30 carbon atoms, more preferably 6 to 24 carbon atoms, and still more preferably 8 to 24 carbon atoms; the alkyl group may be a branched but is preferably linear), an alkenyl group (having preferably 2 to 12 carbon atoms and more preferably 2 to 6 carbon atoms), an aryl group (having preferably 6 to 22 carbon atoms and more preferably 6 to 14 carbon atoms), an aralkyl group (having preferably 7 to 23 carbon atoms and more preferably 7 to 15 carbon atoms), a cyano group, a carboxy group, a hydroxy group, a sulfanyl group, a sulfonate group, a phosphate group, a phosphonate group, an aliphatic heterocyclic group having an oxygen atom (having preferably 2 to 12 carbon atoms and more preferably 2 to 6 carbon atoms), and an amino group (NR^{N1}₂: R^{N1} represents a hydrogen atom or a substituent and preferably a hydrogen atom or an alkyl group having 1 to 3 carbon atoms). In particular, a group having 6 or more carbon atoms is preferable, and an alkyl group, an aryl group, or an aralkyl group having 6 or more carbon atoms is preferable. It is preferable that the group having 6 or more carbon atoms is linear.

The sulfonate group, the phosphate group, and the phosphonate group may be esterified with, for example, an alkyl group having 1 to 6 carbon atoms. As the aliphatic heterocyclic group having an oxygen atom, for example, an epoxy group-containing group, an oxetane group-containing group, or a tetrahydrofuryl group-containing group is preferable.

L¹ represents a linking group, the linking group is not particularly limited, and examples thereof include an alkylene group having 1 to 6 carbon atoms (having preferably 1 to 3 carbon atoms), an alkenylene group having 2 to 6 carbon atoms (having preferably 2 or 3 carbon atoms), an arylene group having 6 to 24 carbon atoms (having preferably 6 to 10 carbon atoms), an oxygen atom, a sulfur atom, an imino group (—NR^{N}—), a carbonyl group, a phosphate linking group (—O—P(OH)(O)—O—), a phosphonate linking group (—P(OH)(O)—O—), and a group relating to a combination thereof. Among these, a —CO—O— group, a —CO—N(R^{N})— group (R^{N} is as described above) is preferable. The above-described linking group may have any substituent. The number of atoms forming the linking group and the number of linking atoms are as described below. Examples of the substituent include the substituent T described below. For example, an alkyl group or a halogen atom can be used.

n represents 0 or 1 and preferably 1. In this case, in a case where -(L¹)ₙ-R² represents one substituent (for example, an alkyl group), n represents 0, and R² represents a substituent (alkyl group).

As the (meth)acrylic compound, not only the compound represented by Formula (b-1) but also a compound represented by (b-2) or (b-3) are preferable.

[chemical structure]

R¹ and n have the same definitions as those of Formula (b-1). In this case, n in Formula (b-2) represents 1.

R³ has the same definition as that of R².

L² represents a linking group and has the same definition as L¹.

L³ represents a linking group, has the same definition as that of L¹, and preferably represents an alkylene group having 1 to 6 carbon atoms (having preferably 1 to 3 carbon atoms).

m represents an integer of I to 200, preferably an integer of I to 100, and more preferably an integer of 1 to 50.

In Formulae (b-1) to (b-3), a carbon atom forming the polymerizable group that is not bonded to R¹ is represented as an unsubstituted carbon atom (H₂C═) but may have a substituent as described above. The substituent is not particularly limited, and examples thereof include the groups that can be used as R.

In addition, in Formulae (b-1) to (b-3), a group which may have a substituent such as an alkyl group, an aryl group, an alkylene group, or an arylene group may have a substituent within a range where the effects of the present invention do not deteriorate. Examples of the substituent include the substituent T, specifically, a halogen atom, a hydroxy group, a carboxy group, a sulfanyl group, an acyl group, an acyloxy group, an alkoxy group, an aryloxy group, an aryloyl group, an aryloyloxy group, or an amino group. As the substituent, a group in the group (a) of functional groups described below can also be used.

Examples of a polymerizable compound other than the polymerizable compound (m2) include “vinyl monomer” described in JP2015-088486A.

Examples of the polymerizable compound (m2) will be shown below and in Examples but do not intend to limit the present invention. In the following formulae, I represents 1 to 1,000,000.

[chemical structure]

[chemical structure]

[chemical structure]

[chemical structure]

[chemical structure]

[chemical structure]

[chemical structure]

[chemical structure]

[chemical structure]

The content of the component (M2) in the polymer is not particularly limited and is preferably 1 mass % to 70 mass %. As a result, a balance between the component (K) and/or the component (MM) described below can be improved, and the dispersibility of the solid electrolyte composition, the binding properties between the solid particles and the like, and the ion conductivity can be exhibited on a higher level. The content of the component (M2) in the polymer is more preferably 5 mass % or higher and still more preferably 15 mass % or higher. The upper limit is more preferably 50 mass % or lower and still more preferably 40 mass % or lower.

In a case where the polymer forming the particle binder is an addition polymerization type polymer, it is preferable that the polymer includes a component (MM) derived from a macromonomer having a mass average molecular weight of 1000 or higher.

The mass average molecular weight of the macromonomer is preferably 2,000 or higher and more preferably 3,000 or higher. The upper limit is preferably 500,000 or lower, more preferably 100,000 or lower, and still more preferably 30,000 or lower. In a case where the polymer forming the particle binder includes the component (MM) derived from the macromonomer having a mass average molecular weight in the above-described range, the polymer can be more uniformly dispersed in the dispersion medium.

The macromonomer is not particularly limited as long as it has a mass average molecular weight of 1000 or higher, and is preferably a macromonomer that includes a polymer chain bonded to a polymerizable group such as a group having an ethylenically unsaturated bond. The polymer chain in the macromonomer forms a side chain (graft chain) to the main chain of the polymer.

The polymer chain has an action of improving the dispersibility in the dispersion medium. As a result, the particle binder is favorably dispersed and thus can cause the inorganic solid electrolyte to be bound to each other without locally or totally covering the solid particles such as the inorganic solid electrolyte. As a result, the solid particles can be adhered to each other without interrupting an electrical connection therebetween. Therefore, it is presumed that an increase in the interface resistance between the solid particles is suppressed. Further, the polymer forming the particle binder includes the polymer chain such that not only an effect of causing the particle binder to be attached to the solid particles but also an effect of twisting the polymer chain can be expected. As a result, it is presumed that suppression in the interface resistance between the solid particles and improvement of binding properties are simultaneously achieved. The molecular weight of the component (MM) can be identified by measuring the mass average molecular weight of the macromonomer incorporated during the synthesis of the polymer forming the particle binder.

—Measurement of Mass Average Molecular Weight—

In the present invention, unless specified otherwise, the molecular weights of the polymer and the macromonomer forming the particle binder refer to mass average molecular weights in terms of standard polystyrene by gel permeation chromatography (GPC). Regarding a measurement method, basically, a value measured using a method under the following condition 1 or condition 2 (preferred) is used. An appropriate eluent may be appropriately selected and used depending on the kind of the polymer or the macromonomer.

(Condition 1)

Column: Two TOSOH TSKgel Super AWM-H's (trade name, manufactured by Tosoh Corporation) connected together

Carrier: 10 mM LiBr/N-methylpyrrolidone

Measurement temperature: 40° C.

Carrier flow rate: 1.0 ml/min

Sample concentration: 0.1 mass %

Detector: refractive index (RI) detector

(Condition 2)

Column: A column obtained by connecting TOSOH TSKgel Super HZM-H, TOSOH TSKgel Super HZ4000, and TOSOH TSKgel Super HZ2000 (all of which are trade names, manufactured by Tosoh Corporation)

Carrier: tetrahydrofuran

Measurement temperature: 40° C.

Carrier flow rate: 1.0 ml/min

Sample concentration: 0.1 mass %

Detector: refractive index (RI) detector

The SP value of the component (MM) is not particularly limited and is preferably 10 or lower and more preferably 9.5 or lower. The lower limit value is not particularly limited, but is practically 5 or more. The SP value is an index indicating a property of being dispersed in an organic solvent. In addition, by adjusting the component (MM) to have a specific molecular weight or higher and preferably to adjust the SP value to be the above-described SP value or higher, the binding properties with the solid particles can be improved, affinity to a solvent can be improved, and thus the polymer can be stably dispersed.

—Definition of SP Value—

In the present invention, unless specified otherwise, the SP value is obtained using a Hoy method (refer to H. L. Hoy Journal of Paint Technology, vol. 42, NO. 541, 1970, 76-118 and Polymer Handbook, 4th, Chapter 59, VII 686 page, Tables 5, 6, and 7 and the following formulae in Table 6). In addition, the unit of the SP value is not shown but is cal^{1/2}cm^{-3/2}. The SP value of the component (MM) is not substantially different from the SP value of the macromonomer and may be evaluated using the SP value of the macromonomer.

In the present invention, the SP value (SP_{P}) of the polymer is a value calculated from the following formula, where SP₁, SP₂, . . . represent the SP values of the respective repeating units forming the polymer, and W₁, W₂, . . . represent the mass ratios of the respective repeating units.

SP_{P}²═(SP₁²×W₁)+(SP₂²×W₂)+ . . .

$${δ}_{t} = \frac{{F}_{t} + \frac{B}{\overline{n}}}{V} \text{:} B = 277$$

In the expression δₜ represents a SP value. Ft represents a molar attraction function (J×cm³)^{1/2}/mol. In the following expression, V represents a molar attraction function (J×cm³)^{1/2}/mol, and n is represented by the following expression.

$${F}_{t} = \sum {n}_{i} {F}_{t , i}$$

$$V = \sum {n}_{i} {V}_{i}$$

$$\overline{n} = \frac{0.5}{{Δ}_{T}^{( P )}}$$

$${Δ}_{T}^{( P )} = \sum {n}_{i} {Δ}_{T , i}^{( P )}$$

In the above-described expression, F_{t,i} represents a molar attraction function of each constitutional unit, Vi represents a molar volume of each constitutional unit, Δ^{(P)}_{t,i} represents a correction value of each constitutional unit, and ni represents the number of the corresponding constitutional units.

The polymerizable group in the macromonomer is not particularly limited, and the details will be described below. Examples of the polymerizable group include various vinyl groups and (meth)acryloyl groups. Among these, a (meth)acryloyl group is preferable.

The polymer chain in the macromonomer A is not particularly limited, and a typical polymer component can be used. Examples of the polymer chain include a chain of a (meth)acrylic resin, a chain of a polyvinyl resin, a polysiloxane chain, a polyalkylene ether chain, and a hydrocarbon chain. Among these, a chain of a (meth)acrylic resin or a polysiloxane chain is preferable.

It is preferable that the chain of a (meth)acrylic resin includes a component derived from a (meth)acrylic compound selected from a (meth)acrylic acid compound, a (meth)acrylic acid ester compound, and a (meth)acrylonitrile compound, and it is more preferable that the chain of a (meth)acrylic resin is a polymer of two or more (meth)acrylic compounds. The polysiloxane chain is not particularly limited, and examples thereof include a siloxane polymer having an alkyl group or an aryl group. Examples of the hydrocarbon chain include a chain consisting of a hydrocarbon-based thermoplastic resin.

In addition, it is preferable that the component forming the above-described polymer chain includes a polymerizable double bond and a linear hydrocarbon structural unit S having 6 or more carbon atoms (preferably an alkylene group having 6 to 30 carbon atoms and more preferably an alkylene group having 8 to 24 carbon atoms). This way, the component forming the polymer chain includes the linear hydrocarbon structural unit S such that affinity to the dispersion medium is improved and dispersion stability is improved. The linear hydrocarbon structural unit S has the same definition as a linear group among groups having 6 or more carbon atoms in the polymerizable compound (m2).

It is preferable that the macromonomer has a polymerizable group represented by Formula (b-11). In the following formula, R¹¹ has the same definition as R¹. * represents a binding position.

[chemical structure]

It is preferable that the macromonomer has a polymerizable site represented by any one of Formulae (b-12a) to (b-12c).

[chemical structure]

R^{b2} has the same definition as R¹. * represents a binding position. R^{N2} has the same definition as that of R^{N1}. A benzene ring in Formula (b-12c) may be substituted with any substituent T.

The structural unit present before the binding position of * is not particularly limited as long as the molecular weight as a macromonomer is satisfied. In particular, the polymer chain (preferably bonded through a linking group) is preferable. In this case, the linking group and the polymer chain may each independently have the substituent T, for example, a halogen atom (fluorine atom).

In the polymerizable group represented by Formula (b-11) and the polymerizable site represented by any one of (b-12a) to (b-12c), a carbon atom forming the polymerizable group that is not bonded to R¹¹ or R^{b2} is represented as an unsubstituted carbon atom but may have a substituent as described above. The substituent is not particularly limited, and examples thereof include the groups that can be used as R¹.

It is preferable that the above-described macromonomer (component (MM)) includes a linking group through which the above-described polymerizable group and the above-described polymer chain are linked to each other. Typically, the linking group is incorporated into a side chain of the macromonomer.

The linking group is not particularly limited and preferably includes a binding site represented by Formula (H-21) or (H-22).

[chemical structure]

In the formulae, X⁴¹, X⁴², X⁴³, and X⁴⁵ each independently represent an imino group, an oxygen atom, a sulfur atom, or a selenium atom and have the same definitions and the same preferable ranges as those of X¹¹, X¹², X¹³, and X¹⁵ in Formulae (H-1) and (H-2).

X⁴⁴ represents an amino group, a hydroxy group, a sulfanyl group, or a carboxy group and has the same definition and the same preferable range as those of X¹⁴ in Formula (H-2).

L⁴¹ represents an alkylene group or an alkenylene group having 4 or less carbon atoms having 4 or less carbon atoms and has the same definition and the same preferable range as those of L in Formula (H-2).

The binding site represented by Formula (H-21) and the binding site represented by Formula (H-22) each independently have the same definitions and the same preferable ranges as those of the binding site represented by Formula (H-1) and the binding site represented by Formula (H-2).

In a case where the polymer forming the particle binder includes the component (MM), the binding sites represented by the respective formulae in the component (MM) may be the same as or different from the respective binding sites in the component (K).

It is preferable that the linking group through which the polymerizable group or the polymerizable site and the polymer chain are linked includes another linking group in addition to the above-described binding site, and it is more preferable that the linking group includes another linking group at each of opposite terminals of the binding site. Examples of the other linking group include a group (residue) derived from a chain transfer agent or a polymerization initiator that is used for polymerization of the polymer chain, for example, the groups described regarding the linking group L¹ in Formula (b-1). Specifically, for example, linking groups in macromonomers MM-1 to MM-3 used in Examples described below can be used.

In the present invention, the number of atoms forming the linking group is preferably 1 to 36, more preferably 1 to 24, still more preferably 1 to 12, and still more preferably 1 to 6. The number of linking atom in the linking group is preferably 10 or less and more preferably 8 or less. The lower limit is 1 or more. The number of linking atoms refers to the minimum number of atoms that connect predetermined structural units. For example, in the case of —CH₂—C(═)—O—, the number of atoms forming the linking group is 6, but the number of linking atoms is 3.

It is preferable that the macromonomer is a compound represented by Formula (b-3a).

[chemical structure]

R^{b2} has the same definition as R¹.

na is not particularly limited and is preferably an integer of 1 to 6, more preferably 1 or 2, and still more preferably 1.

In a case where na represents 1, Ra represents a substituent. In a case where na represents 2 or more, Ra represents a linking group.

The substituent that can be used as Ra is not particularly limited and is preferably the above-described polymer chain and more preferably the chain of a (meth)acrylic resin or the polysiloxane chain.

Ra may be directly bonded to an oxygen atom (—O—) in Formula (b-13a) but is preferably bonded to an oxygen atom (—O—) in Formula (b-13a) through a linking group. The linking group is not particularly limited, and examples thereof include a linking group through which the polymerizable group and the polymer chain are linked.

In a case where Ra represents a linking group, the linking group is not particularly limited. For example, an alkane linking group having 1 to 30 carbon atoms, a cycloalkane linking group having 3 to 12 carbon atoms, an aryl linking group having 6 to 24 carbon atoms, a heteroaryl linking group having 3 to 12 carbon atoms, an ether group, a sulfide group, a phosphinidene group (—PR—: R represents a hydrogen atom or an alkyl group having 1 to 6 carbon atoms), a silylene group (—SiRR′—: R and R′ represent a hydrogen atom or an alkyl group having 1 to 6 carbon atoms), a carbonyl group, an imino group (—NR—: R represents a hydrogen atom or a substituent, and preferably a hydrogen atom, an alkyl group having 1 to 6 carbon atoms, or an aryl group having 6 to 10 carbon atoms), or a combination thereof is preferable. It is preferable that the linking group that can be used as Ra includes a linking group through which the polymerizable group and the polymer chain are linked.

Examples of a macromonomer other than the above-described macromonomer include “vinyl monomer (X)” described in JP2015-088486A.

Examples of the substituent T are as follows:

an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, or 1-carboxymethyl); an alkenyl group (preferably an alkenyl group having 2 to 20 carbon atoms, for example, vinyl, allyl, or oleyl); an alkynyl group (preferably an alkynyl group having 2 to 20 carbon atoms, for example, ethynyl, butadiynyl, or phenyl-ethynyl); a cycloalkyl group (preferably a cycloalkyl group having 3 to 20 carbon atoms, for example, cyclopropyl, cyclopentyl, cyclohexyl, or 4-methylcyclohexyl); an aryl group (preferably an aryl group having 6 to 26 carbon atoms, for example, phenyl, 1-naphthyl, 4-methoxyphenyl, 2-chlorophenyl, or 3-methylphenyl); a heterocyclic group (preferably a heterocyclic group having 2 to 20 carbon atoms and more preferably a 5- or 6-membered heterocyclic group having at least one oxygen atom, sulfur atom, or nitrogen atom: the heterocyclic group includes an aromatic heterocyclic group and an aliphatic heterocyclic group; for example, a tetrahydropyran ring group, a tetrahydrofuran ring group, 2-pyridyl, 4-pyridyl, 2-imidazolyl, 2-benzimidazolyl, 2-thiazolyl, or 2-oxaolyl); an alkoxy group (preferably an alkoxy group having 1 to 20 carbon atoms, for example, methoxy, ethoxy, isopropyloxy, or benzyloxy); an aryloxy group (preferably an aryloxy group having 6 to 26 carbon atoms, for example, phenoxy, 1-naphthyloxy, 3-methylphenoxy, or 4-methoxyphenoxy); a heterocyclic oxy group (a group in which an —O— group is bonded to the above-described heterocyclic group), an alkoxycarbonyl group (preferably an alkoxycarbonyl group having 2 to 20 carbon atoms, for example, ethoxycarbonyl or 2-ethylhexyloxycarbonyl); an aryloxycarbonyl group (preferably an aryloxycarbonyl group having 6 to 26 carbon atoms, for example, phenoxycarbonyl, 1-naphthyloxycarbonyl, 3-methylphenoxycarbonyl, or 4-methoxyphenoxycarbonyl); an amino group (preferably an amino group having 0 to 20 carbon atoms, an alkylamino group, or an arylamino group, for example, amino (—NH₂—), N,N-dimethylamino, N,N-diethylamino, N-ethylamino, or anilino): a sulfamoyl group (preferably a sulfamoyl group having 0 to 20 carbon atoms, for example, N,N-dimethylsulfamoyl or N-phenylsufamoyl); an acyl group (an alkylcarbonyl group, an alkenylcarbonyl group, an alkynylcarbonyl group, an arylcarbonyl group, or a heterocyclic carbonyl group, preferably an acyl group having 1 to 20 carbon atoms, for example, acetyl, propionyl, butyryl, octanoyl, hexadecanoyl, acryloyl, methacryloyl, crotonoyl, benzoyl, naphthoyl, or nicotinoyl); an acyloxy group (an alkylcarbonyloxy group, an alkenylcarbonyloxy group, an alkynylcarbonyloxy group, an arylcarbonyloxy group, or a heterocyclic carbonyloxy group, preferably an acyloxy group having 1 to 20 carbon atoms, for example, acetyloxy, propionyloxy, butyryloxy, octanoyloxy, hexadecanoyloxy, acryloyloxy, methacryloyloxy, crotonoyloxy, benzoyloxy, naphthoyloxy, or nicotinoyloxy); an aryloyloxy group (preferably an aryloyloxy group having 7 to 23 carbon atoms, for example, benzoyloxy):a carbamoyl group (preferably a carbamoyl group having 1 to 20 carbon atoms, for example, N,N-dimethylcarbamoyl or N-phenylcarbamoyl); an acylamino group (preferably an acylamino group having 1 to 20 carbon atoms, for example, acetylamino or benzoylamino); an alkylthio group (preferably an alkylthio group having 1 to 20 carbon atoms, for example, methylthio, ethylthio, isopropylthio, or henzylthio); an arylthio group (preferably an arylthio group having 6 to 26 carbon atoms, for example, phenylthio, 1-naphthylthio, 3-methylphenylthio, or 4-methoxyphenylthio); a heterocyclic thio group (a group in which an —S— group is bonded to the above-described heterocyclic group), an alkylsulfonyl group (preferably an alkylsulfonyl group having 1 to 20 carbon atoms, for example, methylsulfonyl or ethylsulfonyl), an arylsulfonyl group (preferably an arylsulfonyl group having 6 to 22 carbon atoms, for example, benzenesulfonyl), an alkylsilyl group (preferably an alkylsilyl group having 1 to 20 carbon atoms, for example, monomethylsilyl, dimethylsilyl, trimethylsilyl, or triethylsilyl); an arylsilyl group (preferably an arylsilyl group having 6 to 42 carbon atoms, for example, triphenylsilyl), a phosphoryl group (preferably a phosphate group having 0 to 20 carbon atoms, for example, —OP(═)(RP)₂), a phosphonyl group (preferably a phosphonyl group having 0 to 20 carbon atoms, for example, —P(═O)(R^{P})₂), a phosphinyl group (preferably a phosphinyl group having 0 to 20 carbon atoms, for example, —P(RP)₂), a sulfo group (sulfonate group), a hydroxy group, a sulfanyl group, a cyano group, and a halogen atom (for example, a fluorine atom, a chlorine atom, a bromine atom, or an iodine atom), R^{P} represents a hydrogen atom or a substituent (preferably a group selected from the substituent T).

In addition, each exemplary group of the substituent T may be further substituted with the substituent T.

In a case where a compound or a substituent, a linking group, or the like includes, for example, an alkyl group, an alkylene group, an alkenyl group, an alkenylene group, an alkynyl group, and/or an alkynylene group, these groups may be cyclic or chained, may be linear or branched. [0148]1 The content of the component (MM) in the polymer is not particularly limited and is preferably 1 mass % to 50 mass %. As a result, a balance between the component (K) and/or the component (M2) can be improved, and the dispersibility of the solid electrolyte composition, the binding properties between the solid particles and the like, and the ion conductivity can be exhibited on a higher level. The content of the component (MM) in the polymer is more preferably 3 mass % or higher and still more preferably 5 mass % or higher. The upper limit is more preferably 30 mass % or lower and still more preferably 20 mass % or lower.

It is preferable that the specific polymer including the component (K) includes at least one functional group selected from the group (a) of functional groups. This functional group may be included in the main chain or in a side chain but is preferably included in the main chain. The side chain in the functional group may be any component forming the polymer. The specific functional group is included in the side chain such that an interaction with a hydrogen atom, an oxygen atom, or a sulfur atom that is presumed to be present on a surface of the inorganic solid electrolyte, the active material, or the current collector is strengthened, binding properties are further improved, and an increase in interface resistance can be suppressed.

Group (a) of Functional Groups

a carboxy group, a sulfonate group, a phosphate group, a phosphonate group, an isocyanate group, an oxetane group, an epoxy group, and a silyl group.

The sulfonate group may be an ester or a salt thereof. In the case of an ester, the number of carbon atoms is preferably 1 to 24, more preferably 1 to 12, and still more preferably 1 to 6.

The phosphate group (phospho group: for example, —OPO(OH)₂) may be an ester or a salt. In the case of an ester, the number of carbon atoms is preferably 1 to 24, more preferably 1 to 12, and still more preferably 1 to 6.

The phosphonate group (sulfo group: for example, —SO₃H) may be an ester or a salt. In the case of an ester, the number of carbon atoms is preferably 1 to 24, more preferably 1 to 12, and still more preferably 1 to 6.

Examples of the silyl group include an alkylsilyl group, an alkoxysilyl group, an arylsilyl group, and an aryloxysilyl group. In particular, an alkoxysilyl group is preferable. The number of carbon atoms in the silyl group is not particularly limited and is preferably 1 to 18, more preferably 1 to 12, and still more preferably 1 to 6.

The specific polymer including the above-described component (K) includes both an aspect including a group that has a ring structure including two or more rings at a side chain and an aspect not including the group that has a ring structure including two or more rings at a side chain. Examples of the group that has a ring structure including two or more rings include a group consisting of a fused polycyclic aromatic compound and a group having a steroid skeleton.

A method of synthesizing the specific polymer including the component (K) will be described together with a method of manufacturing the particle binder described below.

The particle binder includes not only the aspect (aspect including the polymer) where the above-described polymer including the component (K) is formed but also an aspect including a component other than the above-described polymer, for example, another polymer, an unreacted raw material compound, or a decomposition product.

In a case where the particle binder includes components other than the above-described polymer, it is preferable that the particle binder includes a component (component remaining in an supernatant liquid) that do not precipitate even after an ultracentrifugal separation process under a specific condition at a specific ratio. That is, in a case where the particle binder includes a component that precipitates after a centrifugal separation process and a component that does not precipitate after the centrifugal separation process, it is preferable that a content X of the component that precipitates and a content Y of a component that does not precipitate satisfies the following expression by mass, the centrifugal separation process being performed at a temperature of 20° C. and a rotation speed of 100000 rpm for 1 hour in a state where the particle binder is dispersed or dissolved in a dispersion medium.

Y/(X+Y)≤0.10.

In a case where the particle binder includes the component that does not precipitate at the mass ratio Y/(X+Y) (also referred to as “the amount of the component dissolved”), the dispersibility is excellent, and the solid particles and the like can be more strongly bound to each other. Further, an increase in interface resistance can be effectively suppressed without excessively covering the solid particles.

From the viewpoints of the dispersibility, the binding properties, and the resistance, the mass ratio Y/(X+Y) is preferably 0.09 or lower, more preferably 0.08 or lower, and still more preferably 0.075 or lower. It is preferable that the lower limit of the mass ratio Y/(X+Y) is ideally 0 (the aspect including the polymer) and is practically 0.001 or higher.

The component that does precipitate is typically the polymer including the above-described component (K), the component that does not precipitate is typically a component derived from a dispersion liquid of the particle binder, and examples of the component that does not precipitate include a solid component include a solid component such as an unreacted raw material compound or a by-product thereof that is used for the synthesis of the polymer including the component (K) (for example, a decomposition product of the raw material compound or a polymer that is soluble in a dispersion medium or is in the form of fine particles having a small particle size (for example, less than 5 nm) in the dispersion medium). The component that does not precipitate does not include a dispersion medium or a solvent that is used for the synthesis of the particle binder and remains in the particle binder.

In the particle binder, the component that precipitates and the component that does not precipitate may be present independently or may be present in a state where they interact with each other (adsorption or the like). In the solid electrolyte composition, the component that does not precipitate may be present in the particle binder or may ooze out from the particle binder and present independently from the particle binder.

Typically, the mass ratio Y/(X+Y) can be measured using a method described in Examples below by using the particle binder dispersion liquid as a measurement target. Here, the dispersion medium to be used for the measurement is a dispersion medium described below that is used for the solid electrolyte composition according to the embodiment of the present invention and has a C log P value of 0.4 or higher. In addition, the amount of the dispersion medium used is not particularly limited and is, for example, 200 parts by mass with respect to 100 parts by mass of the particle binder. As the dispersion medium, the particle binder dispersion liquid can be used for the measurement as it is as long as the amount thereof used is satisfied. In a case where the component that does not precipitate oozes out from the particle binder, the solid electrolyte composition can also be used as a measurement target.

From the viewpoints of simultaneously improving the binding properties between the solid particles such as the inorganic solid electrolyte, the active material, or a conductive auxiliary agent and the ion conductivity, the content of the particle binder in the solid electrolyte composition is preferably 0.01 mass % or higher, more preferably 0.05 mass % or higher, and still more preferably 0.1 mass % or higher with respect to 100 mass % of the solid component. From the viewpoint of battery capacity, the upper limit is preferably 20 mass % or lower, more preferably 10 mass % or lower, and still more preferably 5 mass % or lower.

In the solid electrolyte composition according to the embodiment of the present invention, the mass ratio [(the mass of the inorganic solid electrolyte+the mass of the active material)/(the mass of the binder)] of the total mass (total amount) of the inorganic solid electrolyte and the active material to the mass of the binder is preferably in a range of 1,000 to 1. This ratio is preferably 500 to 2 and still more preferably 100 to 10.

The solid electrolyte composition according to the embodiment of the present invention may include one particle binder alone or two or more particle binders.

The particle binder can be synthesized by sequential polymerization or addition polymerization of an appropriate combination of raw material compounds that derive the above-described components optionally in the presence of a catalyst (including a polymerization initiator, a chain transfer agent, or the like). A method and a condition of sequential polymerization or addition polymerization are not particularly limited, and a well-known method and a well-known condition can be appropriately selected. In the present invention, depending on the selection of the dispersion medium and the like, the particle binder can be obtained as a dispersion liquid by dispersing the polymer that is synthesized by sequential polymerization or addition polymerization in the dispersion medium in the form of particles.

In the present invention, in a case where the particle binder is an addition polymerization type polymer, in particular, a (meth)acrylic resin, it is preferable that the particle binder is prepared (synthesized) as follows. In the following manufacturing method, the polymerization ratio of a polymerizable compound for forming a functional polymer and further the reaction rate of a polymer reaction can increase, the amount of remaining unreacted raw material compounds can be reduced, and the above-described mass ratio Y/(X+Y) can be reduced. In particular, in an aspect where the polymer forming the particle binder includes a component derived from a macromonomer, the residual amount of an unreacted material and the like can be effectively suppressed as compared to a method of copolymerizing a macromonomer. Therefore, in a case where the solid electrolyte composition according to the embodiment of the present invention is prepared using the particle binder (dispersion liquid) manufactured using the following method, the dispersibility and the binding properties between the solid particles and the like can be further improved, and further the resistance can be further reduced.

The method of manufacturing the particle binder according to the embodiment of the present invention includes a step of causing a functional polymer having a functional group at a side chain (preferably a side chain terminal) to react with a side chain-forming compound having a reactive group that reacts with the functional group to form the binding site represented by Formula (H-1) or (H-2).

Examples of the side chain-forming compound used in this step include a compound that reacts with the above-described functional group to form the component (K) and a compound that reacts with the above-described functional group to form the component (MM).

In a case where the above-described step is performed first, a functional polymer is synthesized as a precursor of the polymer for forming the particle binder. Addition polymerization of the functional polymer and the polymerizable compound having the functional group and optionally a polymerizable compound that derives the component (M2) and the like is performed using a well-known method under a well-known condition. The polymerizable compound having the functional group is appropriately selected depending on the kind of the reactive group (the binding site represented by Formula (H-1) or (H-2)) of the side chain-forming compound and the like.

Next, the side chain-forming compound is caused to react with the obtained functional polymer in a polymer reaction to construct the binding site represented by Formula (H-1) or (H-2). As a result, the component (K) is formed in the polymer. In the polymer reaction (the reaction between the functional group of the functional polymer and the reactive group of the side chain-forming compound), a well-known method and a well-known condition are selected depending on the kind of the binding site represented by Formula (H-1) or (H-2) and the like. For example, in a case where the binding site represented by Formula (H-1) is a urethane binding site or a urea binding site, the binding site can be obtained through a reaction of a functional polymer having an isocyanate group as a functional group and an alcohol compound or an amino compound. In addition, in a case where the binding site represented by Formula (H-2) is formed, the binding site can be obtained through a reaction of an aliphatic cyclic ether compound having an epoxy group, an oxetane group, or the like as a functional group and an alcohol compound, a carboxy group-containing compound, or an amino compound.

In a case where the component (MM) is formed, it is preferable that the component (MM) is formed before the formation of the component (K). The side chain-forming compound (polymer chain-forming compound) that can form the component (MM) is caused to react with the functional polymer in a polymer reaction to form the component (MM) in the polymer. This polymer reaction can be performed using the same method as that of the polymer reaction for forming the above-described component (K), and the reaction method and the condition can also be appropriately set.

In the method of manufacturing the particle binder according to the embodiment of the present invention, depending on the selection of the dispersion medium to be used in the polymer reaction and the like, the particle binder can be obtained as a dispersion liquid by dispersing the synthesized polymer in the dispersion medium in the form of particles, in particular, as the formation of the component (K) progresses. At this time, a method of adjusting the average particle size of the particle binder is as described above. The details of the method of manufacturing the particle binder according to the embodiment of the present invention will be described in Examples below, but the present invention is not limited thereto.

<Active Material>

The solid electrolyte composition according to the embodiment of the present invention may also include an active material. This active material is a material capable of intercalating and deintercalating ions of a metal element belonging to Group 1 or Group 2 in the periodic table. Examples of the active material include a positive electrode active material and a negative electrode active material. As the positive electrode active material, a metal oxide (preferably a transition metal oxide) is preferable. As the negative electrode active material, a carbonaceous material, a metal oxide, a silicon material, lithium, a lithium alloy, or a metal capable of forming an alloy with lithium is preferable.

In the present invention, the solid electrolyte composition (electrode layer-forming composition) including the positive electrode active material will also be referred to as “positive electrode composition”. In addition, the solid electrolyte composition (electrode layer-forming composition) including the negative electrode active material will also be referred to as “negative electrode composition”.

(Positive Electrode Active Material)

The positive electrode active material is preferably capable of reversibly intercalating and deintercalating lithium ions. The above-described material is not particularly limited as long as the material has the above-described characteristics and may be transition metal oxides, organic matter, elements capable of being complexed with Li such as sulfur, complexes of sulfur and metal, or the like.

Among these, as the positive electrode active material, transition metal oxides are preferably used, and transition metal oxides having a transition metal element M^{a} (one or more elements selected from Co, Ni, Fe, Mn, Cu, and V) are more preferable. In addition, an element Mb (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The amount of the element mixed is preferably 0 to 30 mol % of the amount (100 mol %) of the transition metal element M^{a}. It is more preferable that the transition metal oxide is synthesized by mixing the above components such that a molar ratio Li/M^{a} is 0.3 to 2.2.

Specific examples of the transition metal oxides include transition metal oxides having a layered rock salt structure (MA), transition metal oxides having a spinel-type structure (MB), lithium-containing transition metal phosphate compounds (MC), lithium-containing transition metal halogenated phosphate compounds (MD), and lithium-containing transition metal silicate compounds (ME).

Specific examples of the transition metal oxides having a layered rock salt structure (MA) include LiCoO₂ (lithium cobalt oxide [CO]), LiNi₂O₂ (lithium nickel oxide) LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickel oxide).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphate compounds (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and monoclinic nasicon type vanadium phosphate salt such as Li₃V₂(PO₄)₃ (lithium vanadium phosphate). Examples of the lithium-containing transition metal halogenated phosphate compounds (MD) include iron fluorophosphates such as Li₂FePO₄F, manganese fluorophosphates such as Li₂MnPO₄F, cobalt fluorophosphates such as Li₂CoPO₄F. Examples of the lithium-containing transition metal silicate compounds (ME) include Li₂FeSiO₄, Li₂MnSiO₄, and Li₂CoSiO₄.

In the present invention, the transition metal oxides having a layered rock salt structure (MA) is preferable, and LCO or NMC is more preferable.

The shape of the positive electrode active material is not particularly limited, but is preferably a particle shape. In this case, the average particle size (sphere-equivalent average particle size) of the positive electrode active material is not particularly limited and is, for example, 0.1 to 50 μm. In order to allow the positive electrode active material to have a predetermined particle size, an ordinary pulverizer or classifier may be used. Positive electrode active materials obtained using a calcination method may be used after being washed with water, an acidic aqueous solution, an alkaline aqueous solution, or an organic solvent. The average particle size of the positive electrode active material particles can be measured using the same method as that of the average particle size of the inorganic solid electrolyte.

As the positive electrode active material, one kind may be used alone, or two or more kinds may be used in combination.

In the case of forming a positive electrode active material layer, the mass (mg) of the positive electrode active material per unit area (cm²) of the positive electrode active material layer (weight per unit area) is not particularly limited. The mass can be appropriately determined depending on the designed battery capacity.

The content of the positive electrode active material in the electrode layer-forming composition is not particularly limited, but is preferably 10% to 95 mass %, more preferably 30% to 90 mass %, still more preferably 50% to 85 mass %, and particularly preferably 55% to 80 mass % with respect to a solid content of 100 mass %.

(Negative Electrode Active Material)

The negative electrode active material is preferably capable of reversibly intercalating and deintercalating lithium ions. The material is not particularly limited as long as it has the above-described properties, and examples thereof include a carbonaceous material, a metal oxide, a metal composite oxide, lithium, a lithium alloy, and a negative electrode active material capable of forming an alloy with lithium. Among these, a carbonaceous material, a metal composite oxide, or lithium is preferably used from the viewpoint of reliability.

The carbonaceous material which is used as the negative electrode active material is a material substantially containing carbon. Examples thereof include petroleum pitch, carbon black such as acetylene black (AB), graphite (natural graphite, artificial graphite such as vapor-grown graphite), and carbonaceous material obtained by firing a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the lattice spacing, density, and crystallite size described in JP1987-022066A (JP-S62-022066A), JP1990-006856A (JP-H2-006856A), and JP1991-045473A (JP-H3-045473A). The carbonaceous material is not necessarily a single material and, for example, may be a mixture of natural graphite and artificial graphite described in JP1993-090844A (JP-H5-090844A) or graphite having a coating layer described in JP1994-004516A (JP-H6-004516A).

As the carbonaceous material, hard carbon or graphite is preferably used, and graphite is more preferably used.

The oxide of a metal or a metalloid element that can be used as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element (collectively referred to as “metal composite oxide), and an oxide of a metalloid element (metalloid oxide). The oxides are more preferably amorphous oxides, and preferable examples thereof include chalcogenides which are reaction products between metal elements and elements in Group 16 of the periodic table). In the present invention, the metalloid element refers to an element having intermediate properties between those of a metal element and a non-metal element. Typically, the metalloid elements include six elements including boron, silicon, germanium, arsenic, antimony, and tellurium and further includes three elements including selenium, polonium, and astatine. In addition, “Amorphous” represents an oxide having a broad scattering band with a peak in a range of 20° to 40° in terms of 20 in case of being measured by an X-ray diffraction method using CuKα rays, and the oxide may have a crystal diffraction line. The highest intensity in a crystal diffraction line observed in a range of 40° to 70° in terms of 2θ is preferably 100 times or less and more preferably 5 times or less relative to the intensity of a diffraction peak line in a broad scattering band observed in a range of 20° to 40° in terms of 2θ, and it is still more preferable that the oxide does not have a crystal diffraction line.

In a compound group consisting of the amorphous oxides and the chalcogenides, amorphous oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Groups 13 (IIIB) to 15 (VB) in the periodic table or chalcogenides are more preferable. Specific examples of preferred amorphous oxides and chalcogenides include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Preferable examples of the negative electrode active material which can be used in combination with the amorphous oxide as negative electrode active material containing Sn, Si, or Ge as a major component include a carbonaceous material capable of intercalating and/or deintercalating lithium ions or lithium metal, lithium, a lithium alloy, and a negative electrode active material capable of forming an alloy with lithium.

It is preferable that the oxide of a metal or a metalloid element, in particular, the metal (composite) oxide and the chalcogenide include at least one of titanium or lithium as components from the viewpoint of high current density charging-discharging characteristics. Examples of the metal composite oxide (lithium composite metal oxide) including lithium include a composite oxide consisting of lithium oxide and the metal (composite) oxide or the chalcogenide, specifically, Li₂SnO₂.

As the negative electrode active material, for example, a metal oxide (titanium oxide) having a titanium element is also preferable. Specifically, Li₄Ti₅O₁₂ (lithium titanium oxide [LTO]) is preferable since the volume fluctuation during the intercalation and deintercalation of lithium ions is small, and thus the high-speed charging-discharging characteristics are excellent, and the deterioration of electrodes is suppressed, whereby it becomes possible to improve the service lives of lithium ion secondary batteries.

The lithium alloy as the negative electrode active material is not particularly limited as long as it is typically used as a negative electrode active material for a secondary battery, and examples thereof include a lithium aluminum alloy.

The negative electrode active material capable of forming an alloy with lithium is not particularly limited as long as it is typically used as a negative electrode active material for a secondary battery. In this active material, expansion and contraction is significant during charging and discharging. Therefore, the binding properties between the solid particles decrease, but high binding properties can be achieved by the particle binder including the above-described polymer in the present invention. Examples of the active material include a (negative electrode) active material (alloy) having silicon element or tin element and a metal such as Al or In. A negative electrode active material (silicon-containing active material) having silicon element capable of exhibiting high battery capacity is preferable, and a silicon-containing active material including 50 mol % or higher of silicon element with respect to all the constituent elements is more preferable.

In general, a negative electrode including the negative electrode active material (for example, a Si negative electrode including a silicon-containing active material or an Sn negative electrode including tin element) can intercalate a larger amount of Li ions than a carbon negative electrode (for example, graphite or acetylene black). That is, the amount of Li ions intercalated per unit mass increases. Therefore, it is possible to increase the battery capacity. As a result, there is an advantage that the battery driving duration can be extended.

Examples of the silicon-containing active material include a silicon-containing alloy (for example, LaSi₂, VSi₂, La—Si, Gd—Si, or Ni—Si) including a silicon material such as Si or SiOx (0<x≤1) and titanium, vanadium, chromium, manganese, nickel, copper, lanthanum, or the like or a structured active material thereof (for example. LaSi₂/Si), and an active material such as SnSiO₃ or SnSiS₃ including silicon element and tin element. SiOx itself can be used as the negative electrode active material (metalloid oxide). In addition, Si is produced along with the operation of an all-solid state secondary battery, and thus SiO can be used as a negative electrode active material (or a precursor thereof) capable of forming an alloy with lithium.

Examples of the negative electrode active material including tin element include Sn, SnO, SnO₂, SnS, SnS₂, and the above-described active material including silicon element and tin element. In addition, a composite oxide with lithium oxide, for example, Li₂SnO₂ can also be used.

In the present invention, the above-described negative electrode active material can be used without any particular limitation. From the viewpoint of battery capacity, as the negative electrode active material, a negative electrode active material capable of forming an alloy with lithium is preferable, the above-described silicon material or an silicon-containing alloy (an alloy including silicon element) is more preferable, and a negative electrode active material including silicon (Si) or an silicon-containing alloy is still more preferable.

The shape of the negative electrode active material is not particularly limited, but is preferably a particle shape. The average particle size of the negative electrode active material is preferably 0.1 to 60 μm. In order to obtain a predetermined particle size, an ordinary pulverizer or classifier is used. For example, a mortar, a ball mill, a sand mill, a vibration ball mill, a satellite ball mill, a planetary ball mill, a swirling air flow jet mill, or a sieve is preferably used. During the pulverization, wet pulverization of causing water or an organic solvent such as methanol to coexist with the negative electrode active material can be optionally performed. In order to obtain a desired particle size, it is preferable to perform classification. A classification method is not particularly limited, and a method using, for example, a sieve or an air classifier can be optionally used. The classification can be used using a dry method or a wet method. The average particle size of the negative electrode active material can be measured using the same method as that of the average particle size of the inorganic solid electrolyte.

The chemical formulae of the compounds obtained using a calcination method can be calculated using inductively coupled plasma (ICP) optical emission spectroscopy as a measurement method from the mass difference of powder before and after calcinating as a convenient method.

As the negative electrode active material, one kind may be used alone, or two or more kinds may be used in combination.

In the case of forming a negative electrode active material layer, the mass (mg) of the negative electrode active material per unit area (cm²) in the negative electrode active material layer (weight per unit area) is not particularly limited. The mass can be appropriately determined depending on the designed battery capacity.

The content of the negative electrode active material in the electrode layer-forming composition is not particularly limited, but is preferably 10 to 80 mass % and more preferably 20% to 80 mass % with respect to the solid content of 100 mass %.

In the present invention, in a case where a negative electrode active material layer is formed by charging a battery, ions of a metal belonging to Group 1 or Group 2 in the periodic table produced in the all-solid state secondary battery can be used instead of the negative electrode active material. By binding the ions to electrons and precipitating a metal, a negative electrode active material layer can be formed.

(Coating of Active Material)

The surfaces of the positive electrode active material and the negative electrode active material may be coated with a separate metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, LiPO₄, Li₂MoO₄, Li₃BO₃, LiBO₂, Li₂CO₃, Li₂SiO₃, SiO₂, TiO₂, ZrO₂, Al₂O₃, and B₂O₃.

In addition, a surface treatment may be carried out on the surfaces of electrodes including the positive electrode active material or the negative electrode active material using sulfur, phosphorous, or the like.

Furthermore, the particle surfaces of the positive electrode active material or the negative electrode active material may be treated with an actinic ray or an active gas (plasma or the like) before or after the coating of the surfaces.

<Conductive Auxiliary Agent>

The solid electrolyte composition according to the embodiment of the present invention may also include a conductive auxiliary agent. The conductive auxiliary agent is not particularly limited, and conductive auxiliary agents that are known as ordinary conductive auxiliary agents can be used. The conductive auxiliary agent may be, for example, graphite such as natural graphite or artificial graphite, carbon black such as acetylene black, Ketjen black, or furnace black, irregular carbon such as needle cokes, a carbon fiber such as a vapor-grown carbon fiber or a carbon nanotube, or a carbonaceous material such as graphene or fullerene which are electron-conductive materials and also may be metal powder or a metal fiber of copper, nickel, or the like, and a conductive polymer such as polyaniline, polypyrrole, polythiophene, polyacetylene, or a polyphenylene derivative may also be used.

In the present invention, in a case where the active material and the conductive auxiliary agent are used in combination, among the above-described conductive auxiliary agents, a conductive auxiliary agent that does not intercalate and deintercalate ions (preferably Li ions) of a metal belonging to Group 1 or Group 2 in the periodic table and does not function as an active material during charging and discharging of the battery is classified as the conductive auxiliary agent. Therefore, among the conductive auxiliary agents, a conductive auxiliary agent that can function as the active material in the active material layer during charging and discharging of the battery is classified as an active material not as a conductive auxiliary agent. Whether or not the conductive auxiliary agent functions as the active material during charging and discharging of the battery is not uniquely determined but is determined based on a combination of the conductive auxiliary agent with the active material.

As the conductive auxiliary agent, one kind may be used alone, or two or more kinds may be used in combination.

The content of the conductive auxiliary agent in the electrode layer-forming composition is preferably 0.1% to 5 mass % and more preferably 0.5% to 3 mass % with respect to 100 parts by mass of the solid content.

The shape of the conductive auxiliary agent is not particularly limited, but is preferably a particle shape. The median size D50 of the conductive auxiliary agent is not particularly limited and is, for example, preferably 0.01 to 1 μm and more preferably 0.02 to 0.1 μm.

<Dispersion Medium>

The solid electrolyte composition according to the embodiment of the present invention includes a dispersion medium.

The dispersion medium is not particularly limited as long as it can disperse the respective components included in the solid electrolyte composition according to the embodiment of the present invention, and it is preferable that a dispersion medium that can disperse the above-described particle binder (the polymer forming the binder) in the form of particles is selected. The dispersion medium is not particularly limited, and from the viewpoint of the dispersibility of the particle binder, the C Log P value of the dispersion medium is preferably 1 or higher, more preferably 2 or higher, and still more preferably 2.5 or higher. The upper limit is not particularly limited and is practically 10 or lower.

The C log P value of the dispersion medium can be calculated using the same method as that of the C log P value of the component (K).

Examples of the dispersion medium to be used in the present invention include various organic solvents. Examples of the organic solvent include the respective solvents of an alcohol compound, an ether compound, an amide compound, an amine compound, a ketone compound, an aromatic compound, an aliphatic compound, a nitrile compound, and an ester compound.

Examples of the alcohol compound include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of an ether compound include alkylene glycol alkyl ether (for example, ethylene glycol monomethyl ether, ethylene glycol monobutyl ether, diethylene glycol, dipropylene glycol, propylene glycol monomethyl ether, diethylene glycol monomethyl ether, triethylene glycol, polyethylene glycol, propylene glycol monomethyl ether, dipropylene glycol monomethyl ether, tripropylene glycol monomethyl ether, diethylene glycol monobutyl ether, or diethylene glycol monobutyl ether), dialkyl ether (for example, dimethyl ether, diethyl ether, diisopropyl ether, or dibutyl ether), and cyclic ether (for example, tetrahydrofuran or dioxane (including respective isomers of 1,2-, 1,3, and 1,4-)).

Examples of the amide compound include N,N-dimethylformamide, N-methyl-2-pyrrolidone, 2-pyrrolidinone, 1,3-dimethyl-2-imidazolidinone, ε-caprolactam, formamide, N-methylformamide, acetamide, N-methylacetamide, N,N-dimethylacetamide, N-methylpropanamide, and hexamethylphosphorictriamide.

Examples of the amine compound include triethylamine, diisopropylethylamine, and tributylamine.

Examples of the ketone compound include acetone, methyl ethyl ketone (MEK), methyl isobutyl ketone, cyclohexanone, and diisobutyl ketone (DBK).

Examples of the aromatic compound include an aromatic hydrocarbon compound such as benzene, toluene, or xylene.

Examples of the aliphatic compound include an aliphatic hydrocarbon compound such as hexane, heptane, octane, or decane.

Examples of the nitrile compound include acetonitrile, propionitrile, and isobutyronitrile.

Examples of the ester compound include a carboxylic acid ester such as ethyl acetate, butyl acetate, propyl acetate, propyl butyrate, isopropyl butyrate, butyl butyrate, isobutyl butyrate, butyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

Examples of a non-aqueous dispersion medium include the aromatic compound and the aliphatic compound described above.

Preferable dispersion mediums will be shown together with C log P values.

[chemical structure]

In the present invention, the dispersion medium is preferably a ketone compound, an ester compound, an aromatic compound, or an aliphatic compound and more preferably a dispersion medium including at least one selected from a ketone compound, an ester compound, an aromatic compound, or an aliphatic compound.

The number of non-aqueous dispersion media in the solid electrolyte composition may be one or two or more but is preferably two or more.

The total content of the dispersion medium in the solid electrolyte composition is not particularly limited, but is preferably 20% to 80 mass %, more preferably 30% to 70 mass %, and particularly preferably 40% to 60 mass %.

<Other Additives>

As components other than the respective components described above, the solid electrolyte composition according to the embodiment of the present invention may optionally include a lithium salt, an ionic liquid, a thickener, a crosslinking agent (an agent causing a crosslinking reaction by radical polymerization, condensation polymerization, or ring-opening polymerization), a polymerization initiator (an agent that generates an acid or a radical by heat or light), an antifoaming agent, a leveling agent, a dehydrating agent, or an antioxidant.

In the present invention, the solid electrolyte composition according to the embodiment of the present invention includes both an aspect where the solid electrolyte composition includes a crosslinking agent and a polymerization initiator and the particle binder (or the polymer forming the particle binder) is crosslinked during the formation of a constituent layer described below and an aspect where the solid electrolyte composition does not include a crosslinking agent and a polymerization initiator and the particle binder (or the polymer forming the particle binder) is not crosslinked during the formation of a constituent layer described below.

[Method of manufacturing Solid Electrolyte Composition]

The solid electrolyte composition according to the embodiment of the present invention can be prepared, preferably, as a slurry by mixing the inorganic solid electrolyte, the particle binder, and the dispersion medium and optionally other components, for example using various mixers that are typically used.

A mixing method is not particularly limited, and the components may be mixed at once or sequentially. The particle binder is typically used as a dispersion liquid of the particle binder, but the present invention is not limited thereto. A mixing environment is not particularly limited, and examples thereof include a dry air environment and an inert gas environment.

[Solid Electrolyte-Containing Sheet]

A solid electrolyte-containing sheet according to the embodiment of the present invention is a sheet-shaped molded body with which a constituent layer of an all-solid state secondary battery can be formed, and includes various aspects depending on uses thereof. Examples of the sheet for an all-solid state secondary battery include a sheet that is preferably used in a solid electrolyte layer (also referred to as a solid electrolyte sheet for an all-solid state secondary battery), and a sheet that is preferably used in an electrode or a laminate of an electrode and a solid electrolyte layer (an electrode sheet for an all-solid state secondary battery).

The solid electrolyte sheet for an all-solid state secondary battery according to the embodiment of the present invention is not particularly limited as long as it is a sheet including a solid electrolyte layer, and may be a sheet in which a solid electrolyte layer is formed on a substrate or may be a sheet that is formed of a solid electrolyte layer without including a substrate. The solid electrolyte sheet for an all-solid state secondary battery may include other layers in addition to the solid electrolyte layer. Examples of the other layers include a protective layer (release sheet), a current collector, and a coating layer.

Examples of the solid electrolyte sheet for an all-solid state secondary battery according to the embodiment of the present invention include a sheet including a layer formed of the solid electrolyte composition according to the embodiment of the present invention, a typical solid electrolyte layer, and optionally a protective layer on a substrate in this order. It is preferable that the solid electrolyte layer in the solid electrolyte sheet for an all-solid state secondary battery is formed of the solid electrolyte composition according to the embodiment of the present invention. The contents of the respective components in the solid electrolyte layer are not particularly limited, but are preferably the same as the contents of the respective components with respect to the solid content of the solid electrolyte composition according to the embodiment of the present invention. The solid electrolyte layer is preferably a layer in which solid particles are densely deposited (filled), and the void volume of the layer obtained using a method described in Examples is preferably 0.06 or lower. In a case where the void volume is 0.06 or lower, an effect of reducing the resistance and increasing the energy density can be obtained. The solid electrolyte layer formed of the solid electrolyte composition according to the embodiment of the present invention includes: an inorganic solid electrolyte; and the particle binder that includes the polymer including the above-described component (K), in which the above-described small void volume can be achieved. The solid electrolyte layer is the same as a solid electrolyte layer in an all-solid state secondary battery described below and typically does not include an active material. The solid electrolyte sheet for an all-solid state secondary battery can be suitably used as a material forming a solid electrolyte layer for an all-solid state secondary battery.

The substrate is not particularly limited as long as it can support the solid electrolyte layer, and examples thereof include a sheet body (plate-shaped body) formed of materials described below regarding the current collector, an organic material, an inorganic material, or the like. Examples of the organic materials include various polymers, and specific examples thereof include polyethylene terephthalate, polypropylene, polyethylene, and cellulose. Examples of the inorganic materials include glass and ceramic.

An electrode sheet for an all-solid state secondary battery according to the embodiment of the present invention (simply also referred to as “electrode sheet according to the embodiment of the present invention”) is not particularly limited as long as it is an electrode sheet including an active material layer, and may be a sheet in which an active material layer is formed on a substrate (current collector) or may be a sheet that is formed of an active material layer without including a substrate. The electrode sheet is typically a sheet including the current collector and the active material layer, and examples of an aspect thereof include an aspect including the current collector, the active material layer, and the solid electrolyte layer in this order and an aspect including the current collector, the active material layer, the solid electrolyte layer, and the active material layer in this order. The electrode sheet according to the embodiment of the present invention may include the above-described other layers. The thickness of each of the layers forming the electrode sheet according to the embodiment of the present invention is the same as the thickness of each of layers described below regarding the all-solid state secondary battery.

It is preferable that the active material layer in the electrode sheet is formed of the solid electrolyte composition (electrode layer-forming composition) according to the embodiment of the present invention. The contents of the respective components in the active material layer of the electrode sheet are not particularly limited, but are preferably the same as the contents of the respective components with respect to the solid content of the solid electrolyte composition (electrode layer-forming composition) according to the embodiment of the present invention. The electrode sheet can be suitably used as a material forming an active material layer (a negative electrode or positive electrode active material layer) for an all-solid state secondary battery.

[Method of Manufacturing Solid Electrolyte-Containing Sheet]

A method of manufacturing the solid electrolyte-containing sheet is not particularly limited. The solid electrolyte-containing sheet can be manufactured using the solid electrolyte composition according to the embodiment of the present invention. For example, a method of preparing the solid electrolyte composition according to the embodiment of the present invention as described above and forming a film (applying and drying) on the substrate using the obtained solid electrolyte composition to form a solid electrolyte layer (applied and dried layer) on the substrate can be used. As a result, the solid electrolyte-containing sheet including optionally the substrate (current collector) or the current collector and the applied and dried layer can be prepared. Here, the applied and dried layer refers to a layer formed by applying the solid electrolyte composition according to the embodiment of the present invention and drying the dispersion medium (that is, a layer formed using the solid electrolyte composition according to the embodiment of the present invention and made of a composition obtained by removing the dispersion medium from the solid electrolyte composition according to the embodiment of the present invention). In the active material layer and the applied and dried layer, the dispersion medium may remain within a range where the effects of the present invention do not deteriorate, and the residual amount thereof, for example, in each of the layers may be 3 mass % or lower.

In the above-described manufacturing method, it is preferable that the solid electrolyte composition according to the embodiment of the present invention is used as a slurry. The solid electrolyte composition according to the embodiment of the present invention can be converted into a slurry using a well-known method as desired. Each of steps of application, drying, or the like for the solid electrolyte composition according to the embodiment of the present invention will be described below regarding a method of manufacturing an all-solid state secondary battery.

In the method of manufacturing a solid electrolyte-containing sheet according to the embodiment of the present invention, it is also possible to pressurize the applied and dried layer obtained as described above. Pressurization conditions or the like will be described below regarding the method of manufacturing an all-solid state secondary battery.

In addition, in the method of manufacturing a solid electrolyte-containing sheet according to the embodiment of the present invention, it is also possible to peel the substrate, the protective layer (particularly, the release sheet), or the like.

[All-Solid State Secondary Battery]

The all-solid state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The positive electrode active material layer is formed optionally on a positive electrode current collector to configure a positive electrode. The negative electrode active material layer is formed optionally on a negative electrode current collector to configure a negative electrode.

It is preferable that at least one of the solid electrolyte layer, the positive electrode active material layer, or the negative electrode active material layer in an all-solid state secondary battery is formed of the solid electrolyte composition according to the embodiment of the present invention, which includes an aspect where all the layers are formed of the solid electrolyte composition according to the embodiment of the present invention. In a case where the positive electrode active material layer is not formed of the solid electrolyte composition according to the embodiment of the present invention, the positive electrode active material layer includes an inorganic solid electrolyte, an active material, and an appropriate component among the above-described respective components (preferably a conductive auxiliary agent). In a case where the negative electrode active material layer is not formed of the solid electrolyte composition according to the embodiment of the present invention, as the negative electrode active material layer, for example, a layer including an inorganic solid electrolyte, an active material, and an appropriate component among the above-described respective components, a layer (for example, a lithium metal layer) formed of a metal or an alloy described above as the negative electrode active material, or a layer (sheet) formed of a carbonaceous material described above as the negative electrode active material is adopted. The layer formed of a metal or an alloy includes, for example, a layer, a metal foil or alloy foil, or a deposited film in which powder of a metal such as lithium or an alloy is deposited or molded. The thickness of each of the layer formed of a metal or an alloy and the layer formed of a carbonaceous material is not particularly limited and is, for example, 0.01 to 100 μm. In a case where the solid electrolyte layer is not formed of the solid electrolyte composition according to the embodiment of the present invention, the solid electrolyte layer includes an inorganic solid electrolyte having ion conductivity of a metal belonging to Group 1 or Group 2 in the periodic table; and an appropriate component among the above-described components.

(Positive Electrode Active Material Layer, Solid Electrolyte Layer, and Negative Electrode Active Material Layer)

In the all-solid state secondary battery according to the embodiment of the present invention, as described above, a solid electrolyte composition or an active material layer can be formed of the solid electrolyte composition according to the embodiment of the present invention or the above-described solid electrolyte-containing sheet. Unless specified otherwise, it is preferable that the respective components in the solid electrolyte layer and the active material layer to be formed and the contents thereof are the same as those in the solid content of the solid electrolyte composition or the solid electrolyte-containing sheet.

The thicknesses of the negative electrode active material layer, the solid electrolyte layer, and the positive electrode active material layer are not particularly limited respectively. In consideration of the dimension of a general all-solid state secondary battery, each of the thicknesses of the respective layers is preferably 10 to 1,000 μm and more preferably 20 μm or more and less than 500 μm. In the all-solid state secondary battery according to the embodiment of the present invention, the thickness of at least one layer of the positive electrode active material layer, the solid electrolyte layer, or the negative electrode active material layer is still more preferably 50 μm or more and less than 500 μm.

Each of the positive electrode active material layer and the negative electrode active material layer may include the current collector opposite to the solid electrolyte layer.

(Case)

Depending on uses, the all-solid state secondary battery according to the embodiment of the present invention may be used as the all-solid state secondary battery having the above-described structure as it is but is preferably sealed in an appropriate case to be used in the form of a dry cell. The case may be a metallic case or a resin (plastic) case. In a case where a metallic case is used, examples thereof include an aluminum alloy case and a stainless steel case. It is preferable that the metallic case is classified into a positive electrode-side case and a negative electrode-side case and that the positive electrode-side case and the negative electrode-side case are electrically connected to the positive electrode current collector and the negative electrode current collector, respectively. The positive electrode-side case and the negative electrode-side case are preferably integrated by being joined together through a gasket for short-circuit prevention.

Hereinafter, an all-solid state secondary battery according to a preferred embodiment of the present invention will be described with reference to FIG. 1, but the present invention is not limited thereto.

FIG. 1 is a cross-sectional view schematically illustrating the all-solid state secondary battery (lithium ion secondary battery) according to the preferred embodiment of the present invention. In the case of being seen from the negative electrode side, an all-solid state secondary battery 10 of the present embodiment includes a negative electrode current collector 1, a negative electrode active material layer 2, a solid electrolyte layer 3, a positive electrode active material layer 4, and a positive electrode current collector 5 in this order. The respective layers are in contact with one another and have a laminated structure. In a case in which the above-described structure is employed, during charging, electrons (e⁻) are supplied to the negative electrode side, and lithium ions (Li⁺) are accumulated in the negative electrode side. On the other hand, during discharging, the lithium ions (Li⁺) accumulated in the negative electrode side return to the positive electrode, and electrons are supplied to an operation portion 6. In an example illustrated in the drawing, an electric bulb is employed as the operation portion 6 and is lit by discharging.

The solid electrolyte composition according to the embodiment of the present invention can be preferably used as a material for forming the solid electrolyte layer, the negative electrode active material layer, or the positive electrode active material layer. In addition, the solid electrolyte-containing sheet according to the embodiment of the present invention is suitable as the negative electrode active material layer, the positive electrode active material layer, and the solid electrolyte layer.

In the present specification, the positive electrode active material layer (hereinafter, also referred to as the positive electrode layer) and the negative electrode active material layer (hereinafter, also referred to as the negative electrode layer) will also be collectively referred to as the electrode layer or the active material layer.

In a case where the all-solid state secondary battery having a layer configuration illustrated in FIG. 1 is put into a 2032-type coin case, the all-solid state secondary battery will be referred to as “laminate for an all-solid state secondary battery”, and a battery prepared by putting this laminate for an all-solid state secondary battery into a 2032-type coin case will be referred to as “all-solid state secondary battery”, thereby referring to both batteries distinctively in some cases.

(Positive Electrode Active Material Layer, Solid Electrolyte Layer, and Negative Electrode Active Material Layer)

In the all-solid state secondary battery 10, any one of the solid electrolyte layer or the active material layer is formed using the solid electrolyte composition according to the embodiment of the present invention or the above-described solid electrolyte-containing sheet. In a preferable aspect, all the layers are formed using the solid electrolyte composition according to the embodiment of the present invention or the above-described solid electrolyte-containing sheet. In another preferable aspect, the solid electrolyte layer and the positive electrode active material layer are formed using the solid electrolyte composition according to the embodiment of the present invention or the above-described solid electrolyte-containing sheet. In addition to the method of forming the negative electrode active material layer using the solid electrolyte composition according to the embodiment of the present invention or the above-described electrode sheet, the negative electrode active material layer can also be formed by using a layer formed of a metal or an alloy, a layer formed of a carbonaceous material, or the like as the negative electrode active material and further precipitating a metal belonging to Group 1 or Group 2 in the periodic table on a negative electrode current collector or the like during charging.

The respective components included in the positive electrode active material layer 4, the solid electrolyte layer 3, and the negative electrode active material layer 2 may be the same as or different from each other.

The positive electrode current collector 5 and the negative electrode current collector 1 are preferably an electron conductor.

In the present invention, either or both of the positive electrode current collector and the negative electrode current collector will also be simply referred to as the current collector.

As a material for forming the positive electrode current collector, not only aluminum, an aluminum alloy, stainless steel, nickel, or titanium but also a material (a material on which a thin film is formed) obtained by treating the surface of aluminum or stainless steel with carbon, nickel, titanium, or silver is preferable. Among these, aluminum or an aluminum alloy is more preferable.

As a material for forming the negative electrode current collector, not only aluminum, copper, a copper alloy, stainless steel, nickel, or titanium but also a material obtained by treating the surface of aluminum, copper, a copper alloy, or stainless steel with carbon, nickel, titanium, or silver is preferable, and aluminum, copper, a copper alloy, or stainless steel is more preferable.

Regarding the shape of the current collector, typically, current collectors having a film sheet-like shape are used, but it is also possible to use net-shaped collectors, punched collectors, compacts of lath bodies, porous bodies, foaming bodies, or fiber groups, and the like.

The thickness of the current collector is not particularly limited, but is preferably 1 to 500 μm. In addition, it is also preferable that the surface of the current collector is made to be uneven through a surface treatment.

In the present invention, a functional layer, a member, or the like may be appropriately interposed or disposed between the respective layers of the negative electrode current collector, the negative electrode active material layer, the solid electrolyte layer, the positive electrode active material layer, and the positive electrode current collector or on the outside thereof. In addition, each of the layers may have a single-layer structure or a multi-layer structure.

[Method of Manufacturing All-Solid State Secondary Battery]

The all-solid state secondary battery according to the embodiment of the present invention is not particularly limited an can be manufacturing method through (including) a method of manufacturing the solid electrolyte composition according to the embodiment of the present invention. Focusing on raw materials to be used, the all-solid state secondary battery can be manufactured using the solid electrolyte composition according to the embodiment of the present invention. Specifically, the all-solid state secondary battery can be manufactured by preparing the solid electrolyte composition according to the embodiment of the present invention as described above and forming a solid electrolyte layer and/or an active material layer of the all-solid state secondary battery using the obtained solid electrolyte composition or the like. As a result, an all-solid state secondary battery having high battery capacity can be manufactured. A method of preparing the solid electrolyte composition according to the embodiment of the present invention is as described above, and the description thereof will not be repeated.

The all-solid state secondary battery according to the embodiment of the present invention can be manufactured through a method including (through) a step of applying (forming a film of) the solid electrolyte composition according to the embodiment of the present invention to the substrate (for example, the metal foil as the current collector) to form a coating film.

For example, the solid electrolyte composition (electrode layer-forming composition) according to the embodiment of the present invention as the positive electrode composition is applied to a metal foil which is a positive electrode current collector so as to form a positive electrode active material layer. As a result, a positive electrode sheet for an all-solid state secondary battery is prepared. Next, the solid electrolyte composition according to the embodiment of the present invention for forming a solid electrolyte layer is applied to the positive electrode active material layer so as to form the solid electrolyte layer. Furthermore, the solid electrolyte composition (electrode layer-forming composition) according to the embodiment of the present invention as the negative electrode composition is applied to the solid electrolyte layer so as to form a negative electrode active material layer. By laminating the negative electrode current collector (metal foil) on the negative electrode active material layer, an all-solid state secondary battery having a structure in which the solid electrolyte layer is sandwiched between the positive electrode active material layer and the negative electrode active material layer can be obtained. Optionally by sealing the laminate in a case, a desired all-solid state secondary battery can be obtained.

In addition, an all-solid state secondary battery can also be manufactured by forming the negative electrode active material layer, the solid electrolyte layer, and the positive electrode active material layer on the negative electrode current collector in order reverse to that of the method of forming the respective layers and laminating the positive electrode current collector thereon.

As another method, for example, the following method can be used. That is, the positive electrode sheet for an all-solid state secondary battery is prepared as described above. In addition, the solid electrolyte composition according to the embodiment of the present invention is applied as a negative electrode composition to a metal foil which is a negative electrode current collector so as to form a negative electrode active material layer. As a result, a negative electrode sheet for an all-solid state secondary battery is prepared. Next, the solid electrolyte layer is formed on the active material layer in any one of the sheets by applying solid electrolyte composition according to the embodiment of the present invention thereto as described above. Furthermore, the other one of the positive electrode sheet for an all-solid state secondary battery and the negative electrode sheet for an all-solid state secondary battery is laminated on the solid electrolyte layer such that the solid electrolyte layer and the active material layer come into contact with each other. This way, an all-solid state secondary battery can be manufactured.

As still another method, for example, the following method can be used. That is, the positive electrode sheet for an all-solid state secondary battery and the negative electrode sheet for an all-solid state secondary battery are prepared as described above. In addition, separately from the electrode sheets, the solid electrolyte composition is applied to a substrate to prepare a solid electrolyte sheet for an all-solid state secondary battery including the solid electrolyte layer. Furthermore, the positive electrode sheet for an all-solid state secondary battery and the negative electrode sheet for an all-solid state secondary battery are laminated such that the solid electrolyte layer removed from the substrate is sandwiched therebetween. This way, an all-solid state secondary battery can be manufactured.

The respective manufacturing methods are the methods of forming the solid electrolyte layer, the negative electrode active material layer, and the positive electrode active material layer using the solid electrolyte composition according to the embodiment of the present invention. However, in the method of manufacturing the all-solid state secondary battery according to the embodiment of the present invention, at least one of the solid electrolyte layer, the negative electrode active material layer, or the positive electrode active material layer is formed using the solid electrolyte composition according to the embodiment of the present invention. In a case where the solid electrolyte layer is formed using a composition other than the solid electrolyte composition according to the embodiment of the present invention and in a case where the negative electrode active material layer is formed using a solid electrolyte composition that is typically used, examples of a material of the composition a well-known negative electrode active material, a metal or an alloy (metal layer) as a negative electrode active material, and a carbonaceous material (carbonaceous material layer) as a negative electrode active material. In addition, the negative electrode active material layer can also be formed by binding ions of a metal belonging to Group 1 or Group 2 in the periodic table that are accumulated on a negative electrode current collector during initialization described below or during charging for use without forming the negative electrode active material layer during the manufacturing of the all-solid state secondary battery to electrons and precipitating the ions on a negative electrode current collector or the like as a metal.

The solid electrolyte layer or the like can also be formed on the substrate or the active material layer, for example, by pressure-molding the solid electrolyte composition or the like under a pressurization condition described below.

<Formation of Respective layers (Film Formation)>

The method for applying the composition used for manufacturing the all-solid state secondary battery is not particularly limited and can be appropriately selected. Examples thereof include coating (preferably wet-type coating), spray coating, spin coating, dip coating, slit coating, stripe coating, and bar coating.

In this case, the composition may be dried after being applied each time or may be dried after being applied multiple times. The drying temperature is not particularly limited. The lower limit is preferably 30° C. or higher, more preferably 60° C. or higher, and still more preferably 80° C. or higher. The upper limit is preferably 300° C. or lower, more preferably 250° C. or lower, and still more preferably 200° C. or lower. In a case where the solid electrolyte composition is heated in the above-described temperature range, the dispersion medium can be removed to make the composition enter a solid state (applied and dried layer). In addition, the temperature is not excessively increased, and the respective members of the all-solid state secondary battery are not impaired, which is preferable. Therefore, in the all-solid state secondary battery, excellent total performance can be exhibited, and excellent binding properties can be obtained.

As described above, in a case where the solid electrolyte composition according to the embodiment of the present invention is applied and dried, a dense applied and dried layer having a small void volume in which solid particles are strongly bound and the interface resistance between the solid particles is low can be optionally formed.

After the application of the composition or after the preparation of the all-solid state secondary battery, the respective layers or the all-solid state secondary battery is preferably pressurized. In addition, the respective layers are also preferably pressurized in a state where they are laminated. Examples of the pressurization method include a method using a hydraulic cylinder pressing machine. The pressure is not particularly limited, but is generally 10 MPa or higher and preferably in a range of 50 to 1500 MPa.

In addition, the applied composition may be heated while being pressurized. The heating temperature is not particularly limited, but is generally in a range of 30° C. to 300° C. The respective layers or the all-solid state secondary battery can also be pressed at a temperature higher than the glass transition temperature of the inorganic solid electrolyte.

The pressurization may be carried out in a state in which a coating solvent or the dispersion medium has been dried in advance or in a state in which a coating solvent or the dispersion medium remains.

The respective compositions may be applied at the same time, and the application, the drying, and the pressing may be carried out simultaneously and/or sequentially. The respective compositions may be applied to separate substrates and then laminated by transfer.

The atmosphere during the pressurization is not particularly limited and may be any one of in the atmosphere, under the dried air (the dew point: −20° C. or lower), in an inert gas (for example, in an argon gas, in a helium gas, or in a nitrogen gas), and the like. Since the inorganic solid electrolyte reacts with moisture, it is preferable that the atmosphere during pressurization is dry air or an inert gas.

The pressing time may be a short time (for example, within several hours) at a high pressure or a long time (one day or longer) under the application of an intermediate pressure. In the case of members other than the solid electrolyte-containing sheet, for example, the all-solid state secondary battery, it is also possible to use a restraining device (screw fastening pressure or the like) of the all-solid state secondary battery in order to continuously apply an intermediate pressure.

The pressing pressure may be uniform or variable with respect to a pressed portion such as a sheet surface.

The pressing pressure may be variable depending on the area or the thickness of the pressed portion. In addition, the pressure may also be variable stepwise for the same portion.

A pressing surface may be smooth or roughened.

<Initialization>

The all-solid state secondary battery manufactured as described above is preferably initialized after the manufacturing or before the use. The initialization is not particularly limited, and it is possible to initialize the all-solid state secondary battery by, for example, carrying out initial charging and discharging in a state in which the pressing pressure is increased and then releasing the pressure up to a pressure at which the all-solid state secondary battery is ordinarily used.

[Usages of all-Solid State Secondary Battery]

The all-solid state secondary battery according to the embodiment of the present invention can be applied to a variety of usages. Application aspects are not particularly limited, and, in the case of being mounted in electronic apparatuses, examples thereof include notebook computers, pen-based input personal computers, mobile personal computers, e-book players, mobile phones, cordless phone handsets, pagers, handy terminals, portable faxes, mobile copiers, portable printers, headphone stereos, video movies, liquid crystal televisions, handy cleaners, portable CDs, mini discs, electric shavers, transceivers, electronic notebooks, calculators, portable tape recorders, radios, backup power supplies, and memory cards. Additionally, examples of consumer usages include automobiles (electric vehicles and the like), electric vehicles, motors, lighting equipment, toys, game devices, road conditioners, watches, strobes, cameras, medical devices (pacemakers, hearing aids, and shoulder massage devices, and the like). Furthermore, the all-solid state secondary battery can be used for a variety of military usages and universe usages. In addition, the all-solid state secondary battery can also be combined with solar batteries.

### EXAMPLES

Hereinafter, the present invention will be described in more detail on the basis of examples. Meanwhile, the present invention is not interpreted to be limited thereto. “Parts” and “%” that represent compositions in the following examples are mass-based unless particularly otherwise described.

Binders and inorganic solid electrolytes used in Examples and Comparative Examples were synthesized as follows.

### Synthesis Example 1: Synthesis of Polymer B-1 (Preparation of Particle Binder B-1 Dispersion Liquid)

(Synthesis of Precursor a of Polymer B-1: Synthesis of Functional Polymer)

340 parts by mass of butyl butyrate (manufactured by Wako Pure Chemical Industries, Ltd.) was added to a 1 L three-neck flask equipped with a reflux cooling pipe and a gas introduction coke, nitrogen gas was introduced at a flow rate of 200 mL/min for 30 minutes, and the solution was heated to 80° C. A liquid (a solution in which 43 parts by mass of dodecyl acrylate (manufactured by Wako Pure Chemical Industries, Ltd.) for deriving the component (M2), 100 parts by mass of 2-acryloyloxyethyl isocyanate (manufactured by Wako Pure Chemical Industries, Ltd.) as the polymerizable compound having the functional group, 165 parts by mass of butyl butyrate (manufactured by Wako Pure Chemical Industries, Ltd.), and 2.9 parts by mass of a polymerization initiator V-601 (trade name, manufactured by Wako Pure Chemical Industries, Ltd.) were mixed with each other) prepared in a separate container was added dropwise to the solution for 2 hours and was stirred at 80° C. for 2 hours. Next, the solution was heated to 90° C. and stirred for 2 hours. As a result, a solution of a precursor A of a polymer B-1 was obtained. The precursor A of the polymer B-1 is shown below.

[chemical structure]

(Synthesis of Precursor B of Polymer B-1: Formation of Component (Mm-1))

370 parts by mass of the solution of the obtained precursor A, 115 parts by mass of butyl butyrate (manufactured by Wako Pure Chemical Industries, Ltd.), 48 parts by mass (in terms of solid content) of a solution of a side chain-forming compound (polymer chain-forming compound) m-1 for forming the side chain portion (polymer chain) of a macromonomer MM-1 that was obtained as described below, and 0.24 parts by mass of NEOSTANN U-600 (trade name, manufactured by Nitto Kasei Co., Ltd.) were added to a 1 L three-neck flask equipped with a reflux cooling pipe and a gas introduction coke, nitrogen gas was introduced at a flow rate of 200 mL/min for 30 minutes, and the solution was heated to 80° C. and stirred for 2 hours. As a result, the macromonomer component (MM-1) was formed, and a solution of a precursor B of a polymer B-1 was obtained. The precursor B of the polymer B-1 is shown below.

[chemical structure]

—Synthesis of Side Chain-Forming Compound m-1 of Macromonomer MM-1—

190 parts by mass of toluene was added to a 1 L three-neck flask equipped with a reflux cooling pipe and a gas introduction coke, nitrogen gas was introduced at a flow rate of 200 mL/min for 10 minutes, and the solution was heated to 80° C. A liquid (the following formula β) prepared in a separate container was added dropwise to the solution for 2 hours and was stirred at 80° C. for 2 hours. Next, 0.2 g of V-601 was further added, and the solution was stirred at 95° C. for 2 hours. As a result, a solution of a side chain-forming compound m-1 was obtained. The concentration of solid contents was 40.5%, and the mass average molecular weight of the side chain-forming compound m-1 was 15,000. The obtained side chain-forming compound m-1 is shown below.

(Formula β)
Dodecyl methacrylate (manufactured by Wako Pure Chemical Industries, Ltd.) . . . 150 parts by mass
Methyl methacrylate (manufactured by Wako Pure Chemical Industries, Ltd.) . . . 59 parts by mass
2-Sulfanyl ethanol (manufactured by Wako Pure Chemical Industries, Ltd.) . . . 1 part by mass
V-601 (manufactured by Wako Pure Chemical Industries, Ltd.) . . . 1.9 parts by mass

[chemical structure]

(Synthesis of Polymer B-1 (Preparation of Particle Binder B-1 Dispersion Liquid): Formation of Component (K))

185 parts by mass of butyl butyrate (manufactured by Wako Pure Chemical Industries, Ltd.) and 250 g of the solution of the precursor B obtained as described above were added to a 1 L three-neck flask equipped with a reflux cooling pipe and a gas introduction coke, nitrogen gas was introduced at a flow rate of 200 mL/min for 30 minutes, and the solution was heated to 30° C. A liquid (a solution in which 20 parts by mass of benzylamine (manufactured by Wako Pure Chemical Industries, Ltd.) and 360 parts by mass of butyl butyrate (manufactured by Wako Pure Chemical Industries, Ltd.) were mixed with each other) prepared in a separate container was added dropwise for 2 hours to form a component K-1. This way, a dispersion liquid of a particle binder B-1 including a polymer B— shown below was obtained.

The obtained polymer B-1 is an acrylic resin, and the content (mass %) of the component is shown in Table 1. The SP value of the component (MM-1) in the polymer B-1 was 9.2.

[chemical structure]

### Synthesis Examples 2 to 14: Synthesis of Polymers B-2 to B-5 and B-7 to B-15 (Preparation of Particle Binder Dispersion Liquids)

Polymers B-2 to B-5 and B-7 to B-15 (particle binder dispersion liquids) were synthesized (prepared) using the same method as that of the above-described polymer B-1, except that compounds for deriving or forming the components shown in Table 1 below were used as the compounds for deriving the respective components in amounts used for obtaining the contents shown in Table 1.

The obtained polymers B-2 to B-5 and B-7 to B-15 are all acrylic resins, and the contents (mass %) of the components are shown in Table 1.

A side chain-forming compound (polymer chain-forming compound) m-3 for forming the side chain portion (polymer chain) of the macromonomer MM-3 used for the preparation of the particle binder B-7 dispersion liquid or the like is a single-end type carbinol-modified polydimethylsiloxane (X-22-170DX, trade name, manufactured by Shin-Etsu Chemical Co., Ltd.), and the chemical structure thereof is shown below. The SP value of the polymer chain-forming compound m-3 was 9.0, and the SP value of the component (MM-3) in the polymer B-7 or the like was 9.1.

[chemical structure]

### Synthesis Example 15: Synthesis of Polymer B-6 (Preparation of Particle Binder B-6 Dispersion Liquid)

(Synthesis of Precursor A of Polymer B-6: Synthesis of Functional Polymer)

36 parts by mass of ta macromonomer MM-2 obtained as described below and 340 parts by mass of butyl butyrate (manufactured by Wako Pure Chemical Industries, Ltd.) were added to a 1 L three-neck flask equipped with a relux cooling pipe and a gas introduction coke, nitrogen gas was introduced at a flow rate of 200 mL/min for 30 minutes, and the solution was heated to 80° C. A liquid (a solution in which 43 parts by mass of dodecyl acrylate (manufactured by Wako Pure Chemical Industries, Ltd.) for deriving the component (M2), 100 parts by mass of 2-acryloyloxyethyl isocyanate (manufactured by Wako Pure Chemical Industries, Ltd.) as the polymerizable compound having the functional group, 165 parts by mass of butyl butyrate (manufactured by Wako Pure Chemical Industries, Ltd.), and 2.9 parts by mass of a polymerization initiator V-601 (trade name, manufactured by Wako Pure Chemical Industries, Ltd.) were mixed with each other) prepared in a separate container was added dropwise to the solution for 2 hours and was stirred at 80° C. for 2 hours. Next, the solution was heated to 90° C. and stirred for 2 hours. As a result, a solution of a precursor A of a polymer B-6 was obtained. The precursor A of the polymer B-6 is shown below.

[chemical structure]

(Synthesis of Polymer B-6 (Preparation of Particle Binder B-6 Dispersion Liquid): Formation of Component (K))

185 parts by mass of butyl butyrate (manufactured by Wako Pure Chemical Industries, Ltd.) and 250 g of the solution of the precursor B obtained as described above were added to a 1 L three-neck flask equipped with a reflux cooling pipe and a gas introduction coke, nitrogen gas was introduced at a flow rate of 200 mL/min for 30 minutes, and the solution was heated to 30° C. A liquid (a solution in which 20 parts by mass of benzylamine (manufactured by Wako Pure Chemical Industries, Ltd.) and 360 parts by mass of butyl butyrate (manufactured by Wako Pure Chemical Industries, Ltd.) were mixed with each other) prepared in a separate container was added dropwise for 2 hours to form a component K-1. This way, a dispersion liquid of a particle binder B-6 including the polymer B-1 shown below was obtained.

The obtained polymer B-6 is an acrylic resin, and the content (mass %) of the component is shown in Table 1. The component (MM-2) in the polymer B-6 is the same as the component (MM-1) in the polymer B-1, and the SP value is 9.2.

—Synthesis of Macromonomer MM-2—

190 parts by mass of toluene was added to a 1 L three-neck flask equipped with a reflux cooling pipe and a gas introduction coke, nitrogen gas was introduced at a flow rate of 200 mL/min for 10 minutes, and the solution was heated to 80° C. A liquid (the following formula α) prepared in a separate container was added dropwise to the solution for 2 hours and was stirred at 80° C. for 2 hours. Next, 0.2 g of V-601 was further added, and the solution was stirred at 95° C. for 2 hours. After stirring, 0.025 parts by mass of 2,2,6,6-tetramethylpiperidine-1-oxyl (manufactured by Tokyo Chemical Industry Co., Ltd.), 13 parts by mass of 2-acryloyloxyethyl isocyanate (manufactured by Wako Pure Chemical Industries, Ltd.), and 0.5 parts by mass of NEOSTANN U-600 (trade name, manufactured by Nitto Kasei Co., Ltd.) were added to the solution held at 80° C., and the solution was stirred at 120° C. for 3 hours. The obtained mixture was cooled to a room temperature and was added to methanol to be precipitated. The supernatant liquid was removed by decantation, precipitates were cleaned with methanol two times, and 300 parts of butyl butyrate was added to the precipitates to dissolve the precipitates. By removing a part of the obtained solution by distillation under reduced pressure, a solution of a macromonomer MM-2 was obtained. The concentration of solid contents was 42.1%, the SP value of the component (MM-2) was 9.2, and the mass average molecular weight was 18,000. The obtained macromonomer MM-2 was obtained as follows.

(Formula α)
Dodecyl methacrylate (manufactured by Wako Pure Chemical Industries, Ltd.) . . . 150 parts by mass
Methyl methacrylate (manufactured by Wako Pure Chemical Industries, Ltd.) . . . 59 parts by mass
2-Sulfanyl ethanol (manufactured by Wako Pure Chemical Industries, Ltd.) . . . 1 part by mass
V-601 (manufactured by Wako Pure Chemical Industries, Ltd.) . . . 1.9 parts by mass

[chemical structure]

### Synthesis Example 16: Synthesis of Polymer B-16 (Preparation of Particle Binder B-16 Dispersion Liquid)

(Synthesis of Diol compound M-18 for deriving Component K-18)

20.0 g of 3-amino-1,2-propanediol (manufactured by Tokyo Chemical Industry Co., Ltd.) was added to a 200 mL three-neck flask, and the solution was stirred at 0° C. 29.2 g of benzyl isocyanate (manufactured by Tokyo Chemical Industry Co., Ltd.) was added dropwise to the solution for 1 hour. Next, the solution was stirred at 80° C. for 4 hours to synthesize a diol compound M-18. The obtained diol compound M-18 is shown below.

[chemical structure]

<Synthesis of Polymer B-16 (Preparation of Particle Binder B-16 Dispersion Liquid)>

38 g of the diol compound M-18, 20 g of a both-end type hydroxyl group hydrogenated polybutadiene (NISSO-PB GI-1000: trade name, SP value of Component (MM-4): 8.5, manufactured by Nippon Soda Co., Ltd.) having a SP value of 8.5 as the macromonomer MM-4, and 42 g of diphnylmethane diisocyanate (manufactured by FUJIFILM Wako Pure Chemical Corporation) were added to a 500 mL three-neck flask and were dissolved in 200 g of methyl ethyl ketone (MEK). This solution was stirred at 80° C. to uniformly dissolve the components. 100 mg of NEOSTANN U-600 (trade name, manufactured by Nitto Kasei Co., Ltd.) was added to the solution, and the solution was stirred at 80° C. for 4 hours to obtain a white viscous polymer solution. I g of methanol was added to the solution to seal the polymer terminal, the polymerization reaction was stopped, and the solution was diluted with MEK. As a result, a 20 mass % MEK solution of the polymer B-16 was obtained.

Next, while stirring the polymer solution obtained as described above at 500 rpm, 1000 g of butyl butyrate was added dropwise for 1 hour. As a result, an emulsion of the polymer B-16 was obtained. MEK was removed from the obtained emulsion at 45° C. at 40 hPa. As a result, a 10 mass % butyl butyrate dispersion liquid of a particle binder B-16 including the polymer B-16 shown below was obtained. The polymer B-16 is a polyurethane resin, and the content (mass %) of the component is shown in Table 1.

[chemical structure]

### Synthesis Examples 17 to 20: Synthesis of Polymers BC-1 to BC-4 (Preparation of Particle Binder Solutions or Dispersion Liquids)

Polymers BC-1 to BC-4 (particle binder solutions or dispersion liquids) were synthesized (prepared) using the same method as that of the above-described polymer B-1, except that compounds for deriving or forming the components shown in Table 1 below were used as the compounds for deriving the respective components in amounts used for obtaining the contents shown in Table 1.

In addition, polymers BC-2 and BC-3 (particle binder dispersion liquids) were synthesized (prepared) using the same method as that of the above-described polymer B-6, except that compounds for deriving the components shown in Table 1 below were used as the compounds for deriving the respective components in amounts used for obtaining the contents shown in Table 1.

Regarding each of the obtained particle binder dispersion liquids, the average particle size of the particle binder was measured using the above-described method. The results are shown in Table 1.

In addition, the mass average molecular weights of the polymers and the like were measured using the above-described method.

Regarding each of the particle binder dispersion liquids, the dispersed state of the polymer (the formation state of the particle binder) was evaluated by visual inspection, and the result thereof is shown in the column “Shape” of Table 1. A state where the polymer was dispersed in the dispersion medium to form the particle binder is shown as “Particle”. On the other hand, a state where the polymer was precipitated in the dispersion medium without being dispersed is shown as “Precipitation”, and a state where the polymer was dissolved in the dispersion medium without forming the particle binder is shown as “Solution”.

<Determination of Amount of Component Dissolved in Particle Binder>

The concentration of solid contents in the particle binder dispersion liquid or the like prepared as described above was adjusted to 10%. 1.6 g of the obtained solution was put into a polypropylene tube (manufactured by Hitachi Koki Co., Ltd.) and was sealed with a tube sealer (manufactured by Hitachi Koki Co., Ltd.). Next, this tube was set in a loader of a micro-ultracentrifuge (trade name: himac CS-150 FNX, manufactured by Hitachi Koki Co., Ltd.) and was processed with an ultracentrifugal separation process under conditions of a temperature of 20° C. and a rotation speed of 100000 rpm for 1 hour. Based on the amount (content: X) of the solid content of a component that precipitated after the process and the amount (content: Y) of solid content of a component that remained in the supernatant liquid without precipitating, the amount of the component dissolved was calculated from the following expression.

Amount of Component Dissolved=Y/(X+Y)

In this test, the amount of the component dissolved is a value relative to butyl acetate (C log P=2.8) in the particle binder dispersion liquid.

TABLE 1

| | Component (K) | | | | | | | Component (MM) | | |
|---|---|---|---|---|---|---|---|---|---|---|
| | | | Mass | | | | | | | Mass |
| | | | Average | | Component (M2) | | | | | Average |
| | | Content | Molecular | | | Content | | | Content | Molecular |
| No. | No. | (mass %) | Weight | CLogP | No. | (mass %) | CLogP | No. | (mass %) | Weight |
| B-1 | K-1 | 56 | 248 | 1.7 | LA | 24 | 6.1 | MM-1 | 20 | 15000 |
| B-2 | K-1 | 82 | 248 | 1.7 | LA | 3 | 6.1 | MM-1 | 15 | 15000 |
| B-3 | K-1 | 82 | 248 | 1.7 | LA | 18 | 6.1 | — | — | — |
| B-4 | K-1 | 50 | 248 | 1.7 | LA | 10 | 6.1 | MM-1 | 40 | 15000 |
| B-5 | K-5 | 56 | 256 | 2.7 | LA | 24 | 6.1 | MM-1 | 20 | 15000 |
| B-6 | K-1 | 56 | 248 | 1.7 | LA | 24 | 6.1 | MM-2 | 20 | 18000 |
| B-7 | K-1 | 56 | 248 | 1.7 | LA | 24 | 6.1 | MM-3 | 20 | 6000 |
| B-8 | K-2 | 56 | 249 | 2 | LA | 24 | 6.1 | MM-3 | 20 | 6000 |
| B-9 | K-6 | 56 | 262 | 2.2 | LA | 24 | 6.1 | MM-3 | 20 | 6000 |
| B-10 | K-7 | 56 | 216 | −0.1 | LA | 24 | 6.1 | MM-3 | 20 | 6000 |
| B-11 | K-17 | 56 | 246 | −0.2 | LA | 24 | 6.1 | MM-3 | 20 | 6000 |
| B-12 | K-1 | 46 | 248 | 1.7 | LA | 24 | 6.1 | MM-3 | 20 | 6000 |
| | | | | | AO1 | 10 | 0.1 | | | |
| B-13 | K-1 | 56 | 248 | 1.7 | MA | 24 | 0.3 | MM-3 | 20 | 6000 |
| B-14 | K-1 | 56 | 248 | 1.7 | HA | 24 | 2.9 | MM-3 | 20 | 6000 |
| B-15 | K-1 | 56 | 248 | 1.7 | 2EHA | 24 | 3.8 | MM-3 | 20 | 6000 |
| B-16 | K-18 | 38 | 248 | 0.5 | MDI | 42 | 2.6 | MM-4 | 20 | 1500 |
| BC-1 | KB-1 | 56 | 222 | 4.8 | LA | 24 | 6.1 | MM-1 | 20 | 15000 |
| BC-2 | AA | 50 | 72 | −0.1 | LA | 10 | 6.1 | MM-2 | 40 | 18000 |
| BC-3 | MA | 60 | 60 | 0.3 | AA | 10 | −0.1 | MM-2 | 30 | 18000 |
| BC-4 | KB-2 | 56 | 2200 | −6.0 | LA | 24 | 6.1 | MM-1 | 20 | 15000 |
| | | | | | | | | | Average | |
| | | | | | | Dispersion | | | Particle | Amount of |
| | | | | | | Medium | | | Size | Component |
| | | | | | No. | Kind | ClogP | Shape | (nm) | Dissolved |
| | | | | | B-1 | Butyl | 2.8 | Particle | 124 | 0.09 |
| | | | | | | Butyrate | | | | |
| | | | | | B-2 | Butyl | 2.8 | Particle | 463 | 0.08 |
| | | | | | | Butyrate | | | | |
| | | | | | B-3 | Butyl | 2.8 | Precipitate | 3230 | 0.01 |
| | | | | | | Butyrate | | | | |
| | | | | | B-4 | Butyl | 2.8 | Particle | 124 | 0.18 |
| | | | | | | Butyrate | | | | |
| | | | | | B-5 | Butyl | 2.8 | Particle | 58 | 0.14 |
| | | | | | | Butyrate | | | | |
| | | | | | B-6 | Butyl | 2.8 | Particle | 48 | 0.15 |
| | | | | | | Butyrate | | | | |
| | | | | | B-7 | Butyl | 2.8 | Particle | 48 | 0.06 |
| | | | | | | Butyrate | | | | |
| | | | | | B-8 | Butyl | 2.8 | Particle | 62 | 0.08 |
| | | | | | | Butyrate | | | | |
| | | | | | B-9 | Butyl | 2.8 | Particle | 44 | 0.06 |
| | | | | | | Butyrate | | | | |
| | | | | | B-10 | Butyl | 2.8 | Particle | 45 | 0.06 |
| | | | | | | Butyrate | | | | |
| | | | | | B-11 | Butyl | 2.8 | Particle | 45 | 0.06 |
| | | | | | | Butyrate | | | | |
| | | | | | B-12 | Butyl | 2.8 | Particle | 54 | 0.06 |
| | | | | | | Butyrate | | | | |
| | | | | | B-13 | Butyl | 2.8 | Particle | 312 | 0.21 |
| | | | | | | Butyrate | | | | |
| | | | | | B-14 | Butyl | 2.8 | Particle | 82 | 0.09 |
| | | | | | | Butyrate | | | | |
| | | | | | B-15 | Butyl | 2.8 | Particle | 63 | 0.07 |
| | | | | | | Butyrate | | | | |
| | | | | | B-16 | Butyl | 2.8 | Particle | 162 | 0.16 |
| | | | | | | Butyrate | | | | |
| | | | | | BC-1 | Butyl | 2.8 | Solution | Not | 1.00 |
| | | | | | | Butyrate | | | Measured | |
| | | | | | BC-2 | Butyl | 2.8 | Particle | 180 | 0.35 |
| | | | | | | Butyrate | | | | |
| | | | | | BC-3 | Butyl | 2.8 | Particle | 184 | 0.26 |
| | | | | | | Butyrate | | | | |
| | | | | | BC-4 | Butyl | 2.8 | Particle | 286 | 0.23 |
| | | | | | | Butyrate | | | | |

In Table 1, the amount of the component dissolved “Y/(X+Y)” is a value by mass, and the number of the component (K) is a number added to the exemplary component.

In the table, MM-1 to MM-4 represent components derived from macromonomers corresponding thereto, and the mass average molecular weights are measured values of the macromonomers.

Components other than the component (K) are shown below together with C log P values thereof.

[chemical structure]

[chemical structure]

In the particle binders No. BC-2 and BC-3, the components AA and MA correspond to the component (M2) but are shown in the column “Component (K)” for convenience of description.

Regarding the particle binder No. B-16, for convenience of description, “MDI” for deriving the component represented by (I-1) is shown in the column “Component (M2)”, and the component represented by (I-3) in which R^{P2} represents a hydrocarbon polymer chain derived from a both-end type hydroxyl group hydrogenated polybutadiene is shown as “MM-4” in the column “Component (MM)”.

### Synthesis Example 21: Synthesis of Sulfide-Based Inorganic Solid Electrolyte Li—P—S-Based Glass

As a sulfide-based inorganic solid electrolyte, Li—P—S-based glass was synthesized with reference to a non-patent document of T. Ohtomo, A. Hayashi, M. Tatsumisago, Y. Tsuchida, S. Hama, K. Kawamoto, Journal of Power Sources, 233, (2013), pp. 231 to 235 and A. Hayashi. S. Hama. H. Morimoto, M. Tatsumisago, T. Minami, Chem. Lett., (2001), pp. 872 and 873.

Specifically, in a glove box under an argon atmosphere (dew point: −70° C.), lithium sulfide (Li2S, manufactured by Aldrich-Sigma, Co. LLC. Purity: >99.98%) (2.42 g) and diphosphorus pentasulfide (P₂S₅, manufactured by Aldrich-Sigma, Co. LLC. Purity: >99%) (3.90 g) were respectively weighed, put into an agate mortar, and mixed using an agate muddler for 5 minutes. The mixing ratio between Li₂S and P₂S₅ (Li₂S:P₂S) was set to 75:25 in terms of molar ratio.

66 zirconia beads having a diameter of 5 mm were put into a 45 mL zirconia container (manufactured by Fritsch Japan Co., Ltd.), the full amount of the mixture of the lithium sulfide and the diphosphorus pentasulfide was put thereinto, and the container was sealed in an argon atmosphere. The container was set in a planetary ball mill P-7 (trade name, manufactured by Fritsch Japan Co., Ltd.), mechanical milling was carried out at a temperature of 25° C. and a rotation speed of 510 rpm for 20 hours, and a yellow powder (6.20 g) of a sulfide-based inorganic solid electrolyte (Li—P—S-based glass, LPS) was obtained. The ion conductivity was 0.28 mS/cm. The average particle size of the Li—P—S-based glass measured using the above-described measurement method was 15 μm.

### Example 1

A solid electrolyte composition and a solid electrolyte-containing sheet were manufactured, and the following properties of the solid electrolyte composition and the solid electrolyte-containing sheet were evaluated. The results are shown in Table 2.

<Preparation of Solid Electrolyte Composition>

180 zirconia beads having a diameter of 5 mm were put into a 45 mL zirconia container (manufactured by Fritsch Japan Co., Ltd.), and 4.85 g of LPS synthesized in Synthesis Example 21, the dispersion liquid (0.15 g in terms of solid contents) of the particle binder shown in Table 2, and 16.0 g of the dispersion medium shown in Table 2 were put thereinto. Next, the container was set in a planetary ball mill P-7 (trade name, manufactured by Fritsch Japan Co., Ltd.) and the components were continuously mixed for 10 minutes at a temperature of 25° C. and a rotation speed of 150 rpm. As a result, solid electrolyte compositions C-1 to C-17 and BC-1 to BC-4 were prepared.

<Preparation of Solid Electrolyte-Containing Sheet>

Each of the solid electrolyte compositions C-1 to C-17 and CS-1 to CS-4 obtained as described above was applied to an aluminum foil having a thickness of 20 μm using an applicator (trade name: a Baker type applicator SA-201 manufactured by Tester Sangyo Co., Ltd.), and was heated at 80° C. for 2 hours to dry the solid electrolyte composition. Next, using a heat press machine, the solid electrolyte composition that was dried at a temperature of 120° C. and a pressure of 600 MPA for 10 seconds was heated and pressurized. As a result, solid electrolyte-containing sheets S-1 to S-17 and BS-1 to BS-4 were prepared. The thickness of the solid electrolyte layer was 50 μm.

<Evaluation 1: Evaluation of Dispersibility>

The solid electrolyte composition was added to a glass test tube having a diameter of 10 mm and a height of 15 cm up to a height of 10 cm and was left to stand at 25° C. for 2 hours. Next, the height of the separated supernatant liquid was observed and measured by visual inspection. A ratio (height of supernatant liquid/height of total amount) of the height of the supernatant liquid to the height (10 cm) of the total amount of the solid electrolyte composition was obtained. The dispersibility (dispersion stability) of the solid electrolyte composition was evaluated based on one of the following evaluation ranks in which this ratio was included. During the calculation of the above-described ratio, the total amount refers to the total amount (10 cm) of the solid electrolyte composition put into the glass test tube, and the height of the supernatant liquid refers to the amount (cm) of the supernatant liquid produced (by solid-liquid separation) by precipitation of the solid components of the solid electrolyte composition.

In this test, as the above-described ratio decreases, the dispersibility is higher, and an evaluation rank of “5” or higher is an acceptable level.

—Evaluation Rank—

8: Height of Supernatant Liquid/Height of Total Amount<0.1

7: 0.1≤Height of Supernatant Liquid/Height of Total Amount<0.2

6: 0.2≤Height of Supernatant Liquid/Height of Total Amount<0.3

5: 0.3≤Height of Supernatant Liquid/Height of Total Amount<0.4

4: 0.4: ≤Height of Supernatant Liquid/Height of Total Amount<0.5

3: 0.5≤Height of Supernatant Liquid/Height of Total Amount<0.7

2: 0.7≤Height of Supernatant Liquid/Height of Total Amount<0.9

1: 0.9≤Height of Supernatant Liquid/Height of Total Amount

<Evaluation 2: Evaluation of Binding Properties>

Each of the solid electrolyte-containing sheets was wound around rods having different diameters, and whether or not chipping and cracking of the solid electrolyte layer and the peeling of the solid electrolyte layer from the aluminum foil (current collector) occurred was checked. The binding properties were evaluated based one of the following evaluation ranks where the minimum diameter of the rod around which the positive electrode sheet was wound without any abnormalities such as defects.

In the present invention, as the minimum diameter of the rod decreases, the binding properties are stronger, and an evaluation rank of “5” or higher is an acceptable level.

—Evaluation Rank of Binding Properties—

8: Minimum diameter<2 mm

7: 2 mm≤Minimum diameter<4 mm

6: 4 mm≤Minimum diameter<6 mm

5: 6 mm≤Minimum diameter<10 mm

4: 10 mm≤Minimum diameter<14 mm

3: 14 mm≤Minimum diameter<20 mm

2: 20 mm≤Minimum diameter<32 mm

1: 32 mm≤

<Evaluation 3: Measurement of Ion Conductivity>

The solid electrolyte-containing sheet obtained as described above was cut in a disk shape having a diameter of 14.5 mm, and this solid electrolyte-containing sheet was put into a coin case 11 shown in FIG. 2. Specifically, an aluminum foil (not shown in FIG. 2) cut in a disk shape having a diameter of 15 mm was brought into contact with the solid electrolyte layer of the solid electrolyte-containing sheet to form a laminate 12 for an all-solid state secondary battery (a laminate consisting of aluminum-solid electrolyte layer-aluminum), and the laminate 12 was put into a 2032-type coin case 11 formed of stainless steel equipped with a spacer and a washer (both of which are not shown in FIG. 2). By swaging the coin case 11, an all-solid state secondary battery 13 for ion conductivity measurement was prepared.

Using the all-solid state secondary battery 13 for ion conductivity measurement, the ion conductivity was measured. Specifically, the alternating current impedance was measured at a voltage magnitude of 5 mV in a frequency range of 1 MHz to 1 Hz using a 1255B frequency response analyzer (trade name, manufactured by SOLARTRON) in a constant-temperature tank at 25° C. As a result, the resistance of the sample in a thickness direction was obtained by calculation from the Expression (A).

Ion Conductivity (mS/cm)=1000×Sample Thickness (cm)/{Resistance (Ω)×Sample Area (cm²)} Expression (A)

In Expression (A), the sample thickness and the sample area were values (that is, the thickness and the area of the solid electrolyte layer) obtained by performing the measurement before putting the laminate 12 for an all-solid state secondary battery into the 2032-type coin case 16 and subtracting the thickness of the aluminum foil therefrom.

An evaluation rank to which the obtained ion conductivity belongs was determined among the following evaluation ranks.

In this test, an evaluation rank of “4” or higher for the ion conductivity was an acceptable level.

—Evaluation Rank—

8: 0.5 mS/cm≤Ion conductivity

7: 0.4 mS/cm≤Ion conductivity<0.5 mS/cm

6: 0.3 mS/cm≤Ion conductivity<0.4 mS/cm

5: 0.2 mS/cm≤Ion conductivity<0.3 mS/cm

4: 0.1 mS/cm≤Ion conductivity<0.2 mS/cm

3: 0.05 mS/cm≤Ion conductivity<0.1 mS/cm

2: 0.01 mS/cm≤Ion conductivity<0.05 mS/cm

1: Ion conductivity<0.01 mS/cm

<Evaluation 4: Evaluation of Void Volume>

The obtained solid electrolyte-containing sheet was cut with a razor, and a cross-section of the solid electrolyte-containing sheet was exposed by ion milling (manufactured by Hitachi High-Technologies Corporation, IM4000PLUS (trade name)). The cross-section was observed with a tabletop microscope (manufactured by Hitachi High-Technologies Corporation: Miniscope TM3030PLUS (trade name)), the obtained image was processed and binarized such that only a void portion looked black based on the brightness of the image, and the ratio of the area of the void portion to the total area was calculated to calculate a void volume (the total area of void portions/the total area of the measurement region). The void volume was evaluated based on the following evaluation ranks.

In this test, as the void volume decreases, the solid particles are more densely deposited in the solid electrolyte layer, which shows that a function of improving the ion conductivity and the energy density is exhibited. An evaluation rank of “3” or higher is an acceptable level.

—Evaluation Rank—

8: 0<Void volume≤0.01

7: 0.01<Void volume≤0.02

6: 0.02<Void volume≤0.04

5: 0.04<Void volume≤0.06

4: 0.06<Void volume≤0.08

3: 0.08<Void volume≤0.10

2: 0.10<Void volume≤0.15

1: 0.15<Void volume

TABLE 2

| Solid Electrolyte Composition | | | | | | | | | | | |
|---|---|---|---|---|---|---|---|---|---|---|---|
| | Sulfide-Based | | | | | | | | | | |
| | Inorganic | | | | | | | | | | |
| | Solid Electrolyte | | Particle Binder | | | | | Solid Electrolyte-Containing Sheet | | | |
| | | Content | | Content | | | | | Binding | Ion | |
| No. | Kind | (mass %) | No. | (mass %) | Dispersion Lipid | CLogP | Dispersibility | No. | Properties | Conductivity | Void |
| C-1 | LPS | 97% | B-1 | 3% | THF | 0.5 | 5 | S-1 | 5 | 4 | 3 |
| C-2 | LPS | 97% | B-1 | 3% | Butyl Butyrate | 2.8 | 7 | S-2 | 7 | 6 | 6 |
| C-3 | LPS | 97% | B-2 | 3% | Butyl Butyrate | 2.8 | 6 | S-3 | 6 | 6 | 6 |
| C-4 | LPS | 97% | B-3 | 3% | Butyl Butyrate | 2.8 | 5 | S-4 | 5 | 6 | 6 |
| C-5 | LPS | 97% | B-4 | 3% | Butyl Butyrate | 2.8 | 6 | S-5 | 6 | 5 | 6 |
| C-6 | LPS | 97% | B-5 | 3% | Butyl Butyrate | 2.8 | 7 | S-6 | 7 | 5 | 7 |
| C-7 | LPS | 97% | B-6 | 3% | Butyl Butyrate | 2.8 | 5 | S-7 | 6 | 5 | 6 |
| C-8 | LPS | 97% | B-7 | 3% | Butyl Butyrate | 2.8 | 8 | S-8 | 7 | 8 | 7 |
| C-9 | LPS | 97% | B-8 | 3% | Butyl Butyrate | 2.8 | 7 | S-9 | 8 | 6 | 7 |
| C-10 | LPS | 97% | B-9 | 3% | Butyl Butyrate | 2.8 | 8 | S-10 | 6 | 7 | 7 |
| C-11 | LPS | 97% | B-10 | 3% | Butyl Butyrate | 2.8 | 8 | S-11 | 7 | 8 | 8 |
| C-12 | LPS | 97% | B-11 | 3% | Butyl Butyrate | 2.8 | 6 | S-12 | 6 | 6 | 7 |
| C-13 | LPS | 97% | B-12 | 3% | Butyl Butyrate | 2.8 | 8 | S-13 | 8 | 8 | 8 |
| C-14 | LPS | 97% | B-13 | 3% | Butyl Butyrate | 2.8 | 5 | S-14 | 5 | 6 | 4 |
| C-15 | LPS | 97% | B-14 | 3% | Butyl Butyrate | 2.8 | 7 | S-15 | 7 | 8 | 6 |
| C-16 | LPS | 97% | B-15 | 3% | Butyl Butyrate | 2.8 | 8 | S-16 | 7 | 8 | 8 |
| C-17 | LPS | 97% | B-16 | 3% | Butyl Butyrate | 2.8 | 5 | S-17 | 5 | 5 | 6 |
| BC-1 | LPS | 97% | BC-1 | 3% | Butyl Butyrate | 2.8 | 3 | BS-1 | 3 | 3 | 3 |
| BC-2 | LPS | 97% | BC-2 | 3% | Butyl Butyrate | 2.8 | 2 | BS-2 | 1 | 2 | 1 |
| BC-3 | LPS | 97% | BC-3 | 3% | Butyl Butyrate | 2.8 | 4 | BS-3 | 4 | 2 | 2 |
| BC-4 | LPS | 97% | BC-4 | 3% | Butyl Butyrate | 2.8 | 2 | BS-4 | 3 | 3 | 3 |

The following can be seen from the results of Table 2.

In the solid electrolyte compositions BC-1 to BC-4 including the particle binder that did not include the polymer, the dispersibility was not sufficient, the polymer including the component including the binding site represented by Formula (H-1) or (H-2) defined by the present invention at a side chain and having a C log P value of 4 or lower and a molecular weight of lower than 1000. Therefore, in the solid electrolyte-containing sheets BS-1 to BS-4 prepared using the solid electrolyte compositions, the binding properties and the ion conductivity were poor, the void volume in the solid electrolyte layer of the solid electrolyte-containing sheets BS-2 and BS-3 was also high.

On the other hand, in the solid electrolyte compositions C-1 to C-17 according to the embodiment of the present invention that included the particle binder including the polymer, the inorganic solid electrolyte, and the dispersion medium the dispersibility and having an average particle size of 5 nm to 10 μm was excellent, the polymer including the component including the binding site represented by Formula (H-1) or (H-2) defined by the present invention at a side chain and having a C log P value of 4 or lower and a molecular weight of lower than 1000. Therefore, in the solid electrolyte-containing sheets S-1 to S-17 prepared using the solid electrolyte composition, the binding properties and the ion conductivity were excellent at the same time. Further, all the solid electrolyte-containing sheets includes the solid electrolyte layer in which the solid particles were densely deposited with small voids.

### Example 2

An all-solid state secondary battery was manufactured, and the following properties thereof were evaluated. The results are shown in Table 3.

<Preparation of Positive Electrode Composition>

180 zirconia beads having a diameter of 5 mm were put into a 45 mL zirconia container (manufactured by Fritsch Japan Co., Ltd.), and 2.7 g of LPS synthesized in Synthesis Example 21, the dispersion liquid (0.3 g in terms of solid contents) of the particle binder shown in Table 3, and 22 g of the dispersion medium shown in Table 3 were put thereinto. The container was set in a planetary ball mill P-7 (trade name, manufactured by Fritsch Japan Co., Ltd.) and the components were stirred for 60 minutes at 25° C. and a rotation speed of 300 rpm. Next, 7.0 g of LiNi_{1/3}Co_{1/3}Mn_{1/3}O₂ (NMC) as a positive electrode active material was put thereinto. Next, using the same method, the container was set in a planetary ball mill P-7 and the components were continuously mixed together for 5 minutes at 25° C. and a rotation speed of 100 rpm. As a result, positive electrode compositions U-1 to U-17 and V-1 to V4 were prepared.

TABLE 3

| Positive Electrode Composition | | | | | | | | |
|---|---|---|---|---|---|---|---|---|
| | Positive Electrode | | Inorganic Solid | | | | | Positive Electrode |
| | Active Material | | Electrolyte | | Particle Binder | | | Sheet No. for |
| | | Content | | Content | | Content | Dispersion | All-Solid State |
| No. | Kind | (mass %) | Kind | (mass %) | No. | (mass %) | Medium | Secondary Battery |
| U-1 | NMC | 70 | LPS | 27 | B-1 | 3 | THF | PU-1 |
| U-2 | NMC | 70 | LPS | 27 | B-1 | 3 | Butyl Butyrate | PU-2 |
| U-3 | NMC | 70 | LPS | 27 | B-2 | 3 | Butyl Butyrate | PU-3 |
| U-4 | NMC | 70 | LPS | 27 | B-3 | 3 | Butyl Butyrate | PU-4 |
| U-5 | NMC | 70 | LPS | 27 | B-4 | 3 | Butyl Butyrate | PU-5 |
| U-6 | NMC | 70 | LPS | 27 | B-5 | 3 | Butyl Butyrate | PU-6 |
| U-7 | NMC | 70 | LPS | 27 | B-6 | 3 | Butyl Butyrate | PU-7 |
| U-8 | NMC | 70 | LPS | 27 | B-7 | 3 | Butyl Butyrate | PU-8 |
| U-9 | NMC | 70 | LPS | 27 | B-8 | 3 | Butyl Butyrate | PU-9 |
| U-10 | NMC | 70 | LPS | 27 | B-9 | 3 | Butyl Butyrate | PU-10 |
| U-11 | NMC | 70 | LPS | 27 | B-10 | 3 | Butyl Butyrate | PU-11 |
| U-12 | NMC | 70 | LPS | 27 | B-11 | 3 | Butyl Butyrate | PU-12 |
| U-13 | NMC | 70 | LPS | 27 | B-12 | 3 | Butyl Butyrate | PU-13 |
| U-14 | NMC | 70 | LPS | 27 | B-13 | 3 | Butyl Butyrate | PU-14 |
| U-15 | NMC | 70 | LPS | 27 | B-14 | 3 | Butyl Butyrate | PU-15 |
| U-16 | NMC | 70 | LPS | 27 | B-15 | 3 | Butyl Butyrate | PU-16 |
| U-17 | NMC | 70 | LPS | 27 | B-16 | 3 | Butyl Butyrate | PU-17 |
| V-1 | NMC | 70 | LPS | 27 | BC-1 | 3 | Butyl Butyrate | PV-1 |
| V-2 | NMC | 70 | LPS | 27 | BC-2 | 3 | Butyl Butyrate | PV-2 |
| V-3 | NMC | 70 | LPS | 27 | BC-3 | 3 | Butyl Butyrate | PV-3 |
| V-4 | NMC | 70 | LPS | 27 | BC-4 | 3 | Butyl Butyrate | PV-4 |

<Abbreviations of Table>
NMC: LiNi_{1/3}Co_{1/3}Mn_{1/3}O₂
LPS: the sulfide-based inorganic solid electrolyte (Li-P-S-based glass) synthesized in Synthesis Example 21
THF: tetrahydrofuran

<Preparation of Positive Electrode Sheet for all-Solid State Secondary Battery>

The positive electrode composition obtained as described above was applied to an aluminum foil (positive electrode current collector) having a thickness of 20 musing a Baker Type applicator (trade name: SA-201, manufactured by Tester Sangyo Co., Ltd.), and was heated at 80° C. for 2 hours to dry the positive electrode composition (to remove the dispersion medium). Next, using a heat press machine, the positive electrode composition that was dried was pressurized at 25° C. (10 MPa, 1 minute). As a result, positive electrode sheet PU-1 to PU-17 and PV-1 to PV-4 for an all-solid state secondary battery including the positive electrode active material layer having a thickness of 80 μm were prepared.

Next, the solid electrolyte-containing sheet shown in the column “Solid Electrolyte Layer” in Table 4 and prepared in Example 1 was disposed on the obtained positive electrode active material layer of each of the positive electrode sheets for an all-solid state secondary battery shown in Table 4 such that the solid electrolyte layer was in contact with the positive electrode active material layer, was pressurized at 25° C. at 50 MPa using a press machine to be transferred (laminated), and was pressurized at 25° C. at a pressure of 600 MPa. As a result, the positive electrode sheet PU-1 to PU-17 and PV-1 to PV-4 for an all-solid state secondary battery including the solid electrolyte layer having a thickness of 50 μm were prepared.

<Manufacturing of all-Solid State Secondary Battery>

Each of the positive electrode sheets for an all-solid state secondary battery (the aluminum foil of the solid electrolyte-containing sheet was peeled off) was cut out in a disk shape having a diameter of 14.5 mm, as shown in FIG. 2, the cut sheet was put into a 2032-type coin case I1 formed of stainless steel equipped with a spacer and a washer (not shown in FIG. 2), and a graphite negative electrode layer (negative electrode active material layer: thickness of 80 μm) having a sheet shape was laminated on the solid electrolyte layer. Further, a stainless steel foil (negative electrode current collector) was further laminated on the negative electrode layer. As a result, a laminate 12 for an all-solid state secondary battery (a laminate including aluminum, the positive electrode active material layer, the solid electrolyte layer, the graphite negative electrode layer, and stainless steel) was formed. Next, by swaging the 2032-type coin case 11, all-solid state secondary batteries 201 to 217 and c21 to c24 shown in FIG. 2 were manufactured. The all-solid state secondary battery 13 manufactured as described above has the layer configuration shown in FIG. 1.

<Evaluation 1: Battery Characteristics 1 (Discharge Capacity Retention Ratio)>

Regarding the battery characteristics of the all-solid state secondary batteries 201 to 217 and c21 to c24, the discharge capacity retention ratio was measured, and cycle characteristics were evaluated.

Specifically, the discharge capacity retention ratio of each of the all-solid state secondary batteries was measured using a charging and discharging evaluation device “TOSCAT-3000” (trade name, manufactured by Toyo System Corporation). Charging was performed at a current density of 0.1 mA/cm² until the battery voltage reached 3.6 V. Discharging was performed at a current density of 0.1 mA/cm² until the battery voltage reached 2.5 V. One charging operation and the discharging operation was set as one cycle, and three cycles of charging and discharging were repeated. Next, the all-solid state secondary battery was initialized. When the discharge capacity (initial discharge capacity) of one cycle of charging and discharging after the initialization was represented by 100%, the number of charging and discharging cycles in which the discharge capacity retention ratio (discharge capacity relative to the initial discharge capacity) reached 80% was counted, and cycle characteristics were evaluated based one of the following evaluation ranks where the number of charging and discharging cycles was included.

In this test, regarding the discharge capacity retention ratio, an evaluation rank of “5” or higher was an acceptable level.

The initial discharge capacities of all the all-solid state secondary batteries 201 to 217 were sufficient for functioning as the all-solid state secondary batteries.

—Evaluation Rank of Discharge Capacity Retention Ratio—

8: 500 cycles or more

7: 300 cycles or more and less than 500 cycles

6: 200 cycles or more and less than 300 cycles

5: 150 cycles or more and less than 200 cycles

4: 80 cycles or more and less than 150 cycles

3: 40 cycles or more and less than 80 cycles

2: 20 cycles or more and less than 40 cycles

1: less than 20 cycles

<Evaluation 2: Battery Characteristics 2 (Resistance)>

Regarding the battery characteristics of the all-solid state secondary batteries 201 to 217 and c21 to c24, the resistance was measured, and the magnitude of resistance was evaluated.

The resistance of each of the all-solid state secondary batteries was evaluated using a charging and discharging evaluation device “TOSCAT-3000” (trade name, manufactured by Toyo System Corporation). Charging was performed at a current density of 0.1 mA/cm² until the battery voltage reached 4.2 V. Discharging was performed at a current density of 0.2 mA/cm² until the battery voltage reached 2.5 V. One charging operation and the discharging operation was set as one cycle, and three cycles of charging and discharging were repeated. After performing discharging at 5 mAh/g (amount of electricity per 1 g of the mass of the active material) of the third cycle, the battery voltage was read. The resistance of the all-solid state secondary battery was evaluated based on one of the following evaluation ranks in which this battery voltage was included. As the battery voltage increases, the resistance decreases. In this test, an evaluation rank of “4” or higher was an acceptable level.

—Evaluation Rank of Resistance—

8: 4.1 V or higher

7: 4.0 V or higher and lower than 4.1 V

6: 3.9 V or higher and lower than 4.0 V

5: 3.7 V or higher and lower than 3.9 V

4: 3.5 V or higher and lower than 3.7 V

3: 3.2 V or higher and lower than 3.5 V

2: 2.5 V or higher and lower than 3.2 V

1: charging and discharging was not able to be performed

TABLE 4

| | Layer Configuration | | | | |
|---|---|---|---|---|---|
| | Positive | Solid | Discharge | | |
| | Electrode Active | Electrolyte | Capacity | Resis- | |
| No. | Material Layer | Layer | Retention | tance | Note |
| 201 | PU-1 | S-1 | 5 | 4 | Present |
| | | | | | Invention |
| 202 | PU-2 | S-2 | 7 | 6 | Present |
| | | | | | Invention |
| 203 | PU-3 | S-3 | 6 | 6 | Present |
| | | | | | Invention |
| 204 | PU-4 | S-4 | 5 | 6 | Present |
| | | | | | Invention |
| 205 | PU-5 | S-5 | 6 | 5 | Present |
| | | | | | Invention |
| 206 | PU-6 | S-6 | 7 | 5 | Present |
| | | | | | Invention |
| 207 | PU-7 | S-7 | 5 | 5 | Present |
| | | | | | Invention |
| 208 | PU-8 | S-8 | 7 | 8 | Present |
| | | | | | Invention |
| 209 | PU-9 | S-9 | 7 | 6 | Present |
| | | | | | Invention |
| 210 | PU-10 | S-10 | 7 | 7 | Present |
| | | | | | Invention |
| 211 | PU-11 | S-11 | 7 | 8 | Present |
| | | | | | Invention |
| 212 | PU-12 | S-12 | 6 | 6 | Present |
| | | | | | Invention |
| 213 | PU-13 | S-13 | 8 | 8 | Present |
| | | | | | Invention |
| 214 | PU-14 | S-14 | 5 | 6 | Present |
| | | | | | Invention |
| 215 | PU-15 | S-15 | 7 | 8 | Present |
| | | | | | Invention |
| 216 | PU-16 | S-16 | 7 | 8 | Present |
| | | | | | Invention |
| 217 | PU-17 | S-17 | 5 | 5 | Present |
| | | | | | Invention |
| c21 | PV-1 | BS-t | 3 | 3 | Comparative |
| | | | | | Example |
| c22 | PV-2 | BS-2 | 2 | 2 | Comparative |
| | | | | | Example |
| c23 | PV-3 | BS-3 | 4 | 2 | Comparative |
| | | | | | Example |
| c24 | PV-4 | BS-4 | 2 | 3 | Comparative |
| | | | | | Example |

The following can be seen from the results of Table 4.

In each of the all-solid state secondary batteries No. c21 to c24, the positive electrode active material layer and the solid electrolyte layer were prepared using the positive electrode compositions PV-1 to PV-4 and the solid electrolyte-containing sheets BS-1 to BS-4,and the positive electrode compositions PV-1 to PV-4 and the solid electrolyte-containing sheets BS-1 to BS-4 were prepared using the particle binder that did not include the polymer, the polymer including the component including the binding site represented by Formula (H-1) or (H-2) at a side chain and having a C log P value of 4 or lower and a molecular weight of lower than 1000. In the all-solid state secondary batteries, both the discharge capacity retention ratio and the resistance were not sufficient, and the battery performance was poor.

On the other hand, in the all-solid state secondary batteries No. 201 to 217, the positive electrode active material layer and the solid electrolyte layer were prepared using the positive electrode compositions PU-1 to PU-17 and the solid electrolyte-containing sheets S-1 to S-17 that were prepared using the solid electrolyte compositions C-1 to C-17 according to the embodiment of the present invention prepared in Example 1. In the all-solid state secondary batteries No. 201 to 217, the discharge capacity retention ratio was high, an increase in resistance is suppressed (the battery voltage was high), and the battery performance was excellent.

Solid electrolyte compositions including LLT as a solid electrolyte were prepared using the same preparation method as that of the solid electrolyte composition according to Example 1, except that Li_{0.33}La_{0.55}TiO₃ (LLT) was used instead of LPS during the preparation of the solid electrolyte compositions C-1 to C-17 according to Example 1. Using each of the solid electrolyte compositions and the same method as that of Examples 1 and 2, a solid electrolyte-containing sheet and a positive electrode sheet for an all-solid state secondary battery were prepared, an all-solid state secondary battery was manufactured, and the respective tests were performed. As a result, in the solid electrolyte composition including LLT, the solid electrolyte-containing sheet, and the all-solid state secondary battery, it was found that excellent properties and performance were excellent as in the solid electrolyte composition including LPS and the solid electrolyte-containing sheet and the all-solid state secondary battery including the solid electrolyte composition.

The present invention has been described using the embodiments. However, unless specified otherwise, any of the details of the above description is not intended to limit the present invention and can be construed in a broad sense within a range not departing from the concept and scope of the present invention disclosed in the accompanying claims.

The present application claims priority based on JP2018-139152 filed on Jul. 25, 2018, the entire content of which is incorporated herein by reference.

### EXPLANATION OF REFERENCES

1: negative electrode current collector
2: negative electrode active material layer
3: solid electrolyte layer
4: positive electrode active material layer
5: positive electrode current collector
6: operation portion
10: all-solid state secondary battery
11: 2032-type coin case
12: laminate for all-solid state secondary battery
13: all-solid state secondary battery

What is claimed is:

1. A solid electrolyte composition comprising:
an inorganic solid electrolyte having ion conductivity of a metal belonging to Group 1 or Group 2 in the periodic table;
a particle binder that includes a polymer and has an average particle size of 5 nm to 10 μm, the polymer including a component that includes a binding site represented by Formula (H-1) or (H-2) at a side chain and has a C log P value of 4 or lower and a molecular weight of lower than 1000, and a component that is derived from a macromonomer having a mass average molecular weight of 1000 or higher and includes a binding site represented by Formula (H-21) or (H-22) at a side chain; and
a dispersion medium, [chemical structure]
in the formulae, X¹¹, X¹², X¹³, and X¹⁵ each independently represent an imino group, an oxygen atom, a sulfur atom, or a selenium atom,
X¹⁴ represents an amino group, a hydroxy group, a sulfanyl group, or a carboxy group, and
L¹¹ represents an alkylene group or an alkenylene group having 4 or less carbon atoms; [chemical structure]
in the formulae, X⁴¹, X⁴², X⁴³, and X⁴⁵ each independently represent an imino group, an oxygen atom, a sulfur atom, or a selenium atom,
X⁴⁴ represents an amino group, a hydroxy group, a sulfanyl group, or a carboxy group, and
L⁴¹ represents an alkylene group or an alkenylene group having 4 or less carbon atoms.

2. The solid electrolyte composition according to claim 1,
wherein the component having the molecular weight of lower than 1000 is represented by Formula (R-1) or (R-2), [chemical structure]
in the formulae, X²¹, X²², X²³, and X²⁵ each independently represent an imino group, an oxygen atom, or a sulfur atom,
X²⁴ represents a hydroxy group or a sulfanyl group,
R¹¹ to R¹³ and R¹⁵ to R¹⁷ each independently represent a hydrogen atom, a cyano group, a halogen atom, or an alkyl group,
R¹⁴ and R¹⁸ each independently represent a hydrogen atom or a substituent,
L²¹ to L²³ and L²⁵ each independently represent an alkylene group having 1 to 16 carbon atoms, an alkenylene group having 2 to 16 carbon atoms, an arylene group having 6 to 24 carbon atoms, an oxygen atom, a sulfur atom, an imino group, a carbonyl group, a phosphate linking group, a phosphonate linking group, or a linking group including a combination thereof, and
L²⁴ represents an alkylene group or an alkenylene group having 4 or less carbon atoms.

3. The solid electrolyte composition according to claim 1,
wherein the component having the molecular weight of lower than 1000 is represented by Formula (R-21) or (R-22), [chemical structure]
in the formulae, X³¹, X³², and X³⁵ each independently represent an imino group or an oxygen atom,
X³³ represents an oxygen atom,
X³⁴ represents a hydroxy group,
Y¹¹ and Y¹² each independently represent an imino group or an oxygen atom,
R²¹ to R²³ and R²⁵ to R²⁷ each independently represent a hydrogen atom, a cyano group, or an alkyl group,
R²⁴ and R²⁸ each independently represent a hydrogen atom, a hydroxy group, an alkyl group having 1 to 6 carbon atoms, a phenyl group, or a carboxy group,
L³¹ to L³³ and L³⁵ each independently represent an alkylene group having 1 to 16 carbon atoms, an arylene group having 6 to 12 carbon atoms, an oxygen atom, a sulfur atom, an imino group, a carbonyl group, or a linking group including a combination thereof, and
L³⁴ represents an alkylene group having 2 or less carbon atoms.

4. The solid electrolyte composition according to claim 1,
wherein in Formula (H-1), X¹¹ and X¹² each independently represent an imino group and X¹³ represents an oxygen atom, or
in Formula (H-2), X¹⁴ represents an amino group, a hydroxy group, a sulfanyl group, or a carboxy group, X¹⁵ represents an imino group, and L¹¹ represents an alkylene group or an alkenylene group having 4 or less carbon atoms.

5. The solid electrolyte composition according to claim 1,
wherein the polymer includes 20 mass % or higher and lower than 90 mass % of the component having the molecular weight of lower than 1000.

6. The solid electrolyte composition according to claim 1,
wherein the C log P value is 2.5 or lower.

7. The solid electrolyte composition according to claim 1,
wherein the polymer includes a component that includes a group having 6 or more carbon atoms at a side chain.

8. The solid electrolyte composition according to claim 1,
wherein the particle binder includes a component that precipitates after a centrifugal separation process in a dispersion medium at a temperature of 20° C. and a rotation speed of 100000 rpm for 1 hour and a component that does not precipitate after the centrifugal separation process, and
a content X of the component that precipitates and a content Y of the component that does not precipitate satisfy the following expression by mass,
Y/(X+Y)≤0.10.

9. The solid electrolyte composition according to claim 1,
wherein the polymer includes at least one functional group selected from Group (a) of functional groups,
Group (a) of functional groups
a carboxy group, a sulfonate group, a phosphate group, a phosphonate group, an isocyanate group, an oxetane group, an epoxy group, and a silyl group.

10. The solid electrolyte composition according to claim 1,
wherein the inorganic solid electrolyte is represented by Formula (1),
Lₐ₁M_{b1}P_{c1}S_{d1}Aₑ₁ Formula (1),
in the formula, L represents an element selected from Li, Na, or K,
M represents an element selected from B, Zn, Sn, Si, Cu, Ga, Sb, Al, or Ge,
A represents an element selected from I, Br, Cl, or F, and
a1 to e1 represent compositional ratios between the respective elements, and
a1:b1:c1:d1:e1 satisfies 1 to 12:0 to 5:1:2 to 12:0 to 10.

11. The solid electrolyte composition according to claim 1,
wherein the dispersion medium is at least one dispersion medium selected from a ketone compound, an ester compound, an aromatic compound, or an aliphatic compound.

12. The solid electrolyte composition according to claim 1, comprising:
an active material capable of intercalating and deintercalating ions of a metal belonging to Group 1 or Group 2 in the periodic table.

13. A solid electrolyte-containing sheet comprising:
a layer formed of the solid electrolyte composition according to claim 1.

14. An electrode sheet for an all-solid state secondary battery, the electrode sheet comprising:
an active material layer formed of the solid electrolyte composition according to claim 12.

15. An all-solid state secondary battery comprising a positive electrode active material layer, a solid electrolyte layer, and a negative electrode active material layer in this order,
wherein at least one of the positive electrode active material layer, the negative electrode active material layer, or the solid electrolyte layer is formed of the solid electrolyte composition according to claim 1.

16. A method of manufacturing a solid electrolyte-containing sheet, the method comprising:
forming a film using the solid electrolyte composition according to claim 1.

17. A method of manufacturing an all-solid state secondary battery, the method comprising manufacturing the all-solid state secondary battery through the method according to claim 16.

18. A method of manufacturing a particle binder that includes a polymer and has an average particle size of 5 nm to 10 μm, the polymer including a component that includes a binding site represented by Formula (H-1) or (H-2) and has a C log P value of 4 or lower and a molecular weight of lower than 1000, and a component that is derived from a macromonomer having a mass average molecular weight of 1000 or higher and includes a binding site represented by Formula (H-21) or (H-22) at a side chain, the method comprising:
a step of causing a functional polymer having a functional group at a side chain to react with a side chain-forming compound having a reactive group that reacts with the functional group to form the binding site represented by Formula (H-1) or (H-2), [chemical structure]
in the formulae, X¹¹, X¹², X¹³, and X¹⁵ each independently represent an imino group, an oxygen atom, a sulfur atom, or a selenium atom,
X¹⁴ represents an amino group, a hydroxy group, a sulfanyl group, or a carboxy group, and
L¹¹ represents an alkylene group or an alkenylene group having 4 or less carbon atoms; [chemical structure]
in the formulae, X⁴¹, X⁴², X⁴³, and X⁴⁵ each independently represent an imino group, an oxygen atom, a sulfur atom, or a selenium atom,
X⁴⁴ represents an amino group, a hydroxy group, a sulfanyl group, or a carboxy group, and
L⁴¹ represents an alkylene group or an alkenylene group having 4 or less carbon atoms.
